(19) United States
(12) Patent Application Publication
(10) Pub. No.: US 2016/0152925 A1
(43) Pub. Date: Jun. 2, 2016

(54) Polypeptides Having Anti-Redeposition Effect and Polynucleotides Encoding Same

(71) Applicant: NOVOZYMES A/S, Bagsvaerd (DK)

(72) Inventors: Dorotea R. Segura, Bagsvaerd (DK); Astrid Boisen, Bagsvaerd (DK); Leigh Murphy, Bagsvaerd (DK); Lars Anderson, Bagsvaerd (DK); Lorena G. Palmen, Bagsvaerd (DK); Kasper R. Madsen, Bagsvaerd (DK)

(73) Assignee: Novozymes A/S, Bagsvaerd (DK)

(21) Appl. No.: 14/900,979

(22) PCT Filed: Jul. 3, 2014
(86) PCT No.: PCT/EP2014/064175

§ 371 Date: Dec. 22, 2015

(30) Foreign Application Priority Data
Jul. 4, 2013 (EP) 13175142.2
Nov. 5, 2013 (EP) 13191630.6

(51) Int. Cl. C11D 3/00; C11D 3/386

(52) U.S. Cl. CPC C11D 3/0036; C11D 3/38636

(57) ABSTRACT

The present invention relates to methods for reducing or preventing soil redeposition using a detergent composition comprising an isolated polypeptide having xanthan lyase activity optionally with a GH9 endoglucanase for dish wash and laundry. The invention also relates to polynucleotides encoding the polypeptides, nucleic acid constructs, vectors, and host cells comprising the polynucleotides as well as methods of producing and using the polypeptides.

### REFERENCE TO A SEQUENCE LISTING

This application contains a Sequence Listing in computer readable form, which is incorporated herein by reference.

### BACKGROUND OF THE INVENTION

1. Field of the Invention

The present invention relates to methods for reducing or preventing soil redeposition using a detergent composition comprising an isolated polypeptide having xanthan lyase activity optionally with a GH9 endoglucanase for dish wash and laundry. The invention also relates to polynucleotides encoding the polypeptides, nucleic acid constructs, vectors, and host cells comprising the polynucleotides as well as methods of producing and using the polypeptides.

2. Background of the Invention

Xanthan gum is a polysaccharide derived from the bacterial coat of Xanthomonas campestris. It is produced by the fermentation of glucose, sucrose, or lactose by the Xanthomonas campestris bacterium. After a fermentation period, the polysaccharide is precipitated from a growth medium with isopropyl alcohol, dried, and ground into a fine powder. Later, it is added to a liquid medium to form the gum.

Xanthan gum is a natural polysaccharide consisting of different sugars which are connected by several different bonds, such as β-D-mannosyl-β-D-1,4-glucuronosyl bonds and β-D-glucosyl-β-D-1,4-glucosyl bonds. Xanthan gum is at least partly soluble in water and forms highly viscous solutions or gels. Complete enzymatic degradation of xanthan gum requires several enzymes, including xanthan lyase, endoglucanase (β-D-glucanase), β-D-glucosidase and α-D-mannosidase (Nankai et al. (1999) “Microbial system for polysaccharide depolymerization: enzymatic route for xanthan depolymerization by Bacillus sp. Strain GL1”, App. Environ. Microbiol. 65(6): 2520-2526).

Xanthan lyases are enzymes that cleave the β-D-mannosyl-β-D-1,4-glucuronosyl bond of xanthan and have been described in the literature (e.g. Ruijssenaars et al. (1999) “A pyruvated mannose-specific xanthan lyase involved in xanthan degradation by Paenibacillus alginolyticus XL-1”, Appl. Environ. Microbiol. 65(6): 2446-2452, and Ruijssenaars et al. (2000), “A novel gene encoding xanthan lyase of Paenibacillus alginolyticus strain XL-1”′, Appl. Environ. Microbiol. 66(9): 3945-3950).

Glycoside hydrolases (GH) are enzymes that catalyse the hydrolysis of the glycosyl bond to release smaller sugars. There are over 100 classes of glycoside hydrolases which have been classified, see e.g. Henrissat et al. (1991) “A classification of glycosyl hydrolases based on amino-acid sequence similarities”, Biochem. J. 280(2): 309-316 and the CAZY website at www.cazy.org. α-D-mannosidase (3.2.1.24) activity has been found in the glycoside hydrolases GH38 and GH92. Endoglucanase (EC 3.2.1.4) and β-glucosidase (EC 3.2.1.21) activity has been found in the glycoside hydrolase family 9 (GH9). The GH9 family consists of over 70 different enzymes that are mostly endoglucanases (EC 3.2.1.4), cellobiohydrolase (EC 3.2.1.91), β-glucosidase (EC 3.2.1.21) and exo-β-glucosaminidase (EC 3.2.1.165).

Anti-redeposition agents are compounds, such as polymers or enzymes, which prevent soils which are in the wash liquor from depositing back onto the textile, fabric or hard surface. The redeposition can occur anywhere on the same textile, fabric or hard surface or onto another textile, fabric or hard surface which is washed at the same time. Whilst not wishing to be bound by theory, the washing process generally works by reducing the particle size and/or molecular weight of the soil fragment which then facilitates the soils to remain suspended in the wash liquor. Anti-redeposition agents can be added which keep detached soils as individual entities in solution and prevents re-combination that can give rise to grit formation. Anti-redeposition agents, especially enzymes which have anti-redeposition properties, can also help to detach soils from the soiled surfaces. This, in combination with soil suspension, contributes to a more effective enzymatic cleaning and results in better shine and reduced filming and spotting on the washed items.

In recent years, xanthan gum has been use as an ingredient in many consumer products including foods (e.g. as thickening agent in salat dressings and dairy products), cosmetics (e.g. as stabilizer and thickener in toothpaste and make-up to prevent ingredients from separating) and sun cream products. There is therefore an interest in removing food and cosmetic stains/soils from textiles and hard surfaces and ensuring that the stains/soils do not redeposit back onto the textile or hard surface.

This invention provides methods that can reduce soil redeposition by using detergent compositions comprising isolated polypeptides having xanthan lyase activity and optionally isolated GH9 endoglucanases.

### SUMMARY OF THE INVENTION

In one aspect, the invention relates to a method for reducing or preventing soil redeposition using a detergent composition comprising an isolated polypeptide having xanthan lyase activity selected from the group consisting of:
(a) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 4;
(b) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 46;
(c) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 60;
(d) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 64;
(e) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 106;
(f) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 110;
(g) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 114;
(h) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 118;
(i) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 122;
(j) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 126;
(k) a polypeptide encoded by a polynucleotide that hybridizes under medium stringency conditions, medium-high stringency conditions, high stringency conditions, or very high stringency conditions with:
   (i) the mature polypeptide coding sequence of SEQ ID NO: 3;
   (ii) the mature polypeptide coding sequence of SEQ ID NO: 45;
   (iii) the mature polypeptide coding sequence of SEQ ID NO: 59;
   (iv) the mature polypeptide coding sequence of SEQ ID NO: 63;
   (v) the mature polypeptide coding sequence of SEQ ID NO: 105;
   (vi) the mature polypeptide coding sequence of SEQ ID NO: 109;
   (vii) the mature polypeptide coding sequence of SEQ ID NO: 113;
   (viii) the mature polypeptide coding sequence of SEQ ID NO: 117;
   (ix) the mature polypeptide coding sequence of SEQ ID NO: 121;
   (x) the mature polypeptide coding sequence of SEQ ID NO: 125; or
   (xi) the full-length complement thereof of (i), (ii), (iii), (iv), (v), (vi), (vii), (viii), (ix), or (x);
(l) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 3;
(m) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 45;
(n) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 59;
(o) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 63;
(p) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 105;
(q) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 109;
(r) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 113;
(s) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 117;
(t) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 121;
(u) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 125;
(v) a variant of the mature polypeptide of SEQ ID NO: 4, SEQ ID NO: 46, SEQ ID NO: 60, SEQ ID NO: 64, SEQ ID NO: 106, SEQ ID NO: 110, SEQ ID NO: 114, SEQ ID NO: 118, SEQ ID NO: 122 or SEQ ID NO: 126 comprising a substitution, deletion, and/or insertion at one or more positions (e.g. several); and
(w) a fragment of the polypeptide of (a), (b), (c), (d), (e), (f), (g), (h), (i), (j), (k), (l), (m), (n), (o), (p), (q), (r), (s), (t), (u) or (v) that has xanthan lyase activity.

An embodiment of the invention is a method for reducing or preventing soil redeposition using a detergent composition comprising an isolated polypeptide having xanthan lyase activity and an isolated GH9 endoglucanase. A further embodiment is a method for reducing or preventing soil redeposition using a detergent composition comprising one of more detergent components and/or one or more further enzymes.

A further aspect of the invention is the use of a detergent composition for reducing or preventing soil redeposition comprising an isolated polypeptide having xanthan lyase activity selected from the group consisting of:
(a) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 4;
(b) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 46;
(c) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 60;
(d) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 64;
(e) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 106;
(f) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 110;
(g) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 114;
(h) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 118;
(i) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 122;
(j) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 126;
(k) a polypeptide encoded by a polynucleotide that hybridizes under medium stringency conditions, medium-high stringency conditions, high stringency conditions, or very high stringency conditions with:
   (i) the mature polypeptide coding sequence of SEQ ID NO: 3;
   (ii) the mature polypeptide coding sequence of SEQ ID NO: 45;
   (iii) the mature polypeptide coding sequence of SEQ ID NO: 59;
   (iv) the mature polypeptide coding sequence of SEQ ID NO: 63;
   (v) the mature polypeptide coding sequence of SEQ ID NO: 105;
   (vi) the mature polypeptide coding sequence of SEQ ID NO: 109;
   (vii) the mature polypeptide coding sequence of SEQ ID NO: 113;
   (viii) the mature polypeptide coding sequence of SEQ ID NO: 117;
   (ix) the mature polypeptide coding sequence of SEQ ID NO: 121;
   (x) the mature polypeptide coding sequence of SEQ ID NO: 125; or
   (xi) the full-length complement thereof of (i), (ii), (iii), (iv), (v), (vi), (vii), (viii), (ix), or (x);
(l) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 3;
(m) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 45;
(n) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 59;
(o) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 63;
(p) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 105;
(q) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 109;
(r) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 113;
(s) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 117;
(t) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 121;
(u) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 125;
(v) a variant of the mature polypeptide of SEQ ID NO: 4, SEQ ID NO: 46, SEQ ID NO: 60, SEQ ID NO: 64, SEQ ID NO: 106, SEQ ID NO: 110, SEQ ID NO: 114, SEQ ID NO: 118, SEQ ID NO: 122 or SEQ ID NO: 126 comprising a substitution, deletion, and/or insertion at one or more positions (e.g. several); and
(w) a fragment of the polypeptide of (a), (b), (c), (d), (e), (f), (g), (h), (i), (j), (k), (l), (m), (n), (o), (p), (q), (r), (s), (t), (u) or (v) that has xanthan lyase activity.

An embodiment of the invention is the use of a detergent composition for reducing or preventing soil redeposition comprising an isolated polypeptide having xanthan lyase activity and an isolated GH9 endoglucanase.

In an embodiment of the invention the detergent composition also comprises an isolated GH9 endoglucanase selected from the group consisting of:
(a) the polypeptide corresponding to amino acids 1 to 1055 of SEQ ID NO: 2;
(b) the polypeptide corresponding to amino acids 1 to 918 of SEQ ID NO: 10;
(c) the polypeptide corresponding to amino acids 1 to 916 of SEQ ID NO: 12;
(d) the polypeptide corresponding to amino acids 1 to 918 of SEQ ID NO: 14;
(e) the polypeptide corresponding to amino acids 1 to 1007 of SEQ ID NO: 48;
(f) the polypeptide corresponding to amino acids 1 to 915 of SEQ ID NO: 52;
(g) the polypeptide corresponding to amino acids 1 to 1056 of SEQ ID NO: 56;
(h) the polypeptide corresponding to amino acids 1 to 1371 of SEQ ID NO: 82;
(i) the polypeptide corresponding to amino acids 1 to 1203 of SEQ ID NO: 86;
(j) the polypeptide corresponding to amino acids 1 to 1379 of SEQ ID NO: 90;
(k) the polypeptide corresponding to amino acids 1 to 1371 of SEQ ID NO: 94;
(l) the polypeptide corresponding to amino acids 1 to 1372 of SEQ ID NO: 98;
(m) the polypeptide corresponding to amino acids 1 to 922 of SEQ ID NO: 102;
(n) the polypeptide corresponding to amino acids 1 to 916 of SEQ ID NO: 130;
(n) the polypeptide corresponding to amino acids 1 to 1373 of SEQ ID NO: 134; and
(o) the polypeptide corresponding to amino acids 1 to 1204 of SEQ ID NO: 138.

### OVERVIEW OF SEQUENCE LISTING

SEQ ID NO: 1 is the DNA sequence of the GH9 endoglucanase as isolated from Paenibacillus sp NN062047.

SEQ ID NO: 2 is the amino acid sequence as deduced from SEQ ID NO: 1.

SEQ ID NO: 3 is the truncated DNA sequence of the xanthan lyase as isolated from Paenibacillus sp NN018054.

SEQ ID NO: 4 is the amino acid sequence as deduced from SEQ ID NO: 3.

SEQ ID NO: 5 is the DNA sequence of the recombinant expressed sequence from SEQ ID NO: 1 operably linked with a His-tag.

SEQ ID NO: 6 is the amino acid sequence as deduced from SEQ ID NO: 5.

SEQ ID NO: 7 is the DNA sequence of the recombinant expressed sequence from SEQ ID NO: 3 operably linked with a His-tag.

SEQ ID NO: 8 is the amino acid sequence as deduced from SEQ ID NO: 7.

SEQ ID NO: 9 is the DNA sequence of the GH9 endoglucanase as isolated from Microbacterium sp NN062149.

SEQ ID NO: 10 is the amino acid sequence as deduced from SEQ ID NO: 9.

SEQ ID NO: 11 is the DNA sequence of the GH9 endoglucanase as isolated from Microbacterium sp NN062148.

SEQ ID NO: 12 is the amino acid sequence as deduced from SEQ ID NO: 11.

SEQ ID NO: 13 is the DNA sequence of the GH9 endoglucanase as isolated from Microbacterium sp NN062045.

SEQ ID NO: 14 is the amino acid sequence as deduced from SEQ ID NO: 13.

SEQ ID NO: 15 is the DNA sequence of the recombinant expressed sequence from SEQ ID NO: 9 operably linked with a His-tag.

SEQ ID NO: 16 is the amino acid sequence as deduced from SEQ ID NO: 15.

SEQ ID NO: 17 is the DNA sequence of the recombinant expressed sequence from SEQ ID NO: 11 operably linked with a His-tag.

SEQ ID NO: 18 is the amino acid sequence as deduced from SEQ ID NO: 17.

SEQ ID NO: 19 is the DNA sequence of the recombinant expressed sequence from SEQ ID NO: 13 operably linked with a His-tag.

SEQ ID NO: 20 is the amino acid sequence as deduced from SEQ ID NO: 19.

SEQ ID NO: 21 is Primer D88F.

SEQ ID NO: 22 is Primer D89R.

SEQ ID NO: 23 is Primer D124F.

SEQ ID NO: 24 is Primer D125R.

SEQ ID NO: 25 is Primer D126F.

SEQ ID NO: 26 is Primer D127R.

SEQ ID NO: 27 is Primer D128F.

SEQ ID NO: 28 is Primer D129R.

SEQ ID NO: 29 is the DNA sequence of the Savinase signal peptide.

SEQ ID NO: 30 is the His-Tag (also called poly-histidine tag).

SEQ ID NO: 31 is Primer D117F.

SEQ ID NO: 32 is Primer D118R.

SEQ ID NO: 33 is Primer D158F.

SEQ ID NO: 34 is Primer D159R.

SEQ ID NO: 35 is Primer D168F.

SEQ ID NO: 36 is Primer D169R.

SEQ ID NO: 37 is Primer D170F.

SEQ ID NO: 38 is Primer D170R.

SEQ ID NO: 39 is Primer D171F.

SEQ ID NO: 40 is Primer D172R.

SEQ ID NO: 41 is Primer D160F.

SEQ ID NO: 42 is Primer D161R.

SEQ ID NO: 43 is Primer F-C3AQX.

SEQ ID NO: 44 is Primer R-C3AQX.

SEQ ID NO: 45 is the full length DNA sequence of the xanthan lyase as isolated from Paenibacillus sp NN018054.

SEQ ID NO: 46 is the amino acid sequence as deduced from SEQ ID NO: 45.

SEQ ID NO: 47 is the DNA sequence of the truncated GH9 endoglucanase as isolated from Paenibacillus sp NN062047

SEQ ID NO: 48 is the amino acid sequence as deduced from SEQ ID NO: 47.

SEQ ID NO: 49 is the DNA sequence of the recombinant expressed sequence from SEQ ID NO: 47 operably linked with a His-tag.

SEQ ID NO: 50 is the amino acid sequence as deduced from SEQ ID NO: 49.

SEQ ID NO: 51 is the DNA sequence of the truncated GH9 endoglucanase as isolated from Paenibacillus sp NN062047.

SEQ ID NO: 52 is the amino acid sequence as deduced from SEQ ID NO: 51.

SEQ ID NO: 53 is the DNA sequence of the recombinant expressed sequence from SEQ ID NO: 51 operably linked with a His-tag.

SEQ ID NO: 54 is the amino acid sequence as deduced from SEQ ID NO: 53.

SEQ ID NO: 55 is the DNA sequence of the GH9 endoglucanase as isolated from Paenibacillus sp NN062253.

SEQ ID NO: 56 is the amino acid sequence as deduced from SEQ ID NO: 55

SEQ ID NO: 57 is the DNA sequence of the recombinant expressed sequence from SEQ ID NO: 55 operably linked with a His-tag.

SEQ ID NO: 58 is the amino acid sequence as deduced from SEQ ID NO: 57.

SEQ ID NO: 59 is the DNA sequence of the xanthan lyase as isolated from Paenibacillus sp NN062250.

SEQ ID NO: 60 is the amino acid sequence as deduced from SEQ ID NO: 59.

SEQ ID NO: 61 is the DNA sequence of the recombinant expressed sequence from SEQ ID NO: 59 operably linked with a His-tag.

SEQ ID NO: 62 is the amino acid sequence as deduced from SEQ ID NO: 61.

SEQ ID NO: 63 is the DNA sequence of the xanthan lyase as isolated from Paenibacillus sp NN062047.

SEQ ID NO: 64 is the amino acid sequence as deduced from SEQ ID NO: 63.

SEQ ID NO: 65 is the DNA sequence of the recombinant expressed sequence from SEQ ID NO: 63 operably linked with a His-tag.

SEQ ID NO: 66 is the amino acid sequence as deduced from SEQ ID NO: 65.

SEQ ID NO: 67 is the DNA sequence of the recombinant expressed sequence from SEQ ID NO: 45 operably linked with a His-tag.

SEQ ID NO: 68 is the amino acid sequence as deduced from SEQ ID NO: 67.

SEQ ID NO: 69 is Primer D244F.

SEQ ID NO: 70 is Primer D245R.

SEQ ID NO: 71 is Primer D242F.

SEQ ID NO: 72 is Primer D243R.

SEQ ID NO: 73 is Primer D271F.

SEQ ID NO: 74 is Primer D272R.

SEQ ID NO: 75 is Primer D289F.

SEQ ID NO: 76 is Primer D290R.

SEQ ID NO: 77 is Primer D293F.

SEQ ID NO: 78 is Primer D294R.

SEQ ID NO: 79 is Primer D332F.

SEQ ID NO: 80 is Primer D333R.

SEQ ID NO: 81 is the DNA sequence of the GH9 endoglucanase as isolated from Paenibacillus sp NN062046.

SEQ ID NO: 82 is the amino acid sequence as deduced from SEQ ID NO: 81.

SEQ ID NO: 83 is the DNA sequence of the recombinant expressed sequence from SEQ ID NO: 81 operably linked with a His-tag.

SEQ ID NO: 84 is the amino acid sequence as deduced from SEQ ID NO: 83.

SEQ ID NO: 85 is the DNA sequence of the truncated GH9 endoglucanase as isolated from Paenibacillus sp NN018054.

SEQ ID NO: 86 is the amino acid sequence as deduced from SEQ ID NO: 85.

SEQ ID NO: 87 is the DNA sequence of the recombinant expressed sequence from SEQ ID NO: 85.

SEQ ID NO: 88 is the amino acid sequence as deduced from SEQ ID NO: 87.

SEQ ID NO: 89 is the DNA sequence of the GH9 endoglucanase as isolated from Paenibacillus sp NN062408.

SEQ ID NO: 90 is the amino acid sequence as deduced from SEQ ID NO: 89.

SEQ ID NO: 91 is the DNA sequence of the recombinant expressed sequence from SEQ ID NO: 89.

SEQ ID NO: 92 is the amino acid sequence as deduced from SEQ ID NO: 91.

SEQ ID NO: 93 is the DNA sequence of the GH9 endoglucanase as isolated from Paenibacillus sp NN018054.

SEQ ID NO: 94 is the amino acid sequence as deduced from SEQ ID NO: 93.

SEQ ID NO: 95 is the DNA sequence of the recombinant expressed sequence from SEQ ID NO: 93 operably linked with a His-tag.

SEQ ID NO: 96 is the amino acid sequence as deduced from SEQ ID NO: 95.

SEQ ID NO: 97 is the DNA sequence of the GH9 endoglucanase as isolated from Paenibacillus sp NN062332.

SEQ ID NO: 98 is the amino acid sequence as deduced from SEQ ID NO: 97.

SEQ ID NO: 99 is the DNA sequence of the recombinant expressed sequence from SEQ ID NO: 97 operably linked with a His-tag.

SEQ ID NO: 100 is the amino acid sequence as deduced from SEQ ID NO: 99.

SEQ ID NO: 101 is the DNA sequence of the GH9 endoglucanase as isolated from Microbacterium testaceum.

SEQ ID NO: 102 is the amino acid sequence as deduced from SEQ ID NO: 101.

SEQ ID NO: 103 is the DNA sequence of the recombinant expressed sequence from SEQ ID NO: 101 operably linked with a His-tag.

SEQ ID NO: 104 is the amino acid sequence as deduced from SEQ ID NO: 103.

SEQ ID NO: 105 is the DNA sequence of the xanthan lyase as isolated from Paenibacillus sp NN062147.

SEQ ID NO: 106 is the amino acid sequence as deduced from SEQ ID NO: 105.

SEQ ID NO: 107 is the DNA sequence of the recombinant expressed sequence from SEQ ID NO: 105 operably linked with a His-tag.

SEQ ID NO: 108 is the amino acid sequence as deduced from SEQ ID NO: 107.

SEQ ID NO: 109 is the DNA sequence of the xanthan lyase as isolated from Paenibacillus sp NN062193.

SEQ ID NO: 110 is the amino acid sequence as deduced from SEQ ID NO: 109.

SEQ ID NO: 111 is the DNA sequence of the recombinant expressed sequence from SEQ ID NO: 109 operably linked with a His-tag.

SEQ ID NO: 112 is the amino acid sequence as deduced from SEQ ID NO: 111.

SEQ ID NO: 113 is the DNA sequence of the xanthan lyase as isolated from Paenibacillus sp NN062408.

SEQ ID NO: 114 is the amino acid sequence as deduced from SEQ ID NO: 113.

SEQ ID NO: 115 is the DNA sequence of the recombinant expressed sequence from SEQ ID NO: 113 operably linked with a His-tag.

SEQ ID NO: 116 is the amino acid sequence as deduced from SEQ ID NO: 115.

SEQ ID NO: 117 is the DNA sequence of the xanthan lyase as isolated from Paenibacillus sp NN062332.

SEQ ID NO: 118 is the amino acid sequence as deduced from SEQ ID NO: 117.

SEQ ID NO: 119 is the DNA sequence of the recombinant expressed sequence from SEQ ID NO: 117 operably linked with a His-tag.

SEQ ID NO: 120 is the amino acid sequence as deduced from SEQ ID NO: 119.

SEQ ID NO: 121 is the DNA sequence of the xanthan lyase as isolated from Paenibacillus sp NN062046.

SEQ ID NO: 122 is the amino acid sequence as deduced from SEQ ID NO: 121.

SEQ ID NO: 123 is the DNA sequence of the recombinant expressed sequence from SEQ ID NO: 121 operably linked with a His-tag.

SEQ ID NO: 124 is the amino acid sequence as deduced from SEQ ID NO: 123.

SEQ ID NO: 125 is the DNA sequence of the xanthan lyase as isolated from Paenibacillus sp NN062253.

SEQ ID NO: 126 is the amino acid sequence as deduced from SEQ ID NO: 125.

SEQ ID NO: 127 is the DNA sequence of the recombinant expressed sequence from SEQ ID NO: 125 operably linked with a His-tag.

SEQ ID NO: 128 is the amino acid sequence as deduced from SEQ ID NO: 127.

SEQ ID NO: 129 is the DNA sequence of the xanthan lyase as isolated from Microbacterium sp NN062175.

SEQ ID NO: 130 is the amino acid sequence as deduced from SEQ ID NO: 129.

SEQ ID NO: 131 is the DNA sequence of the recombinant expressed sequence from SEQ ID NO: 129 operably linked with a His-tag.

SEQ ID NO: 132 is the amino acid sequence as deduced from SEQ ID NO: 131.

SEQ ID NO: 133 is the DNA sequence of the xanthan lyase as isolated from Paenibacillus sp NN062193.

SEQ ID NO: 134 is the amino acid sequence as deduced from SEQ ID NO: 133.

SEQ ID NO: 135 is the DNA sequence of the recombinant expressed sequence from SEQ ID NO: 133 operably linked with a His-tag.

SEQ ID NO: 136 is the amino acid sequence as deduced from SEQ ID NO: 135.

SEQ ID NO: 137 is the DNA sequence of the truncated xanthan lyase as isolated from Paenibacillus sp NN062193.

SEQ ID NO: 138 is the amino acid sequence as deduced from SEQ ID NO: 137.

SEQ ID NO: 139 is the DNA sequence of the recombinant expressed sequence from SEQ ID NO: 137 operably linked with a His-tag.

SEQ ID NO: 140 is the amino acid sequence as deduced from SEQ ID NO: 139.

SEQ ID NO: 141 is Primer F-C597B.

SEQ ID NO: 142 is Primer R-C597B.

SEQ ID NO: 143 is Primer F-C5B9G.

SEQ ID NO: 144 is Primer R-C5B9G.

SEQ ID NO: 145 is Primer F-C59T2.

SEQ ID NO: 146 is Primer R-C59T2.

SEQ ID NO: 147 is Primer F-C4AM9.

SEQ ID NO: 148 is Primer R-C4AM9.

SEQ ID NO: 149 is Primer F-C4AKF.

SEQ ID NO: 150 is Primer R-C4AKF.

SEQ ID NO: 151 is Primer F-C59TM.

SEQ ID NO: 152 is Primer R-C59TM.

SEQ ID NO: 153 is Primer F-C59SY.

SEQ ID NO: 154 is Primer R-C59SY.

SEQ ID NO: 155 is Primer F-C3AX4.

SEQ ID NO: 156 is Primer R-C3AX4.

SEQ ID NO: 157 is Primer F-C4AKA.

SEQ ID NO: 158 is Primer R-C4AKA.

SEQ ID NO: 159 is Primer F-C3BXT.

SEQ ID NO: 160 is Primer R-C3BXT.

SEQ ID NO: 161 is Primer F-C597E.

SEQ ID NO: 162 is Primer R-C597E.

SEQ ID NO: 163 is Primer F-C597F.

SEQ ID NO: 164 is Primer R-C597F.

SEQ ID NO: 165 is Primer F-C3FCE.

SEQ ID NO: 166 is Primer R-C3FCE.

SEQ ID NO: 167 is Primer D14KMG.

SEQ ID NO: 168 is Primer D14KMH.

SEQ ID NO: 169 is Primer D14N38.

SEQ ID NO: 170 is Primer D14N39.

IDENTITY MATRIX OF XANTHAN LYASE SEQUENCES

| | SEQ | SEQ | SEQ | SEQ | SEQ | SEQ | SEQ | SEQ | SEQ | SEQ |
|---|---|---|---|---|---|---|---|---|---|---|
| | ID | ID | ID | ID | ID | ID | ID | ID | ID | ID |
| | NO: | NO: | NO: | NO: | NO: | NO: | NO: | NO: | NO: | NO: |
| | 4 | 46 | 60 | 64 | 106 | 110 | 114 | 118 | 122 | 126 |
| SEQ ID NO: 4 | 100 | 100 | 50.8 | 66.1 | 52.1 | 53.3 | 50.3 | 53 | 55.8 | 66.2 |
| SEQ ID NO: 46 | 100 | 100 | 48.4 | 62.0 | 49.4 | 50.8 | 47.9 | 50.3 | 49.1 | 64.9 |
| SEQ ID NO: 60 | 50.8 | 48.4 | 100 | 51.7 | 64.5 | 68.9 | 63.6 | 68.9 | 46.8 | 46.5 |
| SEQ ID NO: 64 | 66.1 | 62.0 | 51.7 | 100 | 52.9 | 52.1 | 51.8 | 53.5 | 52.2 | 81.1 |
| SEQ ID NO: 106 | 52.1 | 49.4 | 64.5 | 52.9 | 100 | 64.3 | 60.6 | 63.8 | 47.6 | 48.0 |
| SEQ ID NO: 110 | 53.3 | 50.8 | 68.9 | 52.1 | 64.3 | 100 | 64.2 | 67.3 | 47.2 | 49.5 |
| SEQ ID NO: 114 | 50.3 | 47.9 | 63.6 | 51.8 | 60.6 | 64.2 | 100 | 65.4 | 45.6 | 48.6 |
| SEQ ID NO: 118 | 53 | 50.3 | 68.9 | 53.5 | 63.8 | 67.3 | 65.4 | 100 | 48.0 | 49.6 |
| SEQ ID NO: 122 | 55.8 | 49.1 | 46.8 | 52.2 | 47.6 | 47.2 | 45.6 | 48.0 | 100 | 55.9 |
| SEQ ID NO: 126 | 66.2 | 64.9 | 46.5 | 81.1 | 48.0 | 49.5 | 48.6 | 49.6 | 55.9 | 100 |

IDENTITY MATRIX OF GH9 ENDOGLUCANASE SEQUENCES

| | SEQ | SEQ | SEQ | SEQ | SEQ | SEQ | SEQ | SEQ | SEQ | SEQ | SEQ | SEQ | SEQ | SEQ | SEQ | SEQ |
|---|---|---|---|---|---|---|---|---|---|---|---|---|---|---|---|---|
| | ID | ID | ID | ID | ID | ID | ID | ID | ID | ID | ID | ID | ID | ID | ID | ID |
| | NO: | NO: | NO: | NO: | NO: | NO: | NO: | NO: | NO: | NO: | NO: | NO: | NO: | NO: | NO: | NO: |
| | 2 | 10 | 12 | 14 | 48 | 52 | 56 | 82 | 86 | 90 | 94 | 98 | 102 | 130 | 134 | 138 |
| SEQ 2 | 100 | 51.3 | 49.9 | 50.0 | 62.7 | 64.7 | 81.2 | 51.6 | 55.5 | 49.7 | 53.9 | 53.4 | 48.5 | 50.7 | 52.9 | 56.2 |
| SEQ 10 | 51.3 | 100 | 78.7 | 78.3 | 47.9 | 47.9 | 51.7 | 54.1 | 52.1 | 52.0 | 52.1 | 52.8 | 79.3 | 78.9 | 52.6 | 52.6 |
| SEQ 12 | 49.9 | 78.7 | 100 | 74.3 | 48.4 | 48.4 | 50.8 | 53.6 | 52.6 | 51.6 | 52.6 | 53.4 | 84.6 | 99.7 | 53.4 | 53.4 |
| SEQ 14 | 50.0 | 78.3 | 74.3 | 100 | 48.4 | 48.4 | 50.8 | 51.3 | 52.3 | 53.2 | 52.3 | 52.8 | 74.2 | 74.4 | 53.5 | 53.5 |
| SEQ 48 | 62.7 | 47.9 | 48.4 | 48.4 | 100 | 100 | 62.0 | 54.4 | 56.1 | 49.4 | 54.1 | 54.5 | 48.5 | 48.4 | 53.9 | 56.3 |
| SEQ 52 | 64.7 | 47.9 | 48.4 | 48.4 | 100 | 100 | 64.8 | 55.4 | 56.1 | 51.9 | 56.1 | 56.7 | 48.5 | 48.4 | 56.5 | 56.5 |
| SEQ 56 | 81.2 | 51.7 | 50.8 | 50.8 | 62.0 | 64.8 | 100 | 53.2 | 56.1 | 52.3 | 54.5 | 54.0 | 50.0 | 51.0 | 53.0 | 56.3 |
| SEQ 82 | 51.6 | 54.1 | 53.6 | 51.3 | 54.4 | 55.4 | 53.2 | 100 | 70.5 | 63.5 | 69.8 | 69.9 | 53.7 | 53.9 | 66.4 | 66.6 |
| SEQ 86 | 55.5 | 52.1 | 52.6 | 52.3 | 56.1 | 56.1 | 56.1 | 70.5 | 100 | 66.8 | 100 | 73.1 | 51.9 | 52.8 | 68.4 | 68.2 |
| SEQ 90 | 49.7 | 52.0 | 51.6 | 53.2 | 49.4 | 51.9 | 52.3 | 63.5 | 66.8 | 100 | 67.7 | 68.0 | 52.0 | 52.1 | 64.3 | 64.9 |
| SEQ 94 | 53.9 | 52.1 | 52.6 | 52.3 | 54.1 | 56.1 | 54.5 | 69.8 | 100 | 67.7 | 100 | 72.8 | 51.9 | 52.8 | 68.2 | 68.2 |
| SEQ 98 | 53.4 | 52.8 | 53.4 | 52.8 | 54.5 | 56.7 | 54.0 | 69.9 | 73.1 | 68.0 | 72.8 | 100 | 54.2 | 53.5 | 67.7 | 67.9 |
| SEQ 102 | 48.5 | 79.3 | 84.6 | 74.2 | 48.5 | 48.5 | 50.0 | 53.7 | 51.9 | 52.0 | 51.9 | 54.2 | 100 | 84.7 | 52.2 | 52.2 |
| SEQ 130 | 50.7 | 78.9 | 99.7 | 74.4 | 48.4 | 48.4 | 51.0 | 53.9 | 52.8 | 52.1 | 52.8 | 53.5 | 84.7 | 100 | 53.5 | 53.5 |
| SEQ 134 | 52.9 | 52.6 | 53.4 | 53.5 | 53.9 | 56.5 | 53.0 | 66.4 | 68.4 | 64.3 | 68.2 | 67.7 | 52.2 | 53.5 | 100 | 100 |
| SEQ 138 | 56.2 | 52.6 | 53.4 | 53.5 | 56.3 | 56.5 | 56.3 | 66.6 | 68.2 | 64.9 | 68.2 | 67.9 | 52.2 | 53.5 | 100 | 100 |

### DEFINITIONS

Allelic variant: The term “allelic variant” means any of two or more alternative forms of a gene occupying the same chromosomal locus. Allelic variation arises naturally through mutation, and may result in polymorphism within populations. Gene mutations can be silent (no change in the encoded polypeptide) or may encode polypeptides having altered amino acid sequences. An allelic variant of a polypeptide is a polypeptide encoded by an allelic variant of a gene.

Anti-redeposition: The term “anti-redeposition” or “anti-redeposition effect” means the reduction or prevention of soil from depositing back onto the textile, fabric or hard surface. The anti-redeposition effect can be determined using the Mini-LOM or TOM wash assay as described in the examples herein.

Catalytic domain: The term “catalytic domain” means the region of an enzyme containing the catalytic machinery of the enzyme.

cDNA: The term “cDNA” means a DNA molecule that can be prepared by reverse transcription from a mature, spliced, mRNA molecule obtained from a eukaryotic or prokaryotic cell. cDNA lacks intron sequences that may be present in the corresponding genomic DNA. The initial, primary RNA transcript is a precursor to mRNA that is processed through a series of steps, including splicing, before appearing as mature spliced mRNA.

Coding sequence: The term “coding sequence” means a polynucleotide, which directly specifies the amino acid sequence of a polypeptide. The boundaries of the coding sequence are generally determined by an open reading frame, which begins with a start codon such as ATG, GTG, or TTG and ends with a stop codon such as TAA, TAG, or TGA. The coding sequence may be a genomic DNA, cDNA, synthetic DNA, or a combination thereof.

Control sequences: The term “control sequences” means nucleic acid sequences necessary for expression of a polynucleotide encoding a mature polypeptide of the present invention. Each control sequence may be native (i.e., from the same gene) or foreign (i.e., from a different gene) to the polynucleotide encoding the polypeptide or native or foreign to each other. Such control sequences include, but are not limited to, a leader, polyadenylation sequence, propeptide sequence, promoter, signal peptide sequence, and transcription terminator. At a minimum, the control sequences include a promoter, and transcriptional and translational stop signals. The control sequences may be provided with linkers for the purpose of introducing specific restriction sites facilitating ligation of the control sequences with the coding region of the polynucleotide encoding a polypeptide.

Delta remission value (ΔRem): The terms “Delta remission” or “Delta remission value” are defined herein as the result of a reflectance or remission measurement at 460 nm. Measurements were made on washed swatches with and without enzymes. The test swatch to be measured was placed on top of another swatch of same type and colour (twin swatch). Remission values for individual swatches were calculated by subtracting the remission value of the washed swatch with detergent only from the remission value of the washed swatch with enzymes and detergent

Enzyme Detergency benefit: The term “enzyme detergency benefit” is defined herein as the advantageous effect an enzyme or combination of enzyme may add to a detergent compared to the same detergent without the enzyme/combination of enzyme. Important detergency benefits which can be provided by enzymes are stain removal with no or very little visible soils after washing and/or cleaning, prevention or reduction of redeposition of soils released in the washing process (an effect that also is termed anti-redeposition), restoring fully or partly the whiteness of textiles which originally were white but after repeated use and wash have obtained a greyish or yellowish appearance (an effect that also is termed whitening). Textile care benefits, which are not directly related to catalytic stain removal or prevention of redeposition of soils, are also important for enzyme detergency benefits. Examples of such textile care benefits are prevention or reduction of dye transfer from one fabric to another fabric or another part of the same fabric (an effect that is also termed dye transfer inhibition or anti-backstaining), removal of protruding or broken fibers from a fabric surface to decrease pilling tendencies or remove already existing pills or fuzz (an effect that also is termed anti-pilling), improvement of the fabric-softness, colour clarification of the fabric and removal of particulate soils which are trapped in the fibers of the fabric or garment. Enzymatic bleaching is a further enzyme detergency benefit where the catalytic activity generally is used to catalyze the formation of bleaching components such as hydrogen peroxide or other peroxides.

Detergent component: the term “detergent component” is defined herein to mean the types of chemicals which can be used in detergent compositions. Examples of detergent components are surfactants, hydrotropes, builders, co-builders, chelators or chelating agents, bleaching system or bleach components, polymers, fabric hueing agents, fabric conditioners, foam boosters, suds suppressors, dispersants, dye transfer inhibitors, fluorescent whitening agents, perfume, optical brighteners, bactericides, fungicides, soil suspending agents, soil release polymers, anti-redeposition agents, enzyme inhibitors or stabilizers, enzyme activators, antioxidants, and solubilizers. The detergent composition may comprise one or more of any type of detergent component.

Detergent composition: the term “detergent composition” refers to compositions that find use in the removal of undesired compounds from items to be cleaned, such as textiles, dishes, and hard surfaces. The detergent composition may be used to e.g. clean textiles, dishes and hard surfaces for both household cleaning and industrial cleaning. The terms encompass any materials/compounds selected for the particular type of cleaning composition desired and the form of the product (e.g., liquid, gel, powder, granulate, paste, or spray compositions) and includes, but is not limited to, detergent compositions (e.g., liquid and/or solid laundry detergents and fine fabric detergents; hard surface cleaning formulations, such as for glass, wood, ceramic and metal counter tops and windows; carpet cleaners; oven cleaners; fabric fresheners; fabric softeners; and textile and laundry pre-spotters, as well as dish wash detergents). In addition to containing a xanthan lyase of the invention and optionally a GH9 endoglucanase of the invention, the detergent formulation may contain one or more additional enzymes (such as proteases, amylases, lipases, cutinases, cellulases, endoglucanases, xyloglucanases, pectinases, pectin lyases, xanthanases, peroxidaes, haloperoxygenases, catalases and mannanases, or any mixture thereof), and/or components such as surfactants, builders, chelators or chelating agents, bleach system or bleach components, polymers, fabric conditioners, foam boosters, suds suppressors, dyes, perfume, tannish inhibitors, optical brighteners, bactericides, fungicides, soil suspending agents, anti corrosion agents, enzyme inhibitors or stabilizers, enzyme activators, transferase(s), hydrolytic enzymes, oxido reductases, bluing agents and fluorescent dyes, antioxidants, and solubilizers.

Dish wash: The term “dish wash” refers to all forms of washing dishes, e.g. by hand or automatic dish wash. Washing dishes includes, but is not limited to, the cleaning of all forms of crockery such as plates, cups, glasses, bowls, all forms of cutlery such as spoons, knives, forks and serving utensils as well as ceramics, plastics, metals, china, glass and acrylics.

Dish washing composition: The term “dish washing composition” refers to all forms of compositions for cleaning hard surfaces. The present invention is not restricted to any particular type of dish wash composition or any particular detergent.

Endo-β-1,4-glucanase activity: The term “endo-β-1,4-glucanase activity” means an enzyme that can catalyse the endohydrolysis of 1,4-beta-D-glycosidic linkages in cellulose, cellulose derivatives (such as carboxymethyl cellulose and hydroxyethyl cellulose), lichenin, beta-1,4 bonds in mixed beta-1,3 glucans such as cereal beta-D-glucans, xyloglucans, xanthans and other plant material containing cellulosic components.

Endoglucanase: The term “endoglucanase” means an endo-1,4-(1,3;1,4)-beta-D-glucan 4-glucanohydrolase (E.C. 3.2.1.4) that catalyzes endohydrolysis of 1,4-beta-D-glycosidic linkages in cellulose, cellulose derivatives (such as carboxymethyl cellulose and hydroxyethyl cellulose), lichenin, beta-1,4 bonds in mixed beta-1,3 glucans such as cereal beta-D-glucans, xyloglucans, xanthans and other plant material containing cellulosic components. Endoglucanase activity can be determined by measuring reduction in substrate viscosity or increase in reducing ends determined by a reducing sugar assay (Zhang et al., 2006, Biotechnology Advances 24: 452-481). For purposes of the present invention, endoglucanase activity is determined using carboxymethyl cellulose (CMC) as substrate according to the procedure of Ghose, 1987, Pure and Appl. Chem. 59: 257-268, at pH 5, 40° C.

Expression: The term “expression” includes any step involved in the production of a polypeptide including, but not limited to, transcription, post-transcriptional modification, translation, post-translational modification, and secretion.

Expression vector: The term “expression vector” means a linear or circular DNA molecule that comprises a polynucleotide encoding a polypeptide and is operably linked to control sequences that provide for its expression.

Fragment: The term “fragment” means a polypeptide or a catalytic domain having one or more (e.g., several) amino acids absent from the amino and/or carboxyl terminus of a mature polypeptide or domain; wherein the fragment has improved enzyme detergency benefit, preferably on xanthan gum.

Hard surface cleaning: The term “Hard surface cleaning” is defined herein as cleaning of hard surfaces wherein hard surfaces may include floors, tables, walls, roofs etc. as well as surfaces of hard objects such as cars (car wash) and dishes (dish wash). Dish washing includes but are not limited to cleaning of plates, cups, glasses, bowls, and cutlery such as spoons, knives, forks, serving utensils, ceramics, plastics, metals, china, glass and acrylics.

Host cell: The term “host cell” means any cell type that is susceptible to transformation, transfection, transduction, or the like with a nucleic acid construct or expression vector comprising a polynucleotide of the present invention. The term “host cell” encompasses any progeny of a parent cell that is not identical to the parent cell due to mutations that occur during replication.

Isolated: The term “isolated” means a substance in a form or environment that does not occur in nature. Non-limiting examples of isolated substances include (1) any non-naturally occurring substance, (2) any substance including, but not limited to, any enzyme, variant, nucleic acid, protein, peptide or cofactor, that is at least partially removed from one or more or all of the naturally occurring constituents with which it is associated in nature; (3) any substance modified by the hand of man relative to that substance found in nature; or (4) any substance modified by increasing the amount of the substance relative to other components with which it is naturally associated (e.g., multiple copies of a gene encoding the substance; use of a stronger promoter than the promoter naturally associated with the gene encoding the substance). An isolated substance may be present in a fermentation broth sample.

Laundering: The term “laundering” relates to both household laundering and industrial laundering and means the process of treating textiles and/or fabrics with a solution containing a detergent composition of the present invention. The laundering process can for example be carried out using e.g. a household or an industrial washing machine or can be carried out by hand.

Mature polypeptide: The term “mature polypeptide” means a polypeptide in its final form following translation and any post-translational modifications, such as N-terminal processing, C-terminal truncation, glycosylation, phosphorylation, etc. In one aspect, the mature polypeptide is amino acids 1 to 1055 of SEQ ID NO: 2 based on the SignalP program (Nielsen et al., 1997, Protein Engineering 10: 1-6) that predicts amino acids -38 to -1 of SEQ ID NO: 2 are a signal peptide. In another aspect, the mature polypeptide is amino acids 1 to 918 of SEQ ID NO: 10 based on the SignalP program that predicts amino acids -33 to -1 of SEQ ID NO: 10 are a signal peptide. In a further aspect, the mature polypeptide is amino acids 1 to 916 of SEQ ID NO: 12 based on the SignalP program that predicts amino acids -32 to -1 of SEQ ID NO: 12 are a signal peptide. In one aspect, the mature polypeptide is amino acids 1 to 918 of SEQ ID NO: 14 based on the SignalP program that predicts amino acids -33 to -1 of SEQ ID NO: 14 are a signal peptide. In another aspect, the mature polypeptide is amino acids 1 to 1007 of SEQ ID NO: 48 based on the SignalP program that predicts amino acids -36 to -1 of SEQ ID NO: 48 are a signal peptide. In a further aspect, the mature polypeptide is amino acids 1 to 915 of SEQ ID NO: 52 based on the SignalP program that predicts amino acids -36 to -1 of SEQ ID NO: 52 are a signal peptide. In an additional aspect, the mature polypeptide is amino acids 1 to 1056 of SEQ ID NO: 56 based on the SignalP program that predicts amino acids -38 to -1 of SEQ ID NO: 56 are a signal peptide.

In one aspect, the mature polypeptide is amino acids 1 to 1371 of SEQ ID NO: 82 based on the SignalP program that predicts amino acids -37 to -1 of SEQ ID NO: 82 are a signal peptide. In another aspect, the mature polypeptide is amino acids 1 to 1203 of SEQ ID NO: 86 based on the SignalP program that predicts amino acids -37 to -1 of SEQ ID NO: 86 are a signal peptide. In a further aspect, the mature polypeptide is amino acids 1 to 1379 of SEQ ID NO: 90 based on the SignalP program that predicts amino acids -37 to -1 of SEQ ID NO: 90 are a signal peptide. In an additional aspect, the mature polypeptide is amino acids 1 to 1371 of SEQ ID NO: 94 based on the SignalP program that predicts amino acids -37 to -1 of SEQ ID NO: 94 are a signal peptide. In one aspect, the mature polypeptide is amino acids 1 to 1372 of SEQ ID NO: 98 based on the SignalP program that predicts amino acids -37 to -1 of SEQ ID NO: 98 are a signal peptide. In another aspect, the mature polypeptide is amino acids 1 to 922 of SEQ ID NO: 102 based on the SignalP program that predicts amino acids -32 to -1 of SEQ ID NO: 102 are a signal peptide. In a further aspect, the mature polypeptide is amino acids 1 to 916 of SEQ ID NO: 130 based on the SignalP program that predicts amino acids -36 to -1 of SEQ ID NO: 130 are a signal peptide. In an additional aspect, the mature polypeptide is amino acids 1 to 1373 of SEQ ID NO: 134 based on the SignalP program that predicts amino acids -37 to -1 of SEQ ID NO: 134 are a signal peptide. In an additional aspect, the mature polypeptide is amino acids 1 to 1204 of SEQ ID NO: 138 based on the SignalP program that predicts amino acids -37 to -1 of SEQ ID NO: 138 are a signal peptide.

In one aspect, the mature polypeptide is amino acids 1 to 760 of SEQ ID NO: 4 based on the SignalP program that predicts amino acids -31 to -1 of SEQ ID NO: 4 are a signal peptide. In another aspect, the mature polypeptide is amino acids 1 to 1043 of SEQ ID NO: 46 based on the SignalP program that predicts amino acids -31 to -1 of SEQ ID NO: 46 are a signal peptide. In a further aspect, the mature polypeptide is amino acids 1 to 896 of SEQ ID NO: 60 based on the SignalP program that predicts amino acids -41 to -1 of SEQ ID NO: 60 are a signal peptide. In one aspect, the mature polypeptide is amino acids 1 to 1038 of SEQ ID NO: 64 based on the SignalP program that predicts amino acids -24 to -1 of SEQ ID NO: 64 are a signal peptide.

In one aspect, the mature polypeptide is amino acids 1 to 901 of SEQ ID NO: 106 based on the SignalP program that predicts amino acids -32 to -1 of SEQ ID NO: 106 are a signal peptide. In another aspect, the mature polypeptide is amino acids 1 to 899 of SEQ ID NO: 110 based on the SignalP program that predicts amino acids -32 to -1 of SEQ ID NO: 110 are a signal peptide. In a further aspect, the mature polypeptide is amino acids 1 to 897 of SEQ ID NO: 114 based on the SignalP program that predicts amino acids -61 to -1 of SEQ ID NO: 114 are a signal peptide. In an additional aspect, the mature polypeptide is amino acids 1 to 933 of SEQ ID NO: 118 based on the SignalP program that predicts amino acids -27 to -1 of SEQ ID NO: 118 are a signal peptide. In one aspect, the mature polypeptide is amino acids 1 to 1049 of SEQ ID NO: 122 based on the SignalP program that predicts amino acids -42 to -1 of SEQ ID NO: 122 are a signal peptide. In another aspect, the mature polypeptide is amino acids 1 to 900 of SEQ ID NO: 126 based on the SignalP program that predicts amino acids -33 to -1 of SEQ ID NO: 126 are a signal peptide.

It is known in the art that a host cell may produce a mixture of two of more different mature polypeptides (i.e., with a different C-terminal and/or N-terminal amino acid) expressed by the same polynucleotide. It is also known in the art that different host cells process polypeptides differently, and thus, one host cell expressing a polynucleotide may produce a different mature polypeptide (e.g., having a different C-terminal and/or N-terminal amino acid) as compared to another host cell expressing the same polynucleotide.

Mature polypeptide coding sequence: The term “mature polypeptide coding sequence” means a polynucleotide that encodes a mature polypeptide having enzymatic activity such as activity on xanthan gum pretreated with xanthan lyase or xanthan lyase activity. In one aspect, the mature polypeptide coding sequence is nucleotides 115 to 3279 of SEQ ID NO: 1 based on the SignalP program (Nielsen et al., 1997, supra) that predicts nucleotides 1 to 114 of SEQ ID NO: 1 encode a signal peptide. In another aspect, the mature polypeptide coding sequence is nucleotides 94 to 2373 of SEQ ID NO: 3 based on the SignalP program that predicts nucleotides 1 to 93 of SEQ ID NO: 3 encode a signal peptide. In a further aspect, the mature polypeptide coding sequence is nucleotides 600 to 3353 of SEQ ID NO: 9 based on the SignalP program that predicts nucleotides 501 to 599 of SEQ ID NO: 9 encode a signal peptide. In one aspect, the mature polypeptide coding sequence is nucleotides 174 to 2921 of SEQ ID NO: 11 based on the SignalP program that predicts nucleotides 78 to 173 of SEQ ID NO: 11 encode a signal peptide. In another aspect, the mature polypeptide coding sequence is nucleotides 200 to 2953 of SEQ ID NO: 13 based on the SignalP program that predicts nucleotides 101 to 199 of SEQ ID NO: 13 encode a signal peptide. In a further aspect, the mature polypeptide coding sequence is nucleotides 209 to 3337 of SEQ ID NO: 45 based on the SignalP program that predicts nucleotides 116 to 208 of SEQ ID NO: 45 encode a signal peptide. In one aspect, the mature polypeptide coding sequence is nucleotides 109 to 3129 of SEQ ID NO: 47 based on the SignalP program that predicts nucleotides 1 to 108 of SEQ ID NO: 47 encode a signal peptide. In another aspect, the mature polypeptide coding sequence is nucleotides 109 to 2853 of SEQ ID NO: 51 based on the SignalP program that predicts nucleotides 1 to 108 of SEQ ID NO: 51 encode a signal peptide. In a further aspect, the mature polypeptide coding sequence is nucleotides 115 to 3282 of SEQ ID NO: 55 based on the SignalP program that predicts nucleotides 1 to 114 of SEQ ID NO: 55 encode a signal peptide. In an additional aspect, the mature polypeptide coding sequence is nucleotides 124 to 2811 of SEQ ID NO: 59 based on the SignalP program that predicts nucleotides 1 to 123 of SEQ ID NO: 59 encode a signal peptide. In one aspect, the mature polypeptide coding sequence is nucleotides 73 to 3195 of SEQ ID NO: 63 based on the SignalP program that predicts nucleotides 1 to 72 of SEQ ID NO: 63 encode a signal peptide.

In one aspect, the mature polypeptide coding sequence is nucleotides 112 to 4224 of SEQ ID NO: 81 based on the SignalP program that predicts nucleotides 1 to 111 of SEQ ID NO: 81 encode a signal peptide. In another aspect, the mature polypeptide coding sequence is nucleotides 112 to 3720 of SEQ ID NO: 85 based on the SignalP program that predicts nucleotides 1 to 111 of SEQ ID NO: 85 encode a signal peptide. In a further aspect, the mature polypeptide coding sequence is nucleotides 112 to 4248 of SEQ ID NO: 89 based on the SignalP program that predicts nucleotides 1 to 111 of SEQ ID NO: 89 encode a signal peptide. In an additional aspect, the mature polypeptide coding sequence is nucleotides 112 to 4224 of SEQ ID NO: 93 based on the SignalP program that predicts nucleotides 1 to 111 of SEQ ID NO: 93 encode a signal peptide. In one aspect, the mature polypeptide coding sequence is nucleotides 112 to 4227 of SEQ ID NO: 97 based on the SignalP program that predicts nucleotides 1 to 111 of SEQ ID NO: 97 encode a signal peptide. In another aspect, the mature polypeptide coding sequence is nucleotides 76 to 2841 of SEQ ID NO: 101 based on the SignalP program that predicts nucleotides 1 to 75 of SEQ ID NO: 101 encode a signal peptide. In a further aspect, the mature polypeptide coding sequence is nucleotides 97 to 2799 of SEQ ID NO: 105 based on the SignalP program that predicts nucleotides 1 to 96 of SEQ ID NO: 105 encode a signal peptide. In an additional aspect, the mature polypeptide coding sequence is nucleotides 97 to 2793 of SEQ ID NO: 109 based on the SignalP program that predicts nucleotides 1 to 96 of SEQ ID NO: 109 encode a signal peptide. In one aspect, the mature polypeptide coding sequence is nucleotides 184 to 2874 of SEQ ID NO: 113 based on the SignalP program that predicts nucleotides 1 to 183 of SEQ ID NO: 113 encode a signal peptide. In another aspect, the mature polypeptide coding sequence is nucleotides 82 to 2880 of SEQ ID NO: 117 based on the SignalP program that predicts nucleotides 1 to 81 of SEQ ID NO: 117 encode a signal peptide. In a further aspect, the mature polypeptide coding sequence is nucleotides 127 to 3273 of SEQ ID NO: 121 based on the SignalP program that predicts nucleotides 1 to 126 of SEQ ID NO: 121 encode a signal peptide. In an additional aspect, the mature polypeptide coding sequence is nucleotides 100 to 2799 of SEQ ID NO: 125 based on the SignalP program that predicts nucleotides 1 to 99 of SEQ ID NO: 125 encode a signal peptide. In one aspect, the mature polypeptide coding sequence is nucleotides 97 to 2844 of SEQ ID NO: 129 based on the SignalP program that predicts nucleotides 1 to 96 of SEQ ID NO: 129 encode a signal peptide. In another aspect, the mature polypeptide coding sequence is nucleotides 112 to 4230 of SEQ ID NO: 133 based on the SignalP program that predicts nucleotides 1 to 111 of SEQ ID NO: 133 encode a signal peptide. In a further aspect, the mature polypeptide coding sequence is nucleotides 112 to 3723 of SEQ ID NO: 137 based on the SignalP program that predicts nucleotides 1 to 111 of SEQ ID NO: 137 encode a signal peptide.

Nucleic acid construct: The term “nucleic acid construct” means a nucleic acid molecule, either single- or double-stranded, which is isolated from a naturally occurring gene or is modified to contain segments of nucleic acids in a manner that would not otherwise exist in nature or which is synthetic, which comprises one or more control sequences.

Operably linked: The term “operably linked” means a configuration in which a control sequence is placed at an appropriate position relative to the coding sequence of a polynucleotide such that the control sequence directs expression of the coding sequence.

Reducing or preventing soil redeposition: The term “reducing or preventing soil redeposition”, also called anti-redeposition, means the reduction or prevention of any soil, such as a natural or pigment soil, in the wash from depositing onto the textile or hard surface. The reduction or prevention of soil redeposition can be determined using the Mini-LOM or TOM wash assay as described in the examples herein.

Sequence identity: The relatedness between two amino acid sequences or between two nucleotide sequences is described by the parameter “sequence identity”. For purposes of the present invention, the sequence identity between two amino acid sequences is determined using the Needleman-Wunsch algorithm (Needleman and Wunsch, 1970, J. Mol. Biol. 48: 443-453) as implemented in the Needle program of the EMBOSS package (EMBOSS: The European Molecular Biology Open Software Suite, Rice et al., 2000, Trends Genet. 16: 276-277), preferably version 5.0.0 or later. The parameters used are gap open penalty of 10, gap extension penalty of 0.5, and the EBLOSUM62 (EMBOSS version of BLOSUM62) substitution matrix. The output of Needle labeled “longest identity” (obtained using the -nobrief option) is used as the percent identity and is calculated as follows:

(Identical Residues×100)/(Length of Alignment−Total Number of Gaps in Alignment)

For purposes of the present invention, the sequence identity between two deoxyribonucleotide sequences is determined using the Needleman-Wunsch algorithm (Needleman and Wunsch, 1970, supra) as implemented in the Needle program of the EMBOSS package (EMBOSS: The European Molecular Biology Open Software Suite, Rice et al., 2000, supra), preferably version 5.0.0 or later. The parameters used are gap open penalty of 10, gap extension penalty of 0.5, and the EDNAFULL (EMBOSS version of NCBI NUC4.4) substitution matrix. The output of Needle labeled “longest identity” (obtained using the -nobrief option) is used as the percent identity and is calculated as follows:

(Identical Deoxyribonucleotides×100)/(Length of Alignment−Total Number of Gaps in Alignment)

Stringency conditions: The different stringency conditions are defined as follows.

The term “very low stringency conditions” means for probes of at least 100 nucleotides in length, prehybridization and hybridization at 42° C. in 5×SSPE, 0.3% SDS, 200 micrograms/ml sheared and denatured salmon sperm DNA, and 35% formamide, following standard Southern blotting procedures for 12 to 24 hours. The carrier material is finally washed three times each for 15 minutes using 2×SSC, 0.2% SDS at 60° C.

The term “low stringency conditions” means for probes of at least 100 nucleotides in length, prehybridization and hybridization at 42° C. in 5×SSPE, 0.3% SDS, 200 micrograms/ml sheared and denatured salmon sperm DNA, and 35% formamide, following standard Southern blotting procedures for 12 to 24 hours. The carrier material is finally washed three times each for 15 minutes using 2×SSC, 0.2% SDS at 65° C.

The term “medium stringency conditions” means for probes of at least 100 nucleotides in length, prehybridization and hybridization at 42° C. in 5×SSPE, 0.3% SDS, 200 micrograms/ml sheared and denatured salmon sperm DNA, and 35% formamide, following standard Southern blotting procedures for 12 to 24 hours. The carrier material is finally washed three times each for 15 minutes using 1×SSC, 0.2% SDS at 65° C.

The term “medium-high stringency conditions” means for probes of at least 100 nucleotides in length, prehybridization and hybridization at 42° C. in 5×SSPE, 0.3% SDS, 200 micrograms/ml sheared and denatured salmon sperm DNA, and 35% formamide, following standard Southern blotting procedures for 12 to 24 hours. The carrier material is finally washed three times each for 15 minutes using 0.5×SSC, 0.2% SDS at 65° C.

The term “high stringency conditions” means for probes of at least 100 nucleotides in length, prehybridization and hybridization at 42° C. in 5×SSPE, 0.3% SDS, 200 micrograms/ml sheared and denatured salmon sperm DNA, and 35% formamide, following standard Southern blotting procedures for 12 to 24 hours. The carrier material is finally washed three times each for 15 minutes using 0.2×SSC, 0.2% SDS at 65° C.

The term “very high stringency conditions” means for probes of at least 100 nucleotides in length, prehybridization and hybridization at 42° C. in 5×SSPE, 0.3% SDS, 200 micrograms/ml sheared and denatured salmon sperm DNA, and 35% formamide, following standard Southern blotting procedures for 12 to 24 hours. The carrier material is finally washed three times each for 15 minutes using 0.1×SSC, 0.2% SDS at 65° C.

Subsequence: The term “subsequence” means a polynucleotide having one or more (e.g., several) nucleotides absent from the 5′ and/or 3′ end of a mature polypeptide coding sequence; wherein the subsequence encodes a fragment having endoglucanase activity.

Textile: The term “textile” means any textile material including yarns, yarn intermediates, fibers, non-woven materials, natural materials, synthetic materials, and any other textile material, fabrics made of these materials and products made from fabrics (e.g., garments, cloths and other articles). The textile or fabric may be in the form of knits, wovens, denims, non-wovens, felts, yarns, and toweling. The textile may be cellulose based such as natural cellulosics, including cotton, flax/linen, jute, ramie, sisal or coir or manmade cellulosics (e.g. originating from wood pulp) including viscose/rayon, ramie, cellulose acetate fibers (tricell), lyocell or blends thereof. The textile or fabric may also be non-cellulose based such as natural polyamides including wool, camel, cashmere, mohair, rabit and silk or synthetic polymer such as nylon, aramid, polyester, acrylic, polypropylen and spandex/elastane, or blends thereof as well as blend of cellulose based and non-cellulose based fibers. Examples of blends are blends of cotton and/or rayon/viscose with one or more companion material such as wool, synthetic fibers (e.g. polyamide fibers, acrylic fibers, polyester fibers, polyvinyl alcohol fibers, polyvinyl chloride fibers, polyurethane fibers, polyurea fibers, aramid fibers), and cellulose-containing fibers (e.g. rayon/viscose, ramie, flax/linen, jute, cellulose acetate fibers, lyocell). Fabric may be conventional washable laundry, for example stained household laundry. When the term fabric or garment is used it is intended to include the broader term textiles as well.

Variant: In one embodiment the term “variant” means a polypeptide having xanthan lyase activity comprising an alteration, i.e., a substitution, insertion, and/or deletion, at one or more (e.g., several) positions. A substitution means replacement of the amino acid occupying a position with a different amino acid; a deletion means removal of the amino acid occupying a position; and and an insertion means adding one or more (e.g. several) amino acids e.g. 1-5 amino acids adjacent to and immediately following the amino acid occupying a position.

In another embodiment the term “variant” means a GH9 endoglucanases having activity on xanthan gum pretreated with xanthan lyase comprising an alteration, i.e., a substitution, insertion, and/or deletion, at one or more (e.g., several) positions. A substitution means replacement of the amino acid occupying a position with a different amino acid; a deletion means removal of the amino acid occupying a position; and an insertion means adding one or more (e.g. several) amino acids e.g. 1-5 amino acids adjacent to and immediately following the amino acid occupying a position.

Whiteness: The term “Whiteness” is defined herein as a broad term with different meanings in different regions and for different customers. Loss of whiteness can e.g. be due to greying, yellowing, or removal of optical brighteners/hueing agents. Greying and yellowing can be due to soil redeposition, body soils, coloring from e.g. iron and copper ions or dye transfer. Whiteness might include one or several issues from the list below: colorant or dye effects; incomplete stain removal (e.g. body soils, sebum etc.); re-deposition (greying, yellowing or other discolorations of the object) (removed soils re-associates with other part of textile, soiled or unsoiled); chemical changes in textile during application; and clarification or brightening of colours.

Xanthan degrading activity: The term “xanthan degrading activity” is defined herein as the depolymerization, degradation or breaking down of xanthan gum into smaller components. The degradation of xanthan gum can either be the removal of one or more side chain saccharides, the cutting of the backbone of xanthan gum into smaller components or the removal of one or more side chain saccharides and the cutting of the backbone of xanthan gum into smaller components. The degradation of xanthan gum can preferably be measured using the viscosity reduction method as described in example 4. Alternatively, degradation of xanthan gum can be measured using the reducing ends method or the colourmetric assay as described in example 4.

Xanthan Lyase: The term “xanthan lyase” is defined herein as an enzyme that cleaves the β-D-mannosyl-β-D-1,4-glucuronosyl bonds in xanthan gum (EC 4.2.2.12). For purposes of the present invention, xanthan lyase activity is determined according to the procedure described in the Examples. In one aspect, the polypeptides of the present invention have at least 20%, e.g., at least 40%, at least 50%, at least 60%, at least 70%, at least 80%, at least 90%, at least 95%, or at least 100% of the cellulase activity of the mature polypeptide of SEQ ID NO: 4, SEQ ID NO: 46, SEQ ID NO: 60, SEQ ID NO: 64, SEQ ID NO: 106, SEQ ID NO: 110, SEQ ID NO: 114, SEQ ID NO: 118, SEQ ID NO: 122 or SEQ ID NO: 126. Xanthan lyase activity may be determined as described in the ‘Xanthan lyase activity assay’ as described in the Example section.

### DETAILED DESCRIPTION OF THE INVENTION

The present invention provides a method for reducing or preventing soil redeposition using a detergent composition comprising polypeptides having xanthan lyase activity. It has surprisingly been found that the use of a xanthan lyase in a detergent composition reduces or prevents soil redeposition.

### Xanthan Lyases Having Anti-Redeposition Properties

In one aspect, the invention relates to a method for reducing or preventing soil redeposition using a detergent composition comprising an isolated polypeptide having xanthan lyase activity selected from the group consisting of:
(a) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 4;
(b) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 46;
(c) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 60;
(d) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 64;
(e) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 106;
(f) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 110;
(g) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 114;
(h) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 118;
(i) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 122;
(j) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 126;
(k) a polypeptide encoded by a polynucleotide that hybridizes under medium stringency conditions, medium-high stringency conditions, high stringency conditions, or very high stringency conditions with:
   (i) the mature polypeptide coding sequence of SEQ ID NO: 3;
   (ii) the mature polypeptide coding sequence of SEQ ID NO: 45;
   (iii) the mature polypeptide coding sequence of SEQ ID NO: 59;
   (iv) the mature polypeptide coding sequence of SEQ ID NO: 63;
   (v) the mature polypeptide coding sequence of SEQ ID NO: 105;
   (vi) the mature polypeptide coding sequence of SEQ ID NO: 109;
   (vii) the mature polypeptide coding sequence of SEQ ID NO: 113;
   (viii) the mature polypeptide coding sequence of SEQ ID NO: 117;
   (ix) the mature polypeptide coding sequence of SEQ ID NO: 121;
   (x) the mature polypeptide coding sequence of SEQ ID NO: 125; or
   (xi) the full-length complement thereof of (i), (ii), (iii), (iv), (v), (vi), (vii), (viii), (ix), or (x);
(l) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 3;
(m) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 45;
(n) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 59;
(o) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 63;
(p) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 105;
(q) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 109;
(r) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 113;
(s) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 117;
(t) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 121;
(u) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 125;
(v) a variant of the mature polypeptide of SEQ ID NO: 4, SEQ ID NO: 46, SEQ ID NO: 60, SEQ ID NO: 64, SEQ ID NO: 106, SEQ ID NO: 110, SEQ ID NO: 114, SEQ ID NO: 118, SEQ ID NO: 122 or SEQ ID NO: 126 comprising a substitution, deletion, and/or insertion at one or more positions (e.g. several); and
(w) a fragment of the polypeptide of (a), (b), (c), (d), (e), (f), (g), (h), (i), (j), (k), (l), (m), (n), (o), (p), (q), (r), (s), (t), (u) or (v) that has xanthan lyase activity.

In one embodiment, the detergent composition further comprises one or more detergent components selected from the group comprising surfactants, builders, hydrotopes, bleaching systems, polymers, fabric hueing agents, adjunct materials, dispersants, dye transfer inhibiting agents, fluorescent whitening agents and soil release polymers, or any mixture thereof. The detergent composition may be in the form of a bar, a homogenous tablet, a tablet having two or more layers, a pouch having one or more compartments, a regular or compact powder, a granulate, a paste, a gel, or a regular, compact or concentrated liquid and may be used for dish wash or laundering.

In another embodiment, the detergent composition comprises one or more additional enzymes selected from the group comprising proteases, amylases, lipases, cutinases, cellulases, endoglucanases, xyloglucanases, pectinases, pectin lyases, xanthanases, peroxidaes, haloperoxygenases, catalases and mannanases, or any mixture thereof.

In a further embodiment, the detergent composition comprises one or more detergent components selected from the group comprising surfactants, builders, hydrotopes, bleaching systems, polymers, fabric hueing agents, adjunct materials, dispersants, dye transfer inhibiting agents, fluorescent whitening agents and soil release polymers, or any mixture thereof and one or more additional enzymes selected from the group comprising proteases, amylases, lipases, cutinases, cellulases, endoglucanases, xyloglucanases, pectinases, pectin lyases, xanthanases, peroxidaes, haloperoxygenases, catalases and mannanases, or any mixture thereof.

The method may comprise the following steps:
(a) providing a wash liquor by dissolving/mixing the detergent composition in water;
(b) washing the objects/fabrics/textiles in the wash liquor;
(c) draining the wash liquor and optionally repeating the wash cycle; and
(d) rinsing and optionally drying the objects/fabrics/textiles.

An embodiment of the invention is a method for reducing or preventing soil redeposition using a detergent composition comprising an isolated polypeptide having at least 85% sequence identity to the mature polypeptide of SEQ ID NO: 4.

An embodiment of the invention is a method for reducing or preventing soil redeposition using a detergent composition comprising an isolated polypeptide having at least 86% sequence identity to the mature polypeptide of SEQ ID NO: 4.

An embodiment of the invention is a method for reducing or preventing soil redeposition using a detergent composition comprising an isolated polypeptide having at least 87% sequence identity to the mature polypeptide of SEQ ID NO: 4.

An embodiment of the invention is a method for reducing or preventing soil redeposition using a detergent composition comprising an isolated polypeptide having at least 88% sequence identity to the mature polypeptide of SEQ ID NO: 4.

An embodiment of the invention is a method for reducing or preventing soil redeposition using a detergent composition comprising an isolated polypeptide having at least 89% sequence identity to the mature polypeptide of SEQ ID NO: 4.

An embodiment of the invention is a method for reducing or preventing soil redeposition using a detergent composition comprising an isolated polypeptide having at least 90% sequence identity to the mature polypeptide of SEQ ID NO: 4.

An embodiment of the invention is a method for reducing or preventing soil redeposition using a detergent composition comprising an isolated polypeptide having at least 91% sequence identity to the mature polypeptide of SEQ ID NO: 4.

An embodiment of the invention is a method for reducing or preventing soil redeposition using a detergent composition comprising an isolated polypeptide having at least 92% sequence identity to the mature polypeptide of SEQ ID NO: 4.

An embodiment of the invention is a method for reducing or preventing soil redeposition using a detergent composition comprising an isolated polypeptide having at least 93% sequence identity to the mature polypeptide of SEQ ID NO: 4.

An embodiment of the invention is a method for reducing or preventing soil redeposition using a detergent composition comprising an isolated polypeptide having at least 94% sequence identity to the mature polypeptide of SEQ ID NO: 4.

An embodiment of the invention is a method for reducing or preventing soil redeposition using a detergent composition comprising an isolated polypeptide having at least 95% sequence identity to the mature polypeptide of SEQ ID NO: 4.

An embodiment of the invention is a method for reducing or preventing soil redeposition using a detergent composition comprising an isolated polypeptide having at least 96% sequence identity to the mature polypeptide of SEQ ID NO: 4.

An embodiment of the invention is a method for reducing or preventing soil redeposition using a detergent composition comprising an isolated polypeptide having at least 97% sequence identity to the mature polypeptide of SEQ ID NO: 4.

An embodiment of the invention is a method for reducing or preventing soil redeposition using a detergent composition comprising an isolated polypeptide having at least 98% sequence identity to the mature polypeptide of SEQ ID NO: 4.

An embodiment of the invention is a method for reducing or preventing soil redeposition using a detergent composition comprising an isolated polypeptide having at least 99% sequence identity to the mature polypeptide of SEQ ID NO: 4.

In one aspect, the polypeptides differ by no more than 50 amino acids, e.g., 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49 or 50 from the mature polypeptide of SEQ ID NO: 4. In a preferred aspect, the polypeptides differ by no more than 10 amino acids, e.g., 1, 2, 3, 4, 5, 6, 7, 8, 9 or 10 from the mature polypeptide of SEQ ID NO: 4.

A polypeptide of the present invention preferably comprises or consists of the amino acid sequence of SEQ ID NO: 4 or an allelic variant thereof; or is a fragment thereof that has xanthan lyase activity. In another aspect, the polypeptide comprises or consists of the mature polypeptide of SEQ ID NO: 4. In another aspect, the polypeptide comprises or consists of amino acids 1 to 760 of SEQ ID NO: 4.

In another aspect, the present invention relates to a method for reducing or preventing soil redeposition using a detergent composition comprising an isolated polypeptide having xanthan lyase activity encoded by a polynucleotide that hybridizes under high stringency conditions, or very high stringency conditions with (i) the mature polypeptide coding sequence of SEQ ID NO: 3, or (ii) the full-length complement of (i) (Sambrook et al., 1989, Molecular Cloning, A Laboratory Manual, 2d edition, Cold Spring Harbor, N.Y.).

In another aspect, the method for reducing or preventing soil redeposition using a detergent composition comprises an isolated polypeptide encoded by a polynucleotide having a sequence identity to the mature polypeptide of SEQ ID NO: 4 of at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100%.

An embodiment of the invention is a method for reducing or preventing soil redeposition using a detergent composition comprising an isolated polypeptide having at least 85% sequence identity to the mature polypeptide of SEQ ID NO: 46.

An embodiment of the invention is a method for reducing or preventing soil redeposition using a detergent composition comprising an isolated polypeptide having at least 86% sequence identity to the mature polypeptide of SEQ ID NO: 46.

An embodiment of the invention is a method for reducing or preventing soil redeposition using a detergent composition comprising an isolated polypeptide having at least 87% sequence identity to the mature polypeptide of SEQ ID NO: 46.

An embodiment of the invention is a method for reducing or preventing soil redeposition using a detergent composition comprising an isolated polypeptide having at least 88% sequence identity to the mature polypeptide of SEQ ID NO: 46.

An embodiment of the invention is a method for reducing or preventing soil redeposition using a detergent composition comprising an isolated polypeptide having at least 89% sequence identity to the mature polypeptide of SEQ ID NO: 46.

An embodiment of the invention is a method for reducing or preventing soil redeposition using a detergent composition comprising an isolated polypeptide having at least 90% sequence identity to the mature polypeptide of SEQ ID NO: 46.

An embodiment of the invention is a method for reducing or preventing soil redeposition using a detergent composition comprising an isolated polypeptide having at least 91% sequence identity to the mature polypeptide of SEQ ID NO: 46.

An embodiment of the invention is a method for reducing or preventing soil redeposition using a detergent composition comprising an isolated polypeptide having at least 92% sequence identity to the mature polypeptide of SEQ ID NO: 46.

An embodiment of the invention is a method for reducing or preventing soil redeposition using a detergent composition comprising an isolated polypeptide having at least 93% sequence identity to the mature polypeptide of SEQ ID NO: 46.

An embodiment of the invention is a method for reducing or preventing soil redeposition using a detergent composition comprising an isolated polypeptide having at least 94% sequence identity to the mature polypeptide of SEQ ID NO: 46.

An embodiment of the invention is a method for reducing or preventing soil redeposition using a detergent composition comprising an isolated polypeptide having at least 95% sequence identity to the mature polypeptide of SEQ ID NO: 46.

An embodiment of the invention is a method for reducing or preventing soil redeposition using a detergent composition comprising an isolated polypeptide having at least 96% sequence identity to the mature polypeptide of SEQ ID NO: 46.

An embodiment of the invention is a method for reducing or preventing soil redeposition using a detergent composition comprising an isolated polypeptide having at least 97% sequence identity to the mature polypeptide of SEQ ID NO: 46.

An embodiment of the invention is a method for reducing or preventing soil redeposition using a detergent composition comprising an isolated polypeptide having at least 98% sequence identity to the mature polypeptide of SEQ ID NO: 46.

An embodiment of the invention is a method for reducing or preventing soil redeposition using a detergent composition comprising an isolated polypeptide having at least 99% sequence identity to the mature polypeptide of SEQ ID NO: 46.

In one aspect, the polypeptides differ by no more than 50 amino acids, e.g., 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49 or 50 from the mature polypeptide of SEQ ID NO: 46. In a preferred aspect, the polypeptides differ by no more than 10 amino acids, e.g., 1, 2, 3, 4, 5, 6, 7, 8, 9 or 10 from the mature polypeptide of SEQ ID NO: 46.

A polypeptide of the present invention preferably comprises or consists of the amino acid sequence of SEQ ID NO: 46 or an allelic variant thereof; or is a fragment thereof that has xanthan lyase activity. In another aspect, the polypeptide comprises or consists of the mature polypeptide of SEQ ID NO: 46. In another aspect, the polypeptide comprises or consists of amino acids 1 to 1043 of SEQ ID NO: 46.

In another aspect, the present invention relates to a method for reducing or preventing soil redeposition using a detergent composition comprising an isolated polypeptide having xanthan lyase activity encoded by a polynucleotide that hybridizes under high stringency conditions, or very high stringency conditions with (i) the mature polypeptide coding sequence of SEQ ID NO: 3, or (ii) the full-length complement of (i) (Sambrook et al., 1989, Molecular Cloning, A Laboratory Manual, 2d edition, Cold Spring Harbor, N.Y.).

In another aspect, the method for reducing or preventing soil redeposition using a detergent composition comprises an isolated polypeptide encoded by a polynucleotide having a sequence identity to the mature polypeptide of SEQ ID NO: 46 of at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100%.

An embodiment of the invention is a method for reducing or preventing soil redeposition using a detergent composition comprising an isolated polypeptide having at least 85% sequence identity to the mature polypeptide of SEQ ID NO: 60.

An embodiment of the invention is a method for reducing or preventing soil redeposition using a detergent composition comprising an isolated polypeptide having at least 86% sequence identity to the mature polypeptide of SEQ ID NO: 60.

An embodiment of the invention is a method for reducing or preventing soil redeposition using a detergent composition comprising an isolated polypeptide having at least 87% sequence identity to the mature polypeptide of SEQ ID NO: 60.

An embodiment of the invention is a method for reducing or preventing soil redeposition using a detergent composition comprising an isolated polypeptide having at least 88% sequence identity to the mature polypeptide of SEQ ID NO: 60.

An embodiment of the invention is a method for reducing or preventing soil redeposition using a detergent composition comprising an isolated polypeptide having at least 89% sequence identity to the mature polypeptide of SEQ ID NO: 60.

An embodiment of the invention is a method for reducing or preventing soil redeposition using a detergent composition comprising an isolated polypeptide having at least 90% sequence identity to the mature polypeptide of SEQ ID NO: 60.

An embodiment of the invention is a method for reducing or preventing soil redeposition using a detergent composition comprising an isolated polypeptide having at least 91% sequence identity to the mature polypeptide of SEQ ID NO: 60.

An embodiment of the invention is a method for reducing or preventing soil redeposition using a detergent composition comprising an isolated polypeptide having at least 92% sequence identity to the mature polypeptide of SEQ ID NO: 60.

An embodiment of the invention is a method for reducing or preventing soil redeposition using a detergent composition comprising an isolated polypeptide having at least 93% sequence identity to the mature polypeptide of SEQ ID NO: 60.

An embodiment of the invention is a method for reducing or preventing soil redeposition using a detergent composition comprising an isolated polypeptide having at least 94% sequence identity to the mature polypeptide of SEQ ID NO: 60.

An embodiment of the invention is a method for reducing or preventing soil redeposition using a detergent composition comprising an isolated polypeptide having at least 95% sequence identity to the mature polypeptide of SEQ ID NO: 60.

An embodiment of the invention is a method for reducing or preventing soil redeposition using a detergent composition comprising an isolated polypeptide having at least 96% sequence identity to the mature polypeptide of SEQ ID NO: 60.

An embodiment of the invention is a method for reducing or preventing soil redeposition using a detergent composition comprising an isolated polypeptide having at least 97% sequence identity to the mature polypeptide of SEQ ID NO: 60.

An embodiment of the invention is a method for reducing or preventing soil redeposition using a detergent composition comprising an isolated polypeptide having at least 98% sequence identity to the mature polypeptide of SEQ ID NO: 60.

An embodiment of the invention is a method for reducing or preventing soil redeposition using a detergent composition comprising an isolated polypeptide having at least 99% sequence identity to the mature polypeptide of SEQ ID NO: 60.

In one aspect, the polypeptides differ by no more than 50 amino acids, e.g., 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49 or 50 from the mature polypeptide of SEQ ID NO: 60. In a preferred aspect, the polypeptides differ by no more than 10 amino acids, e.g., 1, 2, 3, 4, 5, 6, 7, 8, 9 or 10 from the mature polypeptide of SEQ ID NO: 60.

A polypeptide of the present invention preferably comprises or consists of the amino acid sequence of SEQ ID NO: 60 or an allelic variant thereof; or is a fragment thereof that has xanthan lyase activity. In another aspect, the polypeptide comprises or consists of the mature polypeptide of SEQ ID NO: 60. In another aspect, the polypeptide comprises or consists of amino acids 1 to 896 of SEQ ID NO: 60.

In another aspect, the present invention relates to a method for reducing or preventing soil redeposition using a detergent composition comprising an isolated polypeptide having xanthan lyase activity encoded by a polynucleotide that hybridizes under high stringency conditions, or very high stringency conditions with (i) the mature polypeptide coding sequence of SEQ ID NO: 3, or (ii) the full-length complement of (i) (Sambrook et al., 1989, Molecular Cloning, A Laboratory Manual, 2d edition, Cold Spring Harbor, N.Y.).

In another aspect, the method for reducing or preventing soil redeposition using a detergent composition comprises an isolated polypeptide encoded by a polynucleotide having a sequence identity to the mature polypeptide of SEQ ID NO: 60 of at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100%.

An embodiment of the invention is a method for reducing or preventing soil redeposition using a detergent composition comprising an isolated polypeptide having at least 85% sequence identity to the mature polypeptide of SEQ ID NO: 64.

An embodiment of the invention is a method for reducing or preventing soil redeposition using a detergent composition comprising an isolated polypeptide having at least 86% sequence identity to the mature polypeptide of SEQ ID NO: 64.

An embodiment of the invention is a method for reducing or preventing soil redeposition using a detergent composition comprising an isolated polypeptide having at least 87% sequence identity to the mature polypeptide of SEQ ID NO: 64.

An embodiment of the invention is a method for reducing or preventing soil redeposition using a detergent composition comprising an isolated polypeptide having at least 88% sequence identity to the mature polypeptide of SEQ ID NO: 64.

An embodiment of the invention is a method for reducing or preventing soil redeposition using a detergent composition comprising an isolated polypeptide having at least 89% sequence identity to the mature polypeptide of SEQ ID NO: 64.

An embodiment of the invention is a method for reducing or preventing soil redeposition using a detergent composition comprising an isolated polypeptide having at least 90% sequence identity to the mature polypeptide of SEQ ID NO: 64.

An embodiment of the invention is a method for reducing or preventing soil redeposition using a detergent composition comprising an isolated polypeptide having at least 91% sequence identity to the mature polypeptide of SEQ ID NO: 64.

An embodiment of the invention is a method for reducing or preventing soil redeposition using a detergent composition comprising an isolated polypeptide having at least 92% sequence identity to the mature polypeptide of SEQ ID NO: 64.

An embodiment of the invention is a method for reducing or preventing soil redeposition using a detergent composition comprising an isolated polypeptide having at least 93% sequence identity to the mature polypeptide of SEQ ID NO: 64.

An embodiment of the invention is a method for reducing or preventing soil redeposition using a detergent composition comprising an isolated polypeptide having at least 94% sequence identity to the mature polypeptide of SEQ ID NO: 64.

An embodiment of the invention is a method for reducing or preventing soil redeposition using a detergent composition comprising an isolated polypeptide having at least 95% sequence identity to the mature polypeptide of SEQ ID NO: 64.

An embodiment of the invention is a method for reducing or preventing soil redeposition using a detergent composition comprising an isolated polypeptide having at least 96% sequence identity to the mature polypeptide of SEQ ID NO: 64.

An embodiment of the invention is a method for reducing or preventing soil redeposition using a detergent composition comprising an isolated polypeptide having at least 97% sequence identity to the mature polypeptide of SEQ ID NO: 64.

An embodiment of the invention is a method for reducing or preventing soil redeposition using a detergent composition comprising an isolated polypeptide having at least 98% sequence identity to the mature polypeptide of SEQ ID NO: 64.

An embodiment of the invention is a method for reducing or preventing soil redeposition using a detergent composition comprising an isolated polypeptide having at least 99% sequence identity to the mature polypeptide of SEQ ID NO: 64.

In one aspect, the polypeptides differ by no more than 50 amino acids, e.g., 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49 or 50 from the mature polypeptide of SEQ ID NO: 64. In a preferred aspect, the polypeptides differ by no more than 10 amino acids, e.g., 1, 2, 3, 4, 5, 6, 7, 8, 9 or 10 from the mature polypeptide of SEQ ID NO: 64.

A polypeptide of the present invention preferably comprises or consists of the amino acid sequence of SEQ ID NO: 64 or an allelic variant thereof; or is a fragment thereof that has xanthan lyase activity. In another aspect, the polypeptide comprises or consists of the mature polypeptide of SEQ ID NO: 64. In another aspect, the polypeptide comprises or consists of amino acids 1 to 1038 of SEQ ID NO: 64.

In another aspect, the present invention relates to a method for reducing or preventing soil redeposition using a detergent composition comprising an isolated polypeptide having xanthan lyase activity encoded by a polynucleotide that hybridizes under high stringency conditions, or very high stringency conditions with (i) the mature polypeptide coding sequence of SEQ ID NO: 3, or (ii) the full-length complement of (i) (Sambrook et al., 1989, Molecular Cloning, A Laboratory Manual, 2d edition, Cold Spring Harbor, N.Y.).

In another aspect, the method for reducing or preventing soil redeposition using a detergent composition comprises an isolated polypeptide encoded by a polynucleotide having a sequence identity to the mature polypeptide of SEQ ID NO: 64 of at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100%.

An embodiment of the invention is a method for reducing or preventing soil redeposition using a detergent composition comprising an isolated polypeptide having at least 85% sequence identity to the mature polypeptide of SEQ ID NO: 106.

An embodiment of the invention is a method for reducing or preventing soil redeposition using a detergent composition comprising an isolated polypeptide having at least 86% sequence identity to the mature polypeptide of SEQ ID NO: 106.

An embodiment of the invention is a method for reducing or preventing soil redeposition using a detergent composition comprising an isolated polypeptide having at least 87% sequence identity to the mature polypeptide of SEQ ID NO: 106.

An embodiment of the invention is a method for reducing or preventing soil redeposition using a detergent composition comprising an isolated polypeptide having at least 88% sequence identity to the mature polypeptide of SEQ ID NO: 106.

An embodiment of the invention is a method for reducing or preventing soil redeposition using a detergent composition comprising an isolated polypeptide having at least 89% sequence identity to the mature polypeptide of SEQ ID NO: 106.

An embodiment of the invention is a method for reducing or preventing soil redeposition using a detergent composition comprising an isolated polypeptide having at least 90% sequence identity to the mature polypeptide of SEQ ID NO: 106.

An embodiment of the invention is a method for reducing or preventing soil redeposition using a detergent composition comprising an isolated polypeptide having at least 91% sequence identity to the mature polypeptide of SEQ ID NO: 106.

An embodiment of the invention is a method for reducing or preventing soil redeposition using a detergent composition comprising an isolated polypeptide having at least 92% sequence identity to the mature polypeptide of SEQ ID NO: 106.

An embodiment of the invention is a method for reducing or preventing soil redeposition using a detergent composition comprising an isolated polypeptide having at least 93% sequence identity to the mature polypeptide of SEQ ID NO: 106.

An embodiment of the invention is a method for reducing or preventing soil redeposition using a detergent composition comprising an isolated polypeptide having at least 94% sequence identity to the mature polypeptide of SEQ ID NO: 106.

An embodiment of the invention is a method for reducing or preventing soil redeposition using a detergent composition comprising an isolated polypeptide having at least 95% sequence identity to the mature polypeptide of SEQ ID NO: 106.

An embodiment of the invention is a method for reducing or preventing soil redeposition using a detergent composition comprising an isolated polypeptide having at least 96% sequence identity to the mature polypeptide of SEQ ID NO: 106.

An embodiment of the invention is a method for reducing or preventing soil redeposition using a detergent composition comprising an isolated polypeptide having at least 97% sequence identity to the mature polypeptide of SEQ ID NO: 106.

An embodiment of the invention is a method for reducing or preventing soil redeposition using a detergent composition comprising an isolated polypeptide having at least 98% sequence identity to the mature polypeptide of SEQ ID NO: 106.

An embodiment of the invention is a method for reducing or preventing soil redeposition using a detergent composition comprising an isolated polypeptide having at least 99% sequence identity to the mature polypeptide of SEQ ID NO: 106.

In one aspect, the polypeptides differ by no more than 50 amino acids, e.g., 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49 or 50 from the mature polypeptide of SEQ ID NO: 106. In a preferred aspect, the polypeptides differ by no more than 10 amino acids, e.g., 1, 2, 3, 4, 5, 6, 7, 8, 9 or 10 from the mature polypeptide of SEQ ID NO: 106.

A polypeptide of the present invention preferably comprises or consists of the amino acid sequence of SEQ ID NO: 106 or an allelic variant thereof; or is a fragment thereof that has xanthan lyase activity. In another aspect, the polypeptide comprises or consists of the mature polypeptide of SEQ ID NO: 106. In another aspect, the polypeptide comprises or consists of amino acids 1 to 901 of SEQ ID NO: 106.

In another aspect, the present invention relates to a method for reducing or preventing soil redeposition using a detergent composition comprising an isolated polypeptide having xanthan lyase activity encoded by a polynucleotide that hybridizes under high stringency conditions, or very high stringency conditions with (i) the mature polypeptide coding sequence of SEQ ID NO: 3, or (ii) the full-length complement of (i) (Sambrook et al., 1989, Molecular Cloning, A Laboratory Manual, 2d edition, Cold Spring Harbor, N.Y.).

In another aspect, the method for reducing or preventing soil redeposition using a detergent composition comprises an isolated polypeptide encoded by a polynucleotide having a sequence identity to the mature polypeptide of SEQ ID NO: 106 of at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100%.

An embodiment of the invention is a method for reducing or preventing soil redeposition using a detergent composition comprising an isolated polypeptide having at least 85% sequence identity to the mature polypeptide of SEQ ID NO: 110.

An embodiment of the invention is a method for reducing or preventing soil redeposition using a detergent composition comprising an isolated polypeptide having at least 86% sequence identity to the mature polypeptide of SEQ ID NO: 110.

An embodiment of the invention is a method for reducing or preventing soil redeposition using a detergent composition comprising an isolated polypeptide having at least 87% sequence identity to the mature polypeptide of SEQ ID NO: 110.

An embodiment of the invention is a method for reducing or preventing soil redeposition using a detergent composition comprising an isolated polypeptide having at least 88% sequence identity to the mature polypeptide of SEQ ID NO: 110.

An embodiment of the invention is a method for reducing or preventing soil redeposition using a detergent composition comprising an isolated polypeptide having at least 89% sequence identity to the mature polypeptide of SEQ ID NO: 110.

An embodiment of the invention is a method for reducing or preventing soil redeposition using a detergent composition comprising an isolated polypeptide having at least 90% sequence identity to the mature polypeptide of SEQ ID NO: 110.

An embodiment of the invention is a method for reducing or preventing soil redeposition using a detergent composition comprising an isolated polypeptide having at least 91% sequence identity to the mature polypeptide of SEQ ID NO: 110.

An embodiment of the invention is a method for reducing or preventing soil redeposition using a detergent composition comprising an isolated polypeptide having at least 92% sequence identity to the mature polypeptide of SEQ ID NO: 110.

An embodiment of the invention is a method for reducing or preventing soil redeposition using a detergent composition comprising an isolated polypeptide having at least 93% sequence identity to the mature polypeptide of SEQ ID NO: 110.

An embodiment of the invention is a method for reducing or preventing soil redeposition using a detergent composition comprising an isolated polypeptide having at least 94% sequence identity to the mature polypeptide of SEQ ID NO: 110.

An embodiment of the invention is a method for reducing or preventing soil redeposition using a detergent composition comprising an isolated polypeptide having at least 95% sequence identity to the mature polypeptide of SEQ ID NO: 110.

An embodiment of the invention is a method for reducing or preventing soil redeposition using a detergent composition comprising an isolated polypeptide having at least 96% sequence identity to the mature polypeptide of SEQ ID NO: 110.

An embodiment of the invention is a method for reducing or preventing soil redeposition using a detergent composition comprising an isolated polypeptide having at least 97% sequence identity to the mature polypeptide of SEQ ID NO: 110.

An embodiment of the invention is a method for reducing or preventing soil redeposition using a detergent composition comprising an isolated polypeptide having at least 98% sequence identity to the mature polypeptide of SEQ ID NO: 110.

An embodiment of the invention is a method for reducing or preventing soil redeposition using a detergent composition comprising an isolated polypeptide having at least 99% sequence identity to the mature polypeptide of SEQ ID NO: 110.

In one aspect, the polypeptides differ by no more than 50 amino acids, e.g., 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49 or 50 from the mature polypeptide of SEQ ID NO: 110. In a preferred aspect, the polypeptides differ by no more than 10 amino acids, e.g., 1, 2, 3, 4, 5, 6, 7, 8, 9 or 10 from the mature polypeptide of SEQ ID NO: 110.

A polypeptide of the present invention preferably comprises or consists of the amino acid sequence of SEQ ID NO: 110 or an allelic variant thereof; or is a fragment thereof that has xanthan lyase activity. In another aspect, the polypeptide comprises or consists of the mature polypeptide of SEQ ID NO: 110. In another aspect, the polypeptide comprises or consists of amino acids 1 to 899 of SEQ ID NO: 110.

In another aspect, the present invention relates to a method for reducing or preventing soil redeposition using a detergent composition comprising an isolated polypeptide having xanthan lyase activity encoded by a polynucleotide that hybridizes under high stringency conditions, or very high stringency conditions with (i) the mature polypeptide coding sequence of SEQ ID NO: 3, or (ii) the full-length complement of (i) (Sambrook et al., 1989, Molecular Cloning, A Laboratory Manual, 2d edition, Cold Spring Harbor, N.Y.).

In another aspect, the method for reducing or preventing soil redeposition using a detergent composition comprises an isolated polypeptide encoded by a polynucleotide having a sequence identity to the mature polypeptide of SEQ ID NO: 110 of at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100%.

An embodiment of the invention is a method for reducing or preventing soil redeposition using a detergent composition comprising an isolated polypeptide having at least 85% sequence identity to the mature polypeptide of SEQ ID NO: 114.

An embodiment of the invention is a method for reducing or preventing soil redeposition using a detergent composition comprising an isolated polypeptide having at least 86% sequence identity to the mature polypeptide of SEQ ID NO: 114.

An embodiment of the invention is a method for reducing or preventing soil redeposition using a detergent composition comprising an isolated polypeptide having at least 87% sequence identity to the mature polypeptide of SEQ ID NO: 114.

An embodiment of the invention is a method for reducing or preventing soil redeposition using a detergent composition comprising an isolated polypeptide having at least 88% sequence identity to the mature polypeptide of SEQ ID NO: 114.

An embodiment of the invention is a method for reducing or preventing soil redeposition using a detergent composition comprising an isolated polypeptide having at least 89% sequence identity to the mature polypeptide of SEQ ID NO: 114.

An embodiment of the invention is a method for reducing or preventing soil redeposition using a detergent composition comprising an isolated polypeptide having at least 90% sequence identity to the mature polypeptide of SEQ ID NO: 114.

An embodiment of the invention is a method for reducing or preventing soil redeposition using a detergent composition comprising an isolated polypeptide having at least 91% sequence identity to the mature polypeptide of SEQ ID NO: 114.

An embodiment of the invention is a method for reducing or preventing soil redeposition using a detergent composition comprising an isolated polypeptide having at least 92% sequence identity to the mature polypeptide of SEQ ID NO: 114.

An embodiment of the invention is a method for reducing or preventing soil redeposition using a detergent composition comprising an isolated polypeptide having at least 93% sequence identity to the mature polypeptide of SEQ ID NO: 114.

An embodiment of the invention is a method for reducing or preventing soil redeposition using a detergent composition comprising an isolated polypeptide having at least 94% sequence identity to the mature polypeptide of SEQ ID NO: 114.

An embodiment of the invention is a method for reducing or preventing soil redeposition using a detergent composition comprising an isolated polypeptide having at least 95% sequence identity to the mature polypeptide of SEQ ID NO: 114.

An embodiment of the invention is a method for reducing or preventing soil redeposition using a detergent composition comprising an isolated polypeptide having at least 96% sequence identity to the mature polypeptide of SEQ ID NO: 114.

An embodiment of the invention is a method for reducing or preventing soil redeposition using a detergent composition comprising an isolated polypeptide having at least 97% sequence identity to the mature polypeptide of SEQ ID NO: 114.

An embodiment of the invention is a method for reducing or preventing soil redeposition using a detergent composition comprising an isolated polypeptide having at least 98% sequence identity to the mature polypeptide of SEQ ID NO: 114.

An embodiment of the invention is a method for reducing or preventing soil redeposition using a detergent composition comprising an isolated polypeptide having at least 99% sequence identity to the mature polypeptide of SEQ ID NO: 114.

In one aspect, the polypeptides differ by no more than 50 amino acids, e.g., 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49 or 50 from the mature polypeptide of SEQ ID NO: 114. In a preferred aspect, the polypeptides differ by no more than 10 amino acids, e.g., 1, 2, 3, 4, 5, 6, 7, 8, 9 or 10 from the mature polypeptide of SEQ ID NO: 114.

A polypeptide of the present invention preferably comprises or consists of the amino acid sequence of SEQ ID NO: 114 or an allelic variant thereof; or is a fragment thereof that has xanthan lyase activity. In another aspect, the polypeptide comprises or consists of the mature polypeptide of SEQ ID NO: 114. In another aspect, the polypeptide comprises or consists of amino acids 1 to 897 of SEQ ID NO: 114.

In another aspect, the present invention relates to a method for reducing or preventing soil redeposition using a detergent composition comprising an isolated polypeptide having xanthan lyase activity encoded by a polynucleotide that hybridizes under high stringency conditions, or very high stringency conditions with (i) the mature polypeptide coding sequence of SEQ ID NO: 3, or (ii) the full-length complement of (i) (Sambrook et al., 1989, Molecular Cloning, A Laboratory Manual, 2d edition, Cold Spring Harbor, N.Y.).

In another aspect, the method for reducing or preventing soil redeposition using a detergent composition comprises an isolated polypeptide encoded by a polynucleotide having a sequence identity to the mature polypeptide of SEQ ID NO: 114 of at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100%.

An embodiment of the invention is a method for reducing or preventing soil redeposition using a detergent composition comprising an isolated polypeptide having at least 85% sequence identity to the mature polypeptide of SEQ ID NO: 118.

An embodiment of the invention is a method for reducing or preventing soil redeposition using a detergent composition comprising an isolated polypeptide having at least 86% sequence identity to the mature polypeptide of SEQ ID NO: 118.

An embodiment of the invention is a method for reducing or preventing soil redeposition using a detergent composition comprising an isolated polypeptide having at least 87% sequence identity to the mature polypeptide of SEQ ID NO: 118.

An embodiment of the invention is a method for reducing or preventing soil redeposition using a detergent composition comprising an isolated polypeptide having at least 88% sequence identity to the mature polypeptide of SEQ ID NO: 118.

An embodiment of the invention is a method for reducing or preventing soil redeposition using a detergent composition comprising an isolated polypeptide having at least 89% sequence identity to the mature polypeptide of SEQ ID NO: 118.

An embodiment of the invention is a method for reducing or preventing soil redeposition using a detergent composition comprising an isolated polypeptide having at least 90% sequence identity to the mature polypeptide of SEQ ID NO: 118.

An embodiment of the invention is a method for reducing or preventing soil redeposition using a detergent composition comprising an isolated polypeptide having at least 91% sequence identity to the mature polypeptide of SEQ ID NO: 118.

An embodiment of the invention is a method for reducing or preventing soil redeposition using a detergent composition comprising an isolated polypeptide having at least 92% sequence identity to the mature polypeptide of SEQ ID NO: 118.

An embodiment of the invention is a method for reducing or preventing soil redeposition using a detergent composition comprising an isolated polypeptide having at least 93% sequence identity to the mature polypeptide of SEQ ID NO: 118.

An embodiment of the invention is a method for reducing or preventing soil redeposition using a detergent composition comprising an isolated polypeptide having at least 94% sequence identity to the mature polypeptide of SEQ ID NO: 118.

An embodiment of the invention is a method for reducing or preventing soil redeposition using a detergent composition comprising an isolated polypeptide having at least 95% sequence identity to the mature polypeptide of SEQ ID NO: 118.

An embodiment of the invention is a method for reducing or preventing soil redeposition using a detergent composition comprising an isolated polypeptide having at least 96% sequence identity to the mature polypeptide of SEQ ID NO: 118.

An embodiment of the invention is a method for reducing or preventing soil redeposition using a detergent composition comprising an isolated polypeptide having at least 97% sequence identity to the mature polypeptide of SEQ ID NO: 118.

An embodiment of the invention is a method for reducing or preventing soil redeposition using a detergent composition comprising an isolated polypeptide having at least 98% sequence identity to the mature polypeptide of SEQ ID NO: 118.

An embodiment of the invention is a method for reducing or preventing soil redeposition using a detergent composition comprising an isolated polypeptide having at least 99% sequence identity to the mature polypeptide of SEQ ID NO: 118.

In one aspect, the polypeptides differ by no more than 50 amino acids, e.g., 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49 or 50 from the mature polypeptide of SEQ ID NO: 118. In a preferred aspect, the polypeptides differ by no more than 10 amino acids, e.g., 1, 2, 3, 4, 5, 6, 7, 8, 9 or 10 from the mature polypeptide of SEQ ID NO: 118.

A polypeptide of the present invention preferably comprises or consists of the amino acid sequence of SEQ ID NO: 118 or an allelic variant thereof; or is a fragment thereof that has xanthan lyase activity. In another aspect, the polypeptide comprises or consists of the mature polypeptide of SEQ ID NO: 118. In another aspect, the polypeptide comprises or consists of amino acids 1 to 933 of SEQ ID NO: 118.

In another aspect, the present invention relates to a method for reducing or preventing soil redeposition using a detergent composition comprising an isolated polypeptide having xanthan lyase activity encoded by a polynucleotide that hybridizes under high stringency conditions, or very high stringency conditions with (i) the mature polypeptide coding sequence of SEQ ID NO: 3, or (ii) the full-length complement of (i) (Sambrook et al., 1989, Molecular Cloning, A Laboratory Manual, 2d edition, Cold Spring Harbor, N.Y.).

In another aspect, the method for reducing or preventing soil redeposition using a detergent composition comprises an isolated polypeptide encoded by a polynucleotide having a sequence identity to the mature polypeptide of SEQ ID NO: 118 of at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100%.

An embodiment of the invention is a method for reducing or preventing soil redeposition using a detergent composition comprising an isolated polypeptide having at least 85% sequence identity to the mature polypeptide of SEQ ID NO: 122.

An embodiment of the invention is a method for reducing or preventing soil redeposition using a detergent composition comprising an isolated polypeptide having at least 86% sequence identity to the mature polypeptide of SEQ ID NO: 122.

An embodiment of the invention is a method for reducing or preventing soil redeposition using a detergent composition comprising an isolated polypeptide having at least 87% sequence identity to the mature polypeptide of SEQ ID NO: 122.

An embodiment of the invention is a method for reducing or preventing soil redeposition using a detergent composition comprising an isolated polypeptide having at least 88% sequence identity to the mature polypeptide of SEQ ID NO: 122.

An embodiment of the invention is a method for reducing or preventing soil redeposition using a detergent composition comprising an isolated polypeptide having at least 89% sequence identity to the mature polypeptide of SEQ ID NO: 122.

An embodiment of the invention is a method for reducing or preventing soil redeposition using a detergent composition comprising an isolated polypeptide having at least 90% sequence identity to the mature polypeptide of SEQ ID NO: 122.

An embodiment of the invention is a method for reducing or preventing soil redeposition using a detergent composition comprising an isolated polypeptide having at least 91% sequence identity to the mature polypeptide of SEQ ID NO: 122.

An embodiment of the invention is a method for reducing or preventing soil redeposition using a detergent composition comprising an isolated polypeptide having at least 92% sequence identity to the mature polypeptide of SEQ ID NO: 122.

An embodiment of the invention is a method for reducing or preventing soil redeposition using a detergent composition comprising an isolated polypeptide having at least 93% sequence identity to the mature polypeptide of SEQ ID NO: 122.

An embodiment of the invention is a method for reducing or preventing soil redeposition using a detergent composition comprising an isolated polypeptide having at least 94% sequence identity to the mature polypeptide of SEQ ID NO: 122.

An embodiment of the invention is a method for reducing or preventing soil redeposition using a detergent composition comprising an isolated polypeptide having at least 95% sequence identity to the mature polypeptide of SEQ ID NO: 122.

An embodiment of the invention is a method for reducing or preventing soil redeposition using a detergent composition comprising an isolated polypeptide having at least 96% sequence identity to the mature polypeptide of SEQ ID NO: 122.

An embodiment of the invention is a method for reducing or preventing soil redeposition using a detergent composition comprising an isolated polypeptide having at least 97% sequence identity to the mature polypeptide of SEQ ID NO: 122.

An embodiment of the invention is a method for reducing or preventing soil redeposition using a detergent composition comprising an isolated polypeptide having at least 98% sequence identity to the mature polypeptide of SEQ ID NO: 122.

An embodiment of the invention is a method for reducing or preventing soil redeposition using a detergent composition comprising an isolated polypeptide having at least 99% sequence identity to the mature polypeptide of SEQ ID NO: 122.

In one aspect, the polypeptides differ by no more than 50 amino acids, e.g., 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49 or 50 from the mature polypeptide of SEQ ID NO: 122. In a preferred aspect, the polypeptides differ by no more than 10 amino acids, e.g., 1, 2, 3, 4, 5, 6, 7, 8, 9 or 10 from the mature polypeptide of SEQ ID NO: 122.

A polypeptide of the present invention preferably comprises or consists of the amino acid sequence of SEQ ID NO: 122 or an allelic variant thereof; or is a fragment thereof that has xanthan lyase activity. In another aspect, the polypeptide comprises or consists of the mature polypeptide of SEQ ID NO: 122. In another aspect, the polypeptide comprises or consists of amino acids 1 to 1049 of SEQ ID NO: 122.

In another aspect, the present invention relates to a method for reducing or preventing soil redeposition using a detergent composition comprising an isolated polypeptide having xanthan lyase activity encoded by a polynucleotide that hybridizes under high stringency conditions, or very high stringency conditions with (i) the mature polypeptide coding sequence of SEQ ID NO: 3, or (ii) the full-length complement of (i) (Sambrook et al., 1989, Molecular Cloning, A Laboratory Manual, 2d edition, Cold Spring Harbor, N.Y.).

In another aspect, the method for reducing or preventing soil redeposition using a detergent composition comprises an isolated polypeptide encoded by a polynucleotide having a sequence identity to the mature polypeptide of SEQ ID NO: 122 of at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100%.

An embodiment of the invention is a method for reducing or preventing soil redeposition using a detergent composition comprising an isolated polypeptide having at least 85% sequence identity to the mature polypeptide of SEQ ID NO: 126.

An embodiment of the invention is a method for reducing or preventing soil redeposition using a detergent composition comprising an isolated polypeptide having at least 86% sequence identity to the mature polypeptide of SEQ ID NO: 126.

An embodiment of the invention is a method for reducing or preventing soil redeposition using a detergent composition comprising an isolated polypeptide having at least 87% sequence identity to the mature polypeptide of SEQ ID NO: 126.

An embodiment of the invention is a method for reducing or preventing soil redeposition using a detergent composition comprising an isolated polypeptide having at least 88% sequence identity to the mature polypeptide of SEQ ID NO: 126.

An embodiment of the invention is a method for reducing or preventing soil redeposition using a detergent composition comprising an isolated polypeptide having at least 89% sequence identity to the mature polypeptide of SEQ ID NO: 126.

An embodiment of the invention is a method for reducing or preventing soil redeposition using a detergent composition comprising an isolated polypeptide having at least 90% sequence identity to the mature polypeptide of SEQ ID NO: 126.

An embodiment of the invention is a method for reducing or preventing soil redeposition using a detergent composition comprising an isolated polypeptide having at least 91% sequence identity to the mature polypeptide of SEQ ID NO: 126.

An embodiment of the invention is a method for reducing or preventing soil redeposition using a detergent composition comprising an isolated polypeptide having at least 92% sequence identity to the mature polypeptide of SEQ ID NO: 126.

An embodiment of the invention is a method for reducing or preventing soil redeposition using a detergent composition comprising an isolated polypeptide having at least 93% sequence identity to the mature polypeptide of SEQ ID NO: 126.

An embodiment of the invention is a method for reducing or preventing soil redeposition using a detergent composition comprising an isolated polypeptide having at least 94% sequence identity to the mature polypeptide of SEQ ID NO: 126.

An embodiment of the invention is a method for reducing or preventing soil redeposition using a detergent composition comprising an isolated polypeptide having at least 95% sequence identity to the mature polypeptide of SEQ ID NO: 126.

An embodiment of the invention is a method for reducing or preventing soil redeposition using a detergent composition comprising an isolated polypeptide having at least 96% sequence identity to the mature polypeptide of SEQ ID NO: 126.

An embodiment of the invention is a method for reducing or preventing soil redeposition using a detergent composition comprising an isolated polypeptide having at least 97% sequence identity to the mature polypeptide of SEQ ID NO: 126.

An embodiment of the invention is a method for reducing or preventing soil redeposition using a detergent composition comprising an isolated polypeptide having at least 98% sequence identity to the mature polypeptide of SEQ ID NO: 126.

An embodiment of the invention is a method for reducing or preventing soil redeposition using a detergent composition comprising an isolated polypeptide having at least 99% sequence identity to the mature polypeptide of SEQ ID NO: 126.

In one aspect, the polypeptides differ by no more than 50 amino acids, e.g., 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49 or 50 from the mature polypeptide of SEQ ID NO: 126. In a preferred aspect, the polypeptides differ by no more than 10 amino acids, e.g., 1, 2, 3, 4, 5, 6, 7, 8, 9 or 10 from the mature polypeptide of SEQ ID NO: 126.

A polypeptide of the present invention preferably comprises or consists of the amino acid sequence of SEQ ID NO: 126 or an allelic variant thereof; or is a fragment thereof that has xanthan lyase activity. In another aspect, the polypeptide comprises or consists of the mature polypeptide of SEQ ID NO: 126. In another aspect, the polypeptide comprises or consists of amino acids 1 to 900 of SEQ ID NO: 126.

In another aspect, the present invention relates to a method for reducing or preventing soil redeposition using a detergent composition comprising an isolated polypeptide having xanthan lyase activity encoded by a polynucleotide that hybridizes under high stringency conditions, or very high stringency conditions with (i) the mature polypeptide coding sequence of SEQ ID NO: 3, or (ii) the full-length complement of (i) (Sambrook et al., 1989, Molecular Cloning, A Laboratory Manual, 2d edition, Cold Spring Harbor, N.Y.).

In another aspect, the method for reducing or preventing soil redeposition using a detergent composition comprises an isolated polypeptide encoded by a polynucleotide having a sequence identity to the mature polypeptide of SEQ ID NO: 126 of at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100%.

The polynucleotide of SEQ ID NO: 3, SEQ ID NO: 45, SEQ ID NO: 59, SEQ ID NO: 63, SEQ ID NO: 105, SEQ ID NO: 109, SEQ ID NO: 113, SEQ ID NO: 117, SEQ ID NO: 121, SEQ ID NO: 125, or a subsequence thereof, may be used to design nucleic acid probes to identify and clone DNA encoding polypeptides having xanthan lyase activity from strains of different genera or species according to methods well known in the art. In particular, such probes can be used for hybridization with the genomic DNA or cDNA of a cell of interest, following standard Southern blotting procedures, in order to identify and isolate the corresponding gene therein. Such probes can be considerably shorter than the entire sequence, but should be at least 15, e.g., at least 25, at least 35, or at least 70 nucleotides in length. Preferably, the nucleic acid probe is at least 100 nucleotides in length, e.g., at least 200 nucleotides, at least 300 nucleotides, at least 400 nucleotides, at least 500 nucleotides, at least 600 nucleotides, at least 700 nucleotides, at least 800 nucleotides, or at least 900 nucleotides in length. Both DNA and RNA probes can be used. The probes are typically labelled for detecting the corresponding gene (for example, with ³²P, ³H, ³⁵S, biotin, or avidin). Such probes are encompassed by the present invention.

A genomic DNA or cDNA library prepared from such other strains may be screened for DNA that hybridizes with the probes described above and encodes a polypeptide having xanthan lyase activity. Genomic or other DNA from such other strains may be separated by agarose or polyacrylamide gel electrophoresis, or other separation techniques. DNA from the libraries or the separated DNA may be transferred to and immobilized on nitrocellulose or other suitable carrier material. In order to identify a clone or DNA that hybridizes with SEQ ID NO: 3, SEQ ID NO: 45, SEQ ID NO: 59, SEQ ID NO: 63, SEQ ID NO: 105, SEQ ID NO: 109, SEQ ID NO: 113, SEQ ID NO: 117, SEQ ID NO: 121, SEQ ID NO: 125 or a subsequence thereof, the carrier material is used in a Southern blot.

For purposes of the present invention, hybridization indicates that the polynucleotide hybridizes to a labelled nucleic acid probe corresponding to (i) SEQ ID NO: 3, SEQ ID NO: 45, SEQ ID NO: 59, SEQ ID NO: 63, SEQ ID NO: 105, SEQ ID NO: 109, SEQ ID NO: 113, SEQ ID NO: 117, SEQ ID NO: 121, SEQ ID NO: 125; (ii) the mature polypeptide coding sequence of SEQ ID NO: 3, SEQ ID NO: 45, SEQ ID NO: 59, SEQ ID NO: 63, SEQ ID NO: 105, SEQ ID NO: 109, SEQ ID NO: 113, SEQ ID NO: 117, SEQ ID NO: 121, SEQ ID NO: 125; (iii) the full-length complement thereof; or (iv) a subsequence thereof; under high stringency conditions to very high stringency conditions. Molecules to which the nucleic acid probe hybridizes under these conditions can be detected using, for example, X-ray film or any other detection means known in the art.

In one aspect, the nucleic acid probe is a polynucleotide that encodes the polypeptide of SEQ ID NO: 4, SEQ ID NO: 46, SEQ ID NO: 60, SEQ ID NO: 64, SEQ ID NO: 106, SEQ ID NO: 110, SEQ ID NO: 114, SEQ ID NO: 118, SEQ ID NO: 122 or SEQ ID NO: 126; the mature polypeptide thereof; or a fragment thereof. In another aspect, the nucleic acid probe is SEQ ID NO: 3, SEQ ID NO: 45, SEQ ID NO: 59, SEQ ID NO: 63, SEQ ID NO: 105, SEQ ID NO: 109, SEQ ID NO: 113, SEQ ID NO: 117, SEQ ID NO: 121 or SEQ ID NO: 125.

In another embodiment, the present invention relates to a method for reducing or preventing soil redeposition using a detergent composition comprising a variant of the mature polypeptide of SEQ ID NO: 4 comprising a substitution, deletion, and/or insertion at one or more (e.g., several) positions. In an embodiment, the number of amino acid substitutions, deletions and/or insertions introduced into the mature polypeptide of SEQ ID NO: 4 is up to 152, e.g., 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 38, 45, 53, 60, 68, 76, 83, 91, 98, 106, 114 or 152. In a preferred aspect, the number of amino acid substitutions, deletions and/or insertions introduced into the mature polypeptide of SEQ ID NO: 4 is up to 10, e.g., 1, 2, 3, 4, 5, 6, 7, 8, 9 or 10. The amino acid changes may be of a minor nature, that is conservative amino acid substitutions or insertions that do not significantly affect the folding and/or activity of the protein; small deletions, typically of 1-30 amino acids; small amino- or carboxyl-terminal extensions, such as an amino-terminal methionine residue; a small linker peptide of up to 20-25 residues; or a small extension that facilitates purification by changing net charge or another function, such as a His-tag (poly-histidine tract), an antigenic epitope or a binding domain.

In another embodiment, the present invention relates to a method for reducing or preventing soil redeposition using a detergent composition comprising a variant of the mature polypeptide of SEQ ID NO: 46 comprising a substitution, deletion, and/or insertion at one or more (e.g., several) positions. In an embodiment, the number of amino acid substitutions, deletions and/or insertions introduced into the mature polypeptide of SEQ ID NO: 46 is up to 208, e.g., 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 41, 52, 62, 73, 83, 93, 104, 114, 125, 135, 146, 156 or 208. In a preferred aspect, the number of amino acid substitutions, deletions and/or insertions introduced into the mature polypeptide of SEQ ID NO: 46 is up to 10, e.g., 1, 2, 3, 4, 5, 6, 7, 8, 9 or 10. The amino acid changes may be of a minor nature, that is conservative amino acid substitutions or insertions that do not significantly affect the folding and/or activity of the protein; small deletions, typically of 1-30 amino acids; small amino- or carboxyl-terminal extensions, such as an amino-terminal methionine residue; a small linker peptide of up to 20-25 residues; or a small extension that facilitates purification by changing net charge or another function, such as a His-tag (poly-histidine tract), an antigenic epitope or a binding domain.

In another embodiment, the present invention relates to a method for reducing or preventing soil redeposition using a detergent composition comprising a variant of the mature polypeptide of SEQ ID NO: 60 comprising a substitution, deletion, and/or insertion at one or more (e.g., several) positions. In an embodiment, the number of amino acid substitutions, deletions and/or insertions introduced into the mature polypeptide of SEQ ID NO: 60 is up to 179, e.g., 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 35, 44, 53, 62, 71, 80, 89, 98, 107, 116, 125, 134 or 179. In a preferred aspect, the number of amino acid substitutions, deletions and/or insertions introduced into the mature polypeptide of SEQ ID NO: 60 is up to 10, e.g., 1, 2, 3, 4, 5, 6, 7, 8, 9 or 10. The amino acid changes may be of a minor nature, that is conservative amino acid substitutions or insertions that do not significantly affect the folding and/or activity of the protein; small deletions, typically of 1-30 amino acids; small amino- or carboxyl-terminal extensions, such as an amino-terminal methionine residue; a small linker peptide of up to 20-25 residues; or a small extension that facilitates purification by changing net charge or another function, such as a His-tag (poly-histidine tract), an antigenic epitope or a binding domain.

In another embodiment, the present invention relates to a method for reducing or preventing soil redeposition using a detergent composition comprising a variant of the mature polypeptide of SEQ ID NO: 64 comprising a substitution, deletion, and/or insertion at one or more (e.g., several) positions. In an embodiment, the number of amino acid substitutions, deletions and/or insertions introduced into the mature polypeptide of SEQ ID NO: 64 is up to 207, e.g., 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 41, 51, 62, 72, 83, 93, 103, 114, 124, 134, 145, 155 or 207. In a preferred aspect, the number of amino acid substitutions, deletions and/or insertions introduced into the mature polypeptide of SEQ ID NO: 64 is up to 10, e.g., 1, 2, 3, 4, 5, 6, 7, 8, 9 or 10. The amino acid changes may be of a minor nature, that is conservative amino acid substitutions or insertions that do not significantly affect the folding and/or activity of the protein; small deletions, typically of 1-30 amino acids; small amino- or carboxyl-terminal extensions, such as an amino-terminal methionine residue; a small linker peptide of up to 20-25 residues; or a small extension that facilitates purification by changing net charge or another function, such as a His-tag (poly-histidine tract), an antigenic epitope or a binding domain.

In another embodiment, the present invention relates to a method for reducing or preventing soil redeposition using a detergent composition comprising a variant of the mature polypeptide of SEQ ID NO: 106 comprising a substitution, deletion, and/or insertion at one or more (e.g., several) positions. In an embodiment, the number of amino acid substitutions, deletions and/or insertions introduced into the mature polypeptide of SEQ ID NO: 106 is up to 180, e.g., 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 36, 45, 54, 63, 72, 81, 90, 99, 108, 117, 126, 135 or 180. In a preferred aspect, the number of amino acid substitutions, deletions and/or insertions introduced into the mature polypeptide of SEQ ID NO: 106 is up to 10, e.g., 1, 2, 3, 4, 5, 6, 7, 8, 9 or 10. The amino acid changes may be of a minor nature, that is conservative amino acid substitutions or insertions that do not significantly affect the folding and/or activity of the protein; small deletions, typically of 1-30 amino acids; small amino- or carboxyl-terminal extensions, such as an amino-terminal methionine residue; a small linker peptide of up to 20-25 residues; or a small extension that facilitates purification by changing net charge or another function, such as a His-tag (poly-histidine tract), an antigenic epitope or a binding domain.

In another embodiment, the present invention relates to a method for reducing or preventing soil redeposition using a detergent composition comprising a variant of the mature polypeptide of SEQ ID NO: 110 comprising a substitution, deletion, and/or insertion at one or more (e.g., several) positions. In an embodiment, the number of amino acid substitutions, deletions and/or insertions introduced into the mature polypeptide of SEQ ID NO: 110 is up to 207, e.g., 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 35, 44, 53, 62, 71, 80, 89, 98, 107, 116, 125, 134 or 179. In a preferred aspect, the number of amino acid substitutions, deletions and/or insertions introduced into the mature polypeptide of SEQ ID NO: 110 is up to 10, e.g., 1, 2, 3, 4, 5, 6, 7, 8, 9 or 10. The amino acid changes may be of a minor nature, that is conservative amino acid substitutions or insertions that do not significantly affect the folding and/or activity of the protein; small deletions, typically of 1-30 amino acids; small amino- or carboxyl-terminal extensions, such as an amino-terminal methionine residue; a small linker peptide of up to 20-25 residues; or a small extension that facilitates purification by changing net charge or another function, such as a His-tag (poly-histidine tract), an antigenic epitope or a binding domain.

In another embodiment, the present invention relates to a method for reducing or preventing soil redeposition using a detergent composition comprising a variant of the mature polypeptide of SEQ ID NO: 114 comprising a substitution, deletion, and/or insertion at one or more (e.g., several) positions. In an embodiment, the number of amino acid substitutions, deletions and/or insertions introduced into the mature polypeptide of SEQ ID NO: 114 is up to 207, e.g., 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 35, 44, 53, 62, 71, 80, 89, 98, 107, 116, 125, 134 or 179. In a preferred aspect, the number of amino acid substitutions, deletions and/or insertions introduced into the mature polypeptide of SEQ ID NO: 114 is up to 10, e.g., 1, 2, 3, 4, 5, 6, 7, 8, 9 or 10. The amino acid changes may be of a minor nature, that is conservative amino acid substitutions or insertions that do not significantly affect the folding and/or activity of the protein; small deletions, typically of 1-30 amino acids; small amino- or carboxyl-terminal extensions, such as an amino-terminal methionine residue; a small linker peptide of up to 20-25 residues; or a small extension that facilitates purification by changing net charge or another function, such as a His-tag (poly-histidine tract), an antigenic epitope or a binding domain.

In another embodiment, the present invention relates to a method for reducing or preventing soil redeposition using a detergent composition comprising a variant of the mature polypeptide of SEQ ID NO: 118 comprising a substitution, deletion, and/or insertion at one or more (e.g., several) positions. In an embodiment, the number of amino acid substitutions, deletions and/or insertions introduced into the mature polypeptide of SEQ ID NO: 118 is up to 186, e.g., 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 37, 46, 55, 65, 74, 83, 93, 102, 111, 121, 130 or 139, 186. In a preferred aspect, the number of amino acid substitutions, deletions and/or insertions introduced into the mature polypeptide of SEQ ID NO: 118 is up to 10, e.g., 1, 2, 3, 4, 5, 6, 7, 8, 9 or 10. The amino acid changes may be of a minor nature, that is conservative amino acid substitutions or insertions that do not significantly affect the folding and/or activity of the protein; small deletions, typically of 1-30 amino acids; small amino- or carboxyl-terminal extensions, such as an amino-terminal methionine residue; a small linker peptide of up to 20-25 residues; or a small extension that facilitates purification by changing net charge or another function, such as a His-tag (poly-histidine tract), an antigenic epitope or a binding domain.

In another embodiment, the present invention relates to a method for reducing or preventing soil redeposition using a detergent composition comprising a variant of the mature polypeptide of SEQ ID NO: 122 comprising a substitution, deletion, and/or insertion at one or more (e.g., several) positions. In an embodiment, the number of amino acid substitutions, deletions and/or insertions introduced into the mature polypeptide of SEQ ID NO: 122 is up to 209, e.g., 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 41, 52, 62, 73, 83, 94, 104, 115, 125, 136, 146, 157 or 209. In a preferred aspect, the number of amino acid substitutions, deletions and/or insertions introduced into the mature polypeptide of SEQ ID NO: 122 is up to 10, e.g., 1, 2, 3, 4, 5, 6, 7, 8, 9 or 10. The amino acid changes may be of a minor nature, that is conservative amino acid substitutions or insertions that do not significantly affect the folding and/or activity of the protein; small deletions, typically of 1-30 amino acids; small amino- or carboxyl-terminal extensions, such as an amino-terminal methionine residue; a small linker peptide of up to 20-25 residues; or a small extension that facilitates purification by changing net charge or another function, such as a His-tag (poly-histidine tract), an antigenic epitope or a binding domain.

In another embodiment, the present invention relates to a method for reducing or preventing soil redeposition using a detergent composition comprising a variant of the mature polypeptide of SEQ ID NO: 126 comprising a substitution, deletion, and/or insertion at one or more (e.g., several) positions. In an embodiment, the number of amino acid substitutions, deletions and/or insertions introduced into the mature polypeptide of SEQ ID NO: 126 is up to 180, e.g., 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 36, 45, 54, 63, 72, 81, 90, 99, 108, 117, 126, 135 or 180. In a preferred aspect, the number of amino acid substitutions, deletions and/or insertions introduced into the mature polypeptide of SEQ ID NO: 126 is up to 10, e.g., 1, 2, 3, 4, 5, 6, 7, 8, 9 or 10. The amino acid changes may be of a minor nature, that is conservative amino acid substitutions or insertions that do not significantly affect the folding and/or activity of the protein; small deletions, typically of 1-30 amino acids; small amino- or carboxyl-terminal extensions, such as an amino-terminal methionine residue; a small linker peptide of up to 20-25 residues; or a small extension that facilitates purification by changing net charge or another function, such as a His-tag (poly-histidine tract), an antigenic epitope or a binding domain.

Examples of conservative substitutions are within the groups of basic amino acids (arginine, lysine and histidine), acidic amino acids (glutamic acid and aspartic acid), polar amino acids (glutamine and asparagine), hydrophobic amino acids (leucine, isoleucine and valine), aromatic amino acids (phenylalanine, tryptophan and tyrosine), and small amino acids (glycine, alanine, serine, threonine and methionine). Amino acid substitutions that do not generally alter specific activity are known in the art and are described, for example, by H. Neurath and R. L. Hill, 1979, In, The Proteins, Academic Press, New York. Common substitutions are Ala/Ser, Val/Ile, Asp/Glu, Thr/Ser, Ala/Gly, Ala/Thr, Ser/Asn, Ala/Val, Ser/Gly, Tyr/Phe, Ala/Pro, Lys/Arg, Asp/Asn, Leu/Ile, Leu/Val, Ala/Glu, and Asp/Gly.

Alternatively, the amino acid changes are of such a nature that the physico-chemical properties of the polypeptides are altered. For example, amino acid changes may improve the thermal stability of the polypeptide, alter the substrate specificity, change the pH optimum, and the like.

Essential amino acids in a polypeptide can be identified according to procedures known in the art, such as site-directed mutagenesis or alanine-scanning mutagenesis (Cunningham and Wells, 1989, Science 244: 1081-1085). In the latter technique, single alanine mutations are introduced at every residue in the molecule, and the resultant mutant molecules are tested for xanthan lyase activity to identify amino acid residues that are critical to the activity of the molecule. See also, Hilton et al., 1996, J. Biol. Chem. 271: 4699-4708. The active site of the enzyme or other biological interaction can also be determined by physical analysis of structure, as determined by such techniques as nuclear magnetic resonance, crystallography, electron diffraction, or photoaffinity labeling, in conjunction with mutation of putative contact site amino acids. See, for example, de Vos et al., 1992, Science 255: 306-312; Smith et al., 1992, J. Mol. Biol. 224: 899-904; Wlodaver et al., 1992, FEBS Lett. 309: 59-64. The identity of essential amino acids can also be inferred from an alignment with a related polypeptide.

Single or multiple amino acid substitutions, deletions, and/or insertions can be made and tested using known methods of mutagenesis, recombination, and/or shuffling, followed by a relevant screening procedure, such as those disclosed by Reidhaar-Olson and Sauer, 1988, Science 241: 53-57; Bowie and Sauer, 1989, Proc. Natl. Acad. Sci. USA 86: 2152-2156; WO 95/17413; or WO 95/22625. Other methods that can be used include error-prone PCR, phage display (e.g., Lowman et al., 1991, Biochemistry 30: 10832-10837; U.S. Pat. No. 5,223,409; WO 92/06204), and region-directed mutagenesis (Derbyshire et al., 1986, Gene 46: 145; Ner et al., 1988, DNA 7: 127).

Mutagenesis/shuffling methods can be combined with high-throughput, automated screening methods to detect activity of cloned, mutagenized polypeptides expressed by host cells (Ness et al., 1999, Nature Biotechnology 17: 893-896). Mutagenized DNA molecules that encode active polypeptides can be recovered from the host cells and rapidly sequenced using standard methods in the art. These methods allow the rapid determination of the importance of individual amino acid residues in a polypeptide.

The polypeptide may be a hybrid polypeptide in which a region of one polypeptide is fused at the N-terminus or the C-terminus of a region of another polypeptide.

The polypeptide may be a fusion polypeptide or cleavable fusion polypeptide in which another polypeptide is fused at the N-terminus or the C-terminus of the polypeptide of the present invention. A fusion polypeptide is produced by fusing a polynucleotide encoding another polypeptide to a polynucleotide of the present invention. Techniques for producing fusion polypeptides are known in the art, and include ligating the coding sequences encoding the polypeptides so that they are in frame and that expression of the fusion polypeptide is under control of the same promoter(s) and terminator. Fusion polypeptides may also be constructed using intein technology in which fusion polypeptides are created post-translationally (Cooper et al., 1993, EMBO J. 12: 2575-2583; Dawson et al., 1994, Science 266: 776-779).

A fusion polypeptide can further comprise a cleavage site between the two polypeptides. Upon secretion of the fusion protein, the site is cleaved releasing the two polypeptides. Examples of cleavage sites include, but are not limited to, the sites disclosed in Martin et al., 2003, J. Ind. Microbiol. Biotechnol. 3: 568-576; Svetina et al., 2000, J. Biotechnol. 76: 245-251; Rasmussen-Wilson et al., 1997, Appl. Environ. Microbiol. 63: 3488-3493; Ward et al., 1995, Biotechnology 13: 498-503; and Contreras et al., 1991, Biotechnology 9: 378-381; Eaton et al., 1986, Biochemistry 25: 505-512; Collins-Racie et al., 1995, Biotechnology 13: 982-987; Carter et al., 1989, Proteins: Structure, Function, and Genetics 6: 240-248; and Stevens, 2003, Drug Discovery World 4: 35-48.

The polypeptide may be expressed by a recombinant DNA sequence containing the coding for a His-tag or HQ-tag to give, after any post-translational modifications, the mature polypeptide containing all or part of the His- or HQ-tag. The HQ-tag, having the sequence -RHQHQHQ, may be fully or partly cleaved off the polypeptide during the post-translational modifications resulting in for example the additional amino acids -RHQHQ attached to the N-terminal of the mature polypeptide. The His-tag, having the sequence -RPHHHHHH, may be fully or partly cleaved off the polypeptide during the post-translational modifications resulting in additional amino acids such as -RPHHHHH, -RPHHHH, -RPHHH, -RPHH, -RPH, -RP or -R attached to the N-terminal of the mature polypeptide.

### Methods for Reducing or Preventing Soil Redeposition Using Detergent Compositions Comprising Xanthan Lyases and GH9 Endoglucanases

An embodiment of the invention is a method for reducing or preventing soil redeposition using a detergent composition comprising a xanthan lyase of the invention and an isolated GH9 endoglucanase.

In one embodiment, the detergent composition further comprises one or more detergent components selected from the group comprising surfactants, builders, hydrotopes, bleaching systems, polymers, fabric hueing agents, adjunct materials, dispersants, dye transfer inhibiting agents, fluorescent whitening agents and soil release polymers, or any mixture thereof. The detergent composition may be in the form of a bar, a homogenous tablet, a tablet having two or more layers, a pouch having one or more compartments, a regular or compact powder, a granulate, a paste, a gel, or a regular, compact or concentrated liquid and may be used for dish wash or laundering.

In another embodiment, the detergent composition comprises one or more additional enzymes selected from the group comprising proteases, amylases, lipases, cutinases, cellulases, endoglucanases, xyloglucanases, pectinases, pectin lyases, xanthanases, peroxidaes, haloperoxygenases, catalases and mannanases, or any mixture thereof.

In a further embodiment, the detergent composition comprises one or more detergent components selected from the group comprising surfactants, builders, hydrotopes, bleaching systems, polymers, fabric hueing agents, adjunct materials, dispersants, dye transfer inhibiting agents, fluorescent whitening agents and soil release polymers, or any mixture thereof and one or more additional enzymes selected from the group comprising proteases, amylases, lipases, cutinases, cellulases, endoglucanases, xyloglucanases, pectinases, pectin lyases, xanthanases, peroxidaes, haloperoxygenases, catalases and mannanases, or any mixture thereof.

The method may comprise the following steps:
(a) providing a wash liquor by dissolving/mixing the detergent composition in water;
(b) washing the objects/fabrics/textiles in the wash liquor;
(c) draining the wash liquor and optionally repeating the wash cycle; and
(d) rinsing and optionally drying the objects/fabrics/textiles.

A preferred embodiment of the invention is a method for reducing soil redeposition using a detergent composition comprising a xanthan lyase of the invention and an isolated GH9 endoglucanase wherein the isolated GH9 endoglucanase is selected from the group consisting of:
(a) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 2;
(b) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 10;
(c) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 12;
(d) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 14;
(e) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 48;
(f) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 52;
(g) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 56;
(h) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 82;
(i) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 86;
(j) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 90;
(k) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 94;
(l) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 98;
(m) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 102;
(n) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 130;
(o) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 134;
(p) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 138;
(q) a polypeptide encoded by a polynucleotide that hybridizes under medium stringency conditions, medium-high stringency conditions, high stringency conditions, or very high stringency conditions with:
   (i) the mature polypeptide coding sequence of SEQ ID NO: 1;
   (ii) the mature polypeptide coding sequence of SEQ ID NO: 9;
   (iii) the mature polypeptide coding sequence of SEQ ID NO: 11;
   (iv) the mature polypeptide coding sequence of SEQ ID NO: 13;
   (v) the mature polypeptide coding sequence of SEQ ID NO: 47;
   (vi) the mature polypeptide coding sequence of SEQ ID NO: 51;
   (vii) the mature polypeptide coding sequence of SEQ ID NO: 55;
   (viii) the mature polypeptide coding sequence of SEQ ID NO: 81;
   (ix) the mature polypeptide coding sequence of SEQ ID NO: 85;
   (x) the mature polypeptide coding sequence of SEQ ID NO: 89;
   (xi) the mature polypeptide coding sequence of SEQ ID NO: 93;
   (xii) the mature polypeptide coding sequence of SEQ ID NO: 97;
   (xiii) the mature polypeptide coding sequence of SEQ ID NO: 101;
   (xiv) the mature polypeptide coding sequence of SEQ ID NO: 129;
   (xv) the mature polypeptide coding sequence of SEQ ID NO: 133;
   (xvi) the mature polypeptide coding sequence of SEQ ID NO: 137; or
   (xvii) the full-length complement thereof of (i), (ii), (iii), (iv), (v), (vi), (vii), (viii), (ix), (x), (xi), (xii), (xiii), (xiv), (xv), or (xvi);
(r) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 1;
(s) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 9;
(t) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 11;
(u) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 13;
(v) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 47;
(w) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 51;
(x) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 55;
(y) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 81;
(z) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 85;
(aa) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 89;
(ab) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 93;
(ac) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 97;
(ad) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 101;
(ae) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 129;
(af) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 133;
(ag) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 137;
(ah) a variant of the mature polypeptide of SEQ ID NO: 2, SEQ ID NO: 10, SEQ ID NO: 12, SEQ ID NO: 14, SEQ ID NO: 48, SEQ ID NO: 52, SEQ ID NO: 56, SEQ ID NO: 82, SEQ ID NO: 86, SEQ ID NO: 90, SEQ ID NO: 94, SEQ ID NO: 98, SEQ ID NO: 102, SEQ ID NO: 130, SEQ ID NO: 134 or SEQ ID NO: 138 comprising a substitution, deletion, and/or insertion at one or more positions (e.g. several); and
(ai) a fragment of the polypeptide of (a), (b), (c), (d), (e), (f), (g), (h), (i), (j), (k), (l), (m), (n), (o), (p), (q), (r), (s), (t), (u), (v), (w), (x), (y), (z), (aa), (ab), (ac), (ad), (ae), (af), (ag) or (ah) that has xanthan degrading activity and/or endo-β-1,4-glucanase activity.

A further preferred embodiment of the invention is a method for reducing or preventing soil redeposition using a detergent composition comprising an isolated polypeptide having xanthan lyase activity selected from the group consisting of:
(a) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 4;
(b) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 46;
(c) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 60;
(d) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 64;
(e) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 106;
(f) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 110;
(g) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 114;
(h) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 118;
(i) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 122;
(j) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 126;
(k) a polypeptide encoded by a polynucleotide that hybridizes under medium stringency conditions, medium-high stringency conditions, high stringency conditions, or very high stringency conditions with:
   (i) the mature polypeptide coding sequence of SEQ ID NO: 3;
   (ii) the mature polypeptide coding sequence of SEQ ID NO: 45;
   (iii) the mature polypeptide coding sequence of SEQ ID NO: 59;
   (iv) the mature polypeptide coding sequence of SEQ ID NO: 63;
   (v) the mature polypeptide coding sequence of SEQ ID NO: 105;
   (vi) the mature polypeptide coding sequence of SEQ ID NO: 109;
   (vii) the mature polypeptide coding sequence of SEQ ID NO: 113;
   (viii) the mature polypeptide coding sequence of SEQ ID NO: 117;
   (ix) the mature polypeptide coding sequence of SEQ ID NO: 121;
   (x) the mature polypeptide coding sequence of SEQ ID NO: 125; or
   (xi) the full-length complement thereof of (i), (ii), (iii), (iv), (v), (vi), (vii), (viii), (ix), or (x);
(l) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 3;
(m) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 45;
(n) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 59;
(o) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 63;
(p) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 105;
(q) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 109;
(r) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 113;
(s) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 117;
(t) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 121;
(u) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 125;
(v) a variant of the mature polypeptide of SEQ ID NO: 4, SEQ ID NO: 46, SEQ ID NO: 60, SEQ ID NO: 64, SEQ ID NO: 106, SEQ ID NO: 110, SEQ ID NO: 114, SEQ ID NO: 118, SEQ ID NO: 122 or SEQ ID NO: 126 comprising a substitution, deletion, and/or insertion at one or more positions (e.g. several); and
(w) a fragment of the polypeptide of (a), (b), (c), (d), (e), (f), (g), (h), (i), (j), (k), (l), (m), (n), (o), (p), (q), (r), (s), (t), (u) or (v) that has xanthan lyase activity;
   and an isolated GH9 endoglucanase selected from the group consisting of:
(a) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 2;
(b) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 10;
(c) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 48;
(d) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 56;
(e) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 82;
(f) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 86;
(g) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 90;
(h) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 94;
(i) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 98;
(j) a polypeptide encoded by a polynucleotide that hybridizes under medium stringency conditions, medium-high stringency conditions, high stringency conditions, or very high stringency conditions with:
   (i) the mature polypeptide coding sequence of SEQ ID NO: 1;
   (ii) the mature polypeptide coding sequence of SEQ ID NO: 9;
   (iii) the mature polypeptide coding sequence of SEQ ID NO: 47;
   (iv) the mature polypeptide coding sequence of SEQ ID NO: 55;
   (v) the mature polypeptide coding sequence of SEQ ID NO: 81;
   (vi) the mature polypeptide coding sequence of SEQ ID NO: 85;
   (vii) the mature polypeptide coding sequence of SEQ ID NO: 89;
   (viii) the mature polypeptide coding sequence of SEQ ID NO: 93;
   (ix) the mature polypeptide coding sequence of SEQ ID NO: 97;
   (x) the full-length complement thereof of (i), (ii), (iii), (iv), (v), (vi), (vii), (viii), (ix) or (x);
(k) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 1;
(l) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 9;
(m) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 47;
(n) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 55;
(o) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 81;
(p) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 85;
(q) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 89;
(r) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 93;
(s) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 97;
(t) a variant of the mature polypeptide of SEQ ID NO: 2, SEQ ID NO: 10, SEQ ID NO: 48, SEQ ID NO: 56, SEQ ID NO: 82, SEQ ID NO: 86, SEQ ID NO: 90, SEQ ID NO: 94 or SEQ ID NO: 98 comprising a substitution, deletion, and/or insertion at one or more positions (e.g. several); and
(u) a fragment of the polypeptide of (a), (b), (c), (d), (e), (f), (g), (h), (i), (j), (k), (l), (m), (n), (o), (p), (q), (r), (s), (t) or (u) that has xanthan degrading activity and/or endo-β-1,4-glucanase activity.

An embodiment of the invention is the method for reducing or preventing soil redeposition using a detergent composition comprising the isolated xanthan lyase of SEQ ID NO: 4 and an isolated GH9 endoglucanase. In a further embodiment, the detergent composition comprises one or more detergent components selected from the group comprising surfactants, builders, hydrotopes, bleaching systems, polymers, fabric hueing agents, adjunct materials, dispersants, dye transfer inhibiting agents, fluorescent whitening agents and soil release polymers, or any mixture thereof. The detergent composition may be in the form of a bar, a homogenous tablet, a tablet having two or more layers, a pouch having one or more compartments, a regular or compact powder, a granulate, a paste, a gel, or a regular, compact or concentrated liquid and may be used for dish wash or laundering.

In another embodiment, the detergent composition comprises one or more additional enzymes selected from the group comprising proteases, amylases, lipases, cutinases, cellulases, endoglucanases, xyloglucanases, pectinases, pectin lyases, xanthanases, peroxidaes, haloperoxygenases, catalases and mannanases, or any mixture thereof.

In a further embodiment, the detergent composition comprises one or more detergent components selected from the group comprising surfactants, builders, hydrotopes, bleaching systems, polymers, fabric hueing agents, adjunct materials, dispersants, dye transfer inhibiting agents, fluorescent whitening agents and soil release polymers, or any mixture thereof and one or more additional enzymes selected from the group comprising proteases, amylases, lipases, cutinases, cellulases, endoglucanases, xyloglucanases, pectinases, pectin lyases, xanthanases, peroxidaes, haloperoxygenases, catalases and mannanases, or any mixture thereof.

In an embodiment, the method for reducing or preventing soil redeposition using a detergent composition comprises the isolated xanthan lyase of SEQ ID NO: 4 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 2.

In an embodiment, the method for reducing or preventing soil redeposition using a detergent composition comprises the isolated xanthan lyase of SEQ ID NO: 4 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 10.

In an embodiment, the method for reducing or preventing soil redeposition using a detergent composition comprises the isolated xanthan lyase of SEQ ID NO: 4 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 12.

In an embodiment, the method for reducing or preventing soil redeposition using a detergent composition comprises the isolated xanthan lyase of SEQ ID NO: 4 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 14.

In an embodiment, the method for reducing or preventing soil redeposition using a detergent composition comprises the isolated xanthan lyase of SEQ ID NO: 4 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 48.

In an embodiment, the method for reducing or preventing soil redeposition using a detergent composition comprises the isolated xanthan lyase of SEQ ID NO: 4 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 52.

In an embodiment, the method for reducing or preventing soil redeposition using a detergent composition comprises the isolated xanthan lyase of SEQ ID NO: 4 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 56.

In an embodiment, the method for reducing or preventing soil redeposition using a detergent composition comprises the isolated xanthan lyase of SEQ ID NO: 4 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 82.

In an embodiment, the method for reducing or preventing soil redeposition using a detergent composition comprises the isolated xanthan lyase of SEQ ID NO: 4 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 86.

In an embodiment, the method for reducing or preventing soil redeposition using a detergent composition comprises the isolated xanthan lyase of SEQ ID NO: 4 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 90.

In an embodiment, the method for reducing or preventing soil redeposition using a detergent composition comprises the isolated xanthan lyase of SEQ ID NO: 4 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 94.

In an embodiment, the method for reducing or preventing soil redeposition using a detergent composition comprises the isolated xanthan lyase of SEQ ID NO: 4 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 98.

In an embodiment, the method for reducing or preventing soil redeposition using a detergent composition comprises the isolated xanthan lyase of SEQ ID NO: 4 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 102.

In an embodiment, the method for reducing or preventing soil redeposition using a detergent composition comprises the isolated xanthan lyase of SEQ ID NO: 4 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 130.

In an embodiment, the method for reducing or preventing soil redeposition using a detergent composition comprises the isolated xanthan lyase of SEQ ID NO: 4 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 134.

In an embodiment, the method for reducing or preventing soil redeposition using a detergent composition comprises the isolated xanthan lyase of SEQ ID NO: 4 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 138.

An embodiment of the invention is the method for reducing or preventing soil redeposition using a detergent composition comprising the isolated xanthan lyase of SEQ ID NO: 46 and an isolated GH9 endoglucanase. In a further embodiment, the detergent composition comprises one or more detergent components selected from the group comprising surfactants, builders, hydrotopes, bleaching systems, polymers, fabric hueing agents, adjunct materials, dispersants, dye transfer inhibiting agents, fluorescent whitening agents and soil release polymers, or any mixture thereof. The detergent composition may be in the form of a bar, a homogenous tablet, a tablet having two or more layers, a pouch having one or more compartments, a regular or compact powder, a granulate, a paste, a gel, or a regular, compact or concentrated liquid and may be used for dish wash or laundering.

In another embodiment, the detergent composition comprises one or more additional enzymes selected from the group comprising proteases, amylases, lipases, cutinases, cellulases, endoglucanases, xyloglucanases, pectinases, pectin lyases, xanthanases, peroxidaes, haloperoxygenases, catalases and mannanases, or any mixture thereof.

In a further embodiment, the detergent composition comprises one or more detergent components selected from the group comprising surfactants, builders, hydrotopes, bleaching systems, polymers, fabric hueing agents, adjunct materials, dispersants, dye transfer inhibiting agents, fluorescent whitening agents and soil release polymers, or any mixture thereof and one or more additional enzymes selected from the group comprising proteases, amylases, lipases, cutinases, cellulases, endoglucanases, xyloglucanases, pectinases, pectin lyases, xanthanases, peroxidaes, haloperoxygenases, catalases and mannanases, or any mixture thereof.

In an embodiment, the method for reducing or preventing soil redeposition using a detergent composition comprises the isolated xanthan lyase of SEQ ID NO: 46 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 2.

In an embodiment, the method for reducing or preventing soil redeposition using a detergent composition comprises the isolated xanthan lyase of SEQ ID NO: 46 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 10.

In an embodiment, the method for reducing or preventing soil redeposition using a detergent composition comprises the isolated xanthan lyase of SEQ ID NO: 46 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 12.

In an embodiment, the method for reducing or preventing soil redeposition using a detergent composition comprises the isolated xanthan lyase of SEQ ID NO: 46 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 14.

In an embodiment, the method for reducing or preventing soil redeposition using a detergent composition comprises the isolated xanthan lyase of SEQ ID NO: 46 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 48.

In an embodiment, the method for reducing or preventing soil redeposition using a detergent composition comprises the isolated xanthan lyase of SEQ ID NO: 46 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 52.

In an embodiment, the method for reducing or preventing soil redeposition using a detergent composition comprises the isolated xanthan lyase of SEQ ID NO: 46 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 56.

In an embodiment, the method for reducing or preventing soil redeposition using a detergent composition comprises the isolated xanthan lyase of SEQ ID NO: 46 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 82.

In an embodiment, the method for reducing or preventing soil redeposition using a detergent composition comprises the isolated xanthan lyase of SEQ ID NO: 46 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 86.

In an embodiment, the method for reducing or preventing soil redeposition using a detergent composition comprises the isolated xanthan lyase of SEQ ID NO: 46 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 90.

In an embodiment, the method for reducing or preventing soil redeposition using a detergent composition comprises the isolated xanthan lyase of SEQ ID NO: 46 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 94.

In an embodiment, the method for reducing or preventing soil redeposition using a detergent composition comprises the isolated xanthan lyase of SEQ ID NO: 46 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 98.

In an embodiment, the method for reducing or preventing soil redeposition using a detergent composition comprises the isolated xanthan lyase of SEQ ID NO: 46 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 102.

In an embodiment, the method for reducing or preventing soil redeposition using a detergent composition comprises the isolated xanthan lyase of SEQ ID NO: 46 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 130.

In an embodiment, the method for reducing or preventing soil redeposition using a detergent composition comprises the isolated xanthan lyase of SEQ ID NO: 46 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 134.

In an embodiment, the method for reducing or preventing soil redeposition using a detergent composition comprises the isolated xanthan lyase of SEQ ID NO: 46 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 138.

An embodiment of the invention is the method for reducing or preventing soil redeposition using a detergent composition comprising the isolated xanthan lyase of SEQ ID NO: 60 and an isolated GH9 endoglucanase. In a further embodiment, the detergent composition comprises one or more detergent components selected from the group comprising surfactants, builders, hydrotopes, bleaching systems, polymers, fabric hueing agents, adjunct materials, dispersants, dye transfer inhibiting agents, fluorescent whitening agents and soil release polymers, or any mixture thereof. The detergent composition may be in the form of a bar, a homogenous tablet, a tablet having two or more layers, a pouch having one or more compartments, a regular or compact powder, a granulate, a paste, a gel, or a regular, compact or concentrated liquid and may be used for dish wash or laundering.

In another embodiment, the detergent composition comprises one or more additional enzymes selected from the group comprising proteases, amylases, lipases, cutinases, cellulases, endoglucanases, xyloglucanases, pectinases, pectin lyases, xanthanases, peroxidaes, haloperoxygenases, catalases and mannanases, or any mixture thereof.

In a further embodiment, the detergent composition comprises one or more detergent components selected from the group comprising surfactants, builders, hydrotopes, bleaching systems, polymers, fabric hueing agents, adjunct materials, dispersants, dye transfer inhibiting agents, fluorescent whitening agents and soil release polymers, or any mixture thereof and one or more additional enzymes selected from the group comprising proteases, amylases, lipases, cutinases, cellulases, endoglucanases, xyloglucanases, pectinases, pectin lyases, xanthanases, peroxidaes, haloperoxygenases, catalases and mannanases, or any mixture thereof.

In an embodiment, the method for reducing or preventing soil redeposition using a detergent composition comprises the isolated xanthan lyase of SEQ ID NO: 60 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 2.

In an embodiment, the method for reducing or preventing soil redeposition using a detergent composition comprises the isolated xanthan lyase of SEQ ID NO: 60 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 10.

In an embodiment, the method for reducing or preventing soil redeposition using a detergent composition comprises the isolated xanthan lyase of SEQ ID NO: 60 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 12.

In an embodiment, the method for reducing or preventing soil redeposition using a detergent composition comprises the isolated xanthan lyase of SEQ ID NO: 60 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 14.

In an embodiment, the method for reducing or preventing soil redeposition using a detergent composition comprises the isolated xanthan lyase of SEQ ID NO: 60 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 48.

In an embodiment, the method for reducing or preventing soil redeposition using a detergent composition comprises the isolated xanthan lyase of SEQ ID NO: 60 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 52.

In an embodiment, the method for reducing or preventing soil redeposition using a detergent composition comprises the isolated xanthan lyase of SEQ ID NO: 60 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 56.

In an embodiment, the method for reducing or preventing soil redeposition using a detergent composition comprises the isolated xanthan lyase of SEQ ID NO: 60 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 82.

In an embodiment, the method for reducing or preventing soil redeposition using a detergent composition comprises the isolated xanthan lyase of SEQ ID NO: 60 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 86.

In an embodiment, the method for reducing or preventing soil redeposition using a detergent composition comprises the isolated xanthan lyase of SEQ ID NO: 60 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 90.

In an embodiment, the method for reducing or preventing soil redeposition using a detergent composition comprises the isolated xanthan lyase of SEQ ID NO: 60 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 94.

In an embodiment, the method for reducing or preventing soil redeposition using a detergent composition comprises the isolated xanthan lyase of SEQ ID NO: 60 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 98.

In an embodiment, the method for reducing or preventing soil redeposition using a detergent composition comprises the isolated xanthan lyase of SEQ ID NO: 60 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 102.

In an embodiment, the method for reducing or preventing soil redeposition using a detergent composition comprises the isolated xanthan lyase of SEQ ID NO: 60 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 130.

In an embodiment, the method for reducing or preventing soil redeposition using a detergent composition comprises the isolated xanthan lyase of SEQ ID NO: 60 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 134.

In an embodiment, the method for reducing or preventing soil redeposition using a detergent composition comprises the isolated xanthan lyase of SEQ ID NO: 60 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 138.

An embodiment of the invention is the method for reducing or preventing soil redeposition using a detergent composition comprising the isolated xanthan lyase of SEQ ID NO: 64 and an isolated GH9 endoglucanase. In a further embodiment, the detergent composition comprises one or more detergent components selected from the group comprising surfactants, builders, hydrotopes, bleaching systems, polymers, fabric hueing agents, adjunct materials, dispersants, dye transfer inhibiting agents, fluorescent whitening agents and soil release polymers, or any mixture thereof. The detergent composition may be in the form of a bar, a homogenous tablet, a tablet having two or more layers, a pouch having one or more compartments, a regular or compact powder, a granulate, a paste, a gel, or a regular, compact or concentrated liquid and may be used for dish wash or laundering.

In another embodiment, the detergent composition comprises one or more additional enzymes selected from the group comprising proteases, amylases, lipases, cutinases, cellulases, endoglucanases, xyloglucanases, pectinases, pectin lyases, xanthanases, peroxidaes, haloperoxygenases, catalases and mannanases, or any mixture thereof.

In a further embodiment, the detergent composition comprises one or more detergent components selected from the group comprising surfactants, builders, hydrotopes, bleaching systems, polymers, fabric hueing agents, adjunct materials, dispersants, dye transfer inhibiting agents, fluorescent whitening agents and soil release polymers, or any mixture thereof and one or more additional enzymes selected from the group comprising proteases, amylases, lipases, cutinases, cellulases, endoglucanases, xyloglucanases, pectinases, pectin lyases, xanthanases, peroxidaes, haloperoxygenases, catalases and mannanases, or any mixture thereof.

In an embodiment, the method for reducing or preventing soil redeposition using a detergent composition comprises the isolated xanthan lyase of SEQ ID NO: 64 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 2.

In an embodiment, the method for reducing or preventing soil redeposition using a detergent composition comprises the isolated xanthan lyase of SEQ ID NO: 64 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 10.

In an embodiment, the method for reducing or preventing soil redeposition using a detergent composition comprises the isolated xanthan lyase of SEQ ID NO: 64 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 12.

In an embodiment, the method for reducing or preventing soil redeposition using a detergent composition comprises the isolated xanthan lyase of SEQ ID NO: 64 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 14.

In an embodiment, the method for reducing or preventing soil redeposition using a detergent composition comprises the isolated xanthan lyase of SEQ ID NO: 64 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 48.

In an embodiment, the method for reducing or preventing soil redeposition using a detergent composition comprises the isolated xanthan lyase of SEQ ID NO: 64 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 52.

In an embodiment, the method for reducing or preventing soil redeposition using a detergent composition comprises the isolated xanthan lyase of SEQ ID NO: 64 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 56.

In an embodiment, the method for reducing or preventing soil redeposition using a detergent composition comprises the isolated xanthan lyase of SEQ ID NO: 64 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 82.

In an embodiment, the method for reducing or preventing soil redeposition using a detergent composition comprises the isolated xanthan lyase of SEQ ID NO: 64 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 86.

In an embodiment, the method for reducing or preventing soil redeposition using a detergent composition comprises the isolated xanthan lyase of SEQ ID NO: 64 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 90.

In an embodiment, the method for reducing or preventing soil redeposition using a detergent composition comprises the isolated xanthan lyase of SEQ ID NO: 64 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 94.

In an embodiment, the method for reducing or preventing soil redeposition using a detergent composition comprises the isolated xanthan lyase of SEQ ID NO: 64 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 98.

In an embodiment, the method for reducing or preventing soil redeposition using a detergent composition comprises the isolated xanthan lyase of SEQ ID NO: 64 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 102.

In an embodiment, the method for reducing or preventing soil redeposition using a detergent composition comprises the isolated xanthan lyase of SEQ ID NO: 64 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 130.

In an embodiment, the method for reducing or preventing soil redeposition using a detergent composition comprises the isolated xanthan lyase of SEQ ID NO: 64 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 134.

In an embodiment, the method for reducing or preventing soil redeposition using a detergent composition comprises the isolated xanthan lyase of SEQ ID NO: 64 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 138.

An embodiment of the invention is the method for reducing or preventing soil redeposition using a detergent composition comprising the isolated xanthan lyase of SEQ ID NO: 106 and an isolated GH9 endoglucanase. In a further embodiment, the detergent composition comprises one or more detergent components selected from the group comprising surfactants, builders, hydrotopes, bleaching systems, polymers, fabric hueing agents, adjunct materials, dispersants, dye transfer inhibiting agents, fluorescent whitening agents and soil release polymers, or any mixture thereof. The detergent composition may be in the form of a bar, a homogenous tablet, a tablet having two or more layers, a pouch having one or more compartments, a regular or compact powder, a granulate, a paste, a gel, or a regular, compact or concentrated liquid and may be used for dish wash or laundering.

In another embodiment, the detergent composition comprises one or more additional enzymes selected from the group comprising proteases, amylases, lipases, cutinases, cellulases, endoglucanases, xyloglucanases, pectinases, pectin lyases, xanthanases, peroxidaes, haloperoxygenases, catalases and mannanases, or any mixture thereof.

In a further embodiment, the detergent composition comprises one or more detergent components selected from the group comprising surfactants, builders, hydrotopes, bleaching systems, polymers, fabric hueing agents, adjunct materials, dispersants, dye transfer inhibiting agents, fluorescent whitening agents and soil release polymers, or any mixture thereof and one or more additional enzymes selected from the group comprising proteases, amylases, lipases, cutinases, cellulases, endoglucanases, xyloglucanases, pectinases, pectin lyases, xanthanases, peroxidaes, haloperoxygenases, catalases and mannanases, or any mixture thereof.

In an embodiment, the method for reducing or preventing soil redeposition using a detergent composition comprises the isolated xanthan lyase of SEQ ID NO: 106 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 2.

In an embodiment, the method for reducing or preventing soil redeposition using a detergent composition comprises the isolated xanthan lyase of SEQ ID NO: 106 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 10.

In an embodiment, the method for reducing or preventing soil redeposition using a detergent composition comprises the isolated xanthan lyase of SEQ ID NO: 106 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 12.

In an embodiment, the method for reducing or preventing soil redeposition using a detergent composition comprises the isolated xanthan lyase of SEQ ID NO: 106 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 14.

In an embodiment, the method for reducing or preventing soil redeposition using a detergent composition comprises the isolated xanthan lyase of SEQ ID NO: 106 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 48.

In an embodiment, the method for reducing or preventing soil redeposition using a detergent composition comprises the isolated xanthan lyase of SEQ ID NO: 106 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 52.

In an embodiment, the method for reducing or preventing soil redeposition using a detergent composition comprises the isolated xanthan lyase of SEQ ID NO: 106 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 56.

In an embodiment, the method for reducing or preventing soil redeposition using a detergent composition comprises the isolated xanthan lyase of SEQ ID NO: 106 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 82.

In an embodiment, the method for reducing or preventing soil redeposition using a detergent composition comprises the isolated xanthan lyase of SEQ ID NO: 106 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 86.

In an embodiment, the method for reducing or preventing soil redeposition using a detergent composition comprises the isolated xanthan lyase of SEQ ID NO: 106 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 90.

In an embodiment, the method for reducing or preventing soil redeposition using a detergent composition comprises the isolated xanthan lyase of SEQ ID NO: 106 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 94.

In an embodiment, the method for reducing or preventing soil redeposition using a detergent composition comprises the isolated xanthan lyase of SEQ ID NO: 106 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 98.

In an embodiment, the method for reducing or preventing soil redeposition using a detergent composition comprises the isolated xanthan lyase of SEQ ID NO: 106 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 102.

In an embodiment, the method for reducing or preventing soil redeposition using a detergent composition comprises the isolated xanthan lyase of SEQ ID NO: 106 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 130.

In an embodiment, the method for reducing or preventing soil redeposition using a detergent composition comprises the isolated xanthan lyase of SEQ ID NO: 106 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 134.

In an embodiment, the method for reducing or preventing soil redeposition using a detergent composition comprises the isolated xanthan lyase of SEQ ID NO: 106 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 138.

An embodiment of the invention is the method for reducing or preventing soil redeposition using a detergent composition comprising the isolated xanthan lyase of SEQ ID NO: 110 and an isolated GH9 endoglucanase. In a further embodiment, the detergent composition comprises one or more detergent components selected from the group comprising surfactants, builders, hydrotopes, bleaching systems, polymers, fabric hueing agents, adjunct materials, dispersants, dye transfer inhibiting agents, fluorescent whitening agents and soil release polymers, or any mixture thereof. The detergent composition may be in the form of a bar, a homogenous tablet, a tablet having two or more layers, a pouch having one or more compartments, a regular or compact powder, a granulate, a paste, a gel, or a regular, compact or concentrated liquid and may be used for dish wash or laundering.

In another embodiment, the detergent composition comprises one or more additional enzymes selected from the group comprising proteases, amylases, lipases, cutinases, cellulases, endoglucanases, xyloglucanases, pectinases, pectin lyases, xanthanases, peroxidaes, haloperoxygenases, catalases and mannanases, or any mixture thereof.

In a further embodiment, the detergent composition comprises one or more detergent components selected from the group comprising surfactants, builders, hydrotopes, bleaching systems, polymers, fabric hueing agents, adjunct materials, dispersants, dye transfer inhibiting agents, fluorescent whitening agents and soil release polymers, or any mixture thereof and one or more additional enzymes selected from the group comprising proteases, amylases, lipases, cutinases, cellulases, endoglucanases, xyloglucanases, pectinases, pectin lyases, xanthanases, peroxidaes, haloperoxygenases, catalases and mannanases, or any mixture thereof.

In an embodiment, the method for reducing or preventing soil redeposition using a detergent composition comprises the isolated xanthan lyase of SEQ ID NO: 110 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 2.

In an embodiment, the method for reducing or preventing soil redeposition using a detergent composition comprises the isolated xanthan lyase of SEQ ID NO: 110 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 10.

In an embodiment, the method for reducing or preventing soil redeposition using a detergent composition comprises the isolated xanthan lyase of SEQ ID NO: 110 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 12.

In an embodiment, the method for reducing or preventing soil redeposition using a detergent composition comprises the isolated xanthan lyase of SEQ ID NO: 110 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 14.

In an embodiment, the method for reducing or preventing soil redeposition using a detergent composition comprises the isolated xanthan lyase of SEQ ID NO: 110 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 48.

In an embodiment, the method for reducing or preventing soil redeposition using a detergent composition comprises the isolated xanthan lyase of SEQ ID NO: 110 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 52.

In an embodiment, the method for reducing or preventing soil redeposition using a detergent composition comprises the isolated xanthan lyase of SEQ ID NO: 110 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 56.

In an embodiment, the method for reducing or preventing soil redeposition using a detergent composition comprises the isolated xanthan lyase of SEQ ID NO: 110 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 82.

In an embodiment, the method for reducing or preventing soil redeposition using a detergent composition comprises the isolated xanthan lyase of SEQ ID NO: 110 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 86.

In an embodiment, the method for reducing or preventing soil redeposition using a detergent composition comprises the isolated xanthan lyase of SEQ ID NO: 110 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 90.

In an embodiment, the method for reducing or preventing soil redeposition using a detergent composition comprises the isolated xanthan lyase of SEQ ID NO: 110 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 94.

In an embodiment, the method for reducing or preventing soil redeposition using a detergent composition comprises the isolated xanthan lyase of SEQ ID NO: 110 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 98.

In an embodiment, the method for reducing or preventing soil redeposition using a detergent composition comprises the isolated xanthan lyase of SEQ ID NO: 110 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 102.

In an embodiment, the method for reducing or preventing soil redeposition using a detergent composition comprises the isolated xanthan lyase of SEQ ID NO: 110 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 130.

In an embodiment, the method for reducing or preventing soil redeposition using a detergent composition comprises the isolated xanthan lyase of SEQ ID NO: 110 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 134.

In an embodiment, the method for reducing or preventing soil redeposition using a detergent composition comprises the isolated xanthan lyase of SEQ ID NO: 110 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 138.

An embodiment of the invention is the method for reducing or preventing soil redeposition using a detergent composition comprising the isolated xanthan lyase of SEQ ID NO: 114 and an isolated GH9 endoglucanase. In a further embodiment, the detergent composition comprises one or more detergent components selected from the group comprising surfactants, builders, hydrotopes, bleaching systems, polymers, fabric hueing agents, adjunct materials, dispersants, dye transfer inhibiting agents, fluorescent whitening agents and soil release polymers, or any mixture thereof. The detergent composition may be in the form of a bar, a homogenous tablet, a tablet having two or more layers, a pouch having one or more compartments, a regular or compact powder, a granulate, a paste, a gel, or a regular, compact or concentrated liquid and may be used for dish wash or laundering.

In another embodiment, the detergent composition comprises one or more additional enzymes selected from the group comprising proteases, amylases, lipases, cutinases, cellulases, endoglucanases, xyloglucanases, pectinases, pectin lyases, xanthanases, peroxidaes, haloperoxygenases, catalases and mannanases, or any mixture thereof.

In a further embodiment, the detergent composition comprises one or more detergent components selected from the group comprising surfactants, builders, hydrotopes, bleaching systems, polymers, fabric hueing agents, adjunct materials, dispersants, dye transfer inhibiting agents, fluorescent whitening agents and soil release polymers, or any mixture thereof and one or more additional enzymes selected from the group comprising proteases, amylases, lipases, cutinases, cellulases, endoglucanases, xyloglucanases, pectinases, pectin lyases, xanthanases, peroxidaes, haloperoxygenases, catalases and mannanases, or any mixture thereof.

In an embodiment, the method for reducing or preventing soil redeposition using a detergent composition comprises the isolated xanthan lyase of SEQ ID NO: 114 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 2.

In an embodiment, the method for reducing or preventing soil redeposition using a detergent composition comprises the isolated xanthan lyase of SEQ ID NO: 114 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 10.

In an embodiment, the method for reducing or preventing soil redeposition using a detergent composition comprises the isolated xanthan lyase of SEQ ID NO: 114 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 12.

In an embodiment, the method for reducing or preventing soil redeposition using a detergent composition comprises the isolated xanthan lyase of SEQ ID NO: 114 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 14.

In an embodiment, the method for reducing or preventing soil redeposition using a detergent composition comprises the isolated xanthan lyase of SEQ ID NO: 114 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 48.

In an embodiment, the method for reducing or preventing soil redeposition using a detergent composition comprises the isolated xanthan lyase of SEQ ID NO: 114 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 52.

In an embodiment, the method for reducing or preventing soil redeposition using a detergent composition comprises the isolated xanthan lyase of SEQ ID NO: 114 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 56.

In an embodiment, the method for reducing or preventing soil redeposition using a detergent composition comprises the isolated xanthan lyase of SEQ ID NO: 114 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 82.

In an embodiment, the method for reducing or preventing soil redeposition using a detergent composition comprises the isolated xanthan lyase of SEQ ID NO: 114 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 86.

In an embodiment, the method for reducing or preventing soil redeposition using a detergent composition comprises the isolated xanthan lyase of SEQ ID NO: 114 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 90.

In an embodiment, the method for reducing or preventing soil redeposition using a detergent composition comprises the isolated xanthan lyase of SEQ ID NO: 114 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 94.

In an embodiment, the method for reducing or preventing soil redeposition using a detergent composition comprises the isolated xanthan lyase of SEQ ID NO: 114 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 98.

In an embodiment, the method for reducing or preventing soil redeposition using a detergent composition comprises the isolated xanthan lyase of SEQ ID NO: 114 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 102.

In an embodiment, the method for reducing or preventing soil redeposition using a detergent composition comprises the isolated xanthan lyase of SEQ ID NO: 114 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 130.

In an embodiment, the method for reducing or preventing soil redeposition using a detergent composition comprises the isolated xanthan lyase of SEQ ID NO: 114 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 134.

In an embodiment, the method for reducing or preventing soil redeposition using a detergent composition comprises the isolated xanthan lyase of SEQ ID NO: 114 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 138.

An embodiment of the invention is the method for reducing or preventing soil redeposition using a detergent composition comprising the isolated xanthan lyase of SEQ ID NO: 118 and an isolated GH9 endoglucanase. In a further embodiment, the detergent composition comprises one or more detergent components selected from the group comprising surfactants, builders, hydrotopes, bleaching systems, polymers, fabric hueing agents, adjunct materials, dispersants, dye transfer inhibiting agents, fluorescent whitening agents and soil release polymers, or any mixture thereof. The detergent composition may be in the form of a bar, a homogenous tablet, a tablet having two or more layers, a pouch having one or more compartments, a regular or compact powder, a granulate, a paste, a gel, or a regular, compact or concentrated liquid and may be used for dish wash or laundering.

In another embodiment, the detergent composition comprises one or more additional enzymes selected from the group comprising proteases, amylases, lipases, cutinases, cellulases, endoglucanases, xyloglucanases, pectinases, pectin lyases, xanthanases, peroxidaes, haloperoxygenases, catalases and mannanases, or any mixture thereof.

In a further embodiment, the detergent composition comprises one or more detergent components selected from the group comprising surfactants, builders, hydrotopes, bleaching systems, polymers, fabric hueing agents, adjunct materials, dispersants, dye transfer inhibiting agents, fluorescent whitening agents and soil release polymers, or any mixture thereof and one or more additional enzymes selected from the group comprising proteases, amylases, lipases, cutinases, cellulases, endoglucanases, xyloglucanases, pectinases, pectin lyases, xanthanases, peroxidaes, haloperoxygenases, catalases and mannanases, or any mixture thereof.

In an embodiment, the method for reducing or preventing soil redeposition using a detergent composition comprises the isolated xanthan lyase of SEQ ID NO: 118 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 2.

In an embodiment, the method for reducing or preventing soil redeposition using a detergent composition comprises the isolated xanthan lyase of SEQ ID NO: 118 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 10.

In an embodiment, the method for reducing or preventing soil redeposition using a detergent composition comprises the isolated xanthan lyase of SEQ ID NO: 118 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 12.

In an embodiment, the method for reducing or preventing soil redeposition using a detergent composition comprises the isolated xanthan lyase of SEQ ID NO: 118 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 14.

In an embodiment, the method for reducing or preventing soil redeposition using a detergent composition comprises the isolated xanthan lyase of SEQ ID NO: 118 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 48.

In an embodiment, the method for reducing or preventing soil redeposition using a detergent composition comprises the isolated xanthan lyase of SEQ ID NO: 118 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 52.

In an embodiment, the method for reducing or preventing soil redeposition using a detergent composition comprises the isolated xanthan lyase of SEQ ID NO: 118 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 56.

In an embodiment, the method for reducing or preventing soil redeposition using a detergent composition comprises the isolated xanthan lyase of SEQ ID NO: 118 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 82.

In an embodiment, the method for reducing or preventing soil redeposition using a detergent composition comprises the isolated xanthan lyase of SEQ ID NO: 118 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 86.

In an embodiment, the method for reducing or preventing soil redeposition using a detergent composition comprises the isolated xanthan lyase of SEQ ID NO: 118 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 90.

In an embodiment, the method for reducing or preventing soil redeposition using a detergent composition comprises the isolated xanthan lyase of SEQ ID NO: 118 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 94.

In an embodiment, the method for reducing or preventing soil redeposition using a detergent composition comprises the isolated xanthan lyase of SEQ ID NO: 118 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 98.

In an embodiment, the method for reducing or preventing soil redeposition using a detergent composition comprises the isolated xanthan lyase of SEQ ID NO: 118 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 102.

In an embodiment, the method for reducing or preventing soil redeposition using a detergent composition comprises the isolated xanthan lyase of SEQ ID NO: 118 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 130.

In an embodiment, the method for reducing or preventing soil redeposition using a detergent composition comprises the isolated xanthan lyase of SEQ ID NO: 118 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 134.

In an embodiment, the method for reducing or preventing soil redeposition using a detergent composition comprises the isolated xanthan lyase of SEQ ID NO: 118 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 138.

An embodiment of the invention is the method for reducing or preventing soil redeposition using a detergent composition comprising the isolated xanthan lyase of SEQ ID NO: 122 and an isolated GH9 endoglucanase. In a further embodiment, the detergent composition comprises one or more detergent components selected from the group comprising surfactants, builders, hydrotopes, bleaching systems, polymers, fabric hueing agents, adjunct materials, dispersants, dye transfer inhibiting agents, fluorescent whitening agents and soil release polymers, or any mixture thereof. The detergent composition may be in the form of a bar, a homogenous tablet, a tablet having two or more layers, a pouch having one or more compartments, a regular or compact powder, a granulate, a paste, a gel, or a regular, compact or concentrated liquid and may be used for dish wash or laundering.

In another embodiment, the detergent composition comprises one or more additional enzymes selected from the group comprising proteases, amylases, lipases, cutinases, cellulases, endoglucanases, xyloglucanases, pectinases, pectin lyases, xanthanases, peroxidaes, haloperoxygenases, catalases and mannanases, or any mixture thereof.

In a further embodiment, the detergent composition comprises one or more detergent components selected from the group comprising surfactants, builders, hydrotopes, bleaching systems, polymers, fabric hueing agents, adjunct materials, dispersants, dye transfer inhibiting agents, fluorescent whitening agents and soil release polymers, or any mixture thereof and one or more additional enzymes selected from the group comprising proteases, amylases, lipases, cutinases, cellulases, endoglucanases, xyloglucanases, pectinases, pectin lyases, xanthanases, peroxidaes, haloperoxygenases, catalases and mannanases, or any mixture thereof.

In an embodiment, the method for reducing or preventing soil redeposition using a detergent composition comprises the isolated xanthan lyase of SEQ ID NO: 122 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 2.

In an embodiment, the method for reducing or preventing soil redeposition using a detergent composition comprises the isolated xanthan lyase of SEQ ID NO: 122 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 10.

In an embodiment, the method for reducing or preventing soil redeposition using a detergent composition comprises the isolated xanthan lyase of SEQ ID NO: 122 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 12.

In an embodiment, the method for reducing or preventing soil redeposition using a detergent composition comprises the isolated xanthan lyase of SEQ ID NO: 122 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 14.

In an embodiment, the method for reducing or preventing soil redeposition using a detergent composition comprises the isolated xanthan lyase of SEQ ID NO: 122 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 48.

In an embodiment, the method for reducing or preventing soil redeposition using a detergent composition comprises the isolated xanthan lyase of SEQ ID NO: 122 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 52.

In an embodiment, the method for reducing or preventing soil redeposition using a detergent composition comprises the isolated xanthan lyase of SEQ ID NO: 122 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 56.

In an embodiment, the method for reducing or preventing soil redeposition using a detergent composition comprises the isolated xanthan lyase of SEQ ID NO: 122 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 82.

In an embodiment, the method for reducing or preventing soil redeposition using a detergent composition comprises the isolated xanthan lyase of SEQ ID NO: 122 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 86.

In an embodiment, the method for reducing or preventing soil redeposition using a detergent composition comprises the isolated xanthan lyase of SEQ ID NO: 122 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 90.

In an embodiment, the method for reducing or preventing soil redeposition using a detergent composition comprises the isolated xanthan lyase of SEQ ID NO: 122 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 94.

In an embodiment, the method for reducing or preventing soil redeposition using a detergent composition comprises the isolated xanthan lyase of SEQ ID NO: 122 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 98.

In an embodiment, the method for reducing or preventing soil redeposition using a detergent composition comprises the isolated xanthan lyase of SEQ ID NO: 122 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 102.

In an embodiment, the method for reducing or preventing soil redeposition using a detergent composition comprises the isolated xanthan lyase of SEQ ID NO: 122 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 130.

In an embodiment, the method for reducing or preventing soil redeposition using a detergent composition comprises the isolated xanthan lyase of SEQ ID NO: 122 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 134.

In an embodiment, the method for reducing or preventing soil redeposition using a detergent composition comprises the isolated xanthan lyase of SEQ ID NO: 122 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 138.

An embodiment of the invention is the method for reducing or preventing soil redeposition using a detergent composition comprising the isolated xanthan lyase of SEQ ID NO: 126 and an isolated GH9 endoglucanase. In a further embodiment, the detergent composition comprises one or more detergent components selected from the group comprising surfactants, builders, hydrotopes, bleaching systems, polymers, fabric hueing agents, adjunct materials, dispersants, dye transfer inhibiting agents, fluorescent whitening agents and soil release polymers, or any mixture thereof. The detergent composition may be in the form of a bar, a homogenous tablet, a tablet having two or more layers, a pouch having one or more compartments, a regular or compact powder, a granulate, a paste, a gel, or a regular, compact or concentrated liquid and may be used for dish wash or laundering.

In another embodiment, the detergent composition comprises one or more additional enzymes selected from the group comprising proteases, amylases, lipases, cutinases, cellulases, endoglucanases, xyloglucanases, pectinases, pectin lyases, xanthanases, peroxidaes, haloperoxygenases, catalases and mannanases, or any mixture thereof.

In a further embodiment, the detergent composition comprises one or more detergent components selected from the group comprising surfactants, builders, hydrotopes, bleaching systems, polymers, fabric hueing agents, adjunct materials, dispersants, dye transfer inhibiting agents, fluorescent whitening agents and soil release polymers, or any mixture thereof and one or more additional enzymes selected from the group comprising proteases, amylases, lipases, cutinases, cellulases, endoglucanases, xyloglucanases, pectinases, pectin lyases, xanthanases, peroxidaes, haloperoxygenases, catalases and mannanases, or any mixture thereof.

In an embodiment, the method for reducing or preventing soil redeposition using a detergent composition comprises the isolated xanthan lyase of SEQ ID NO: 126 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 2.

In an embodiment, the method for reducing or preventing soil redeposition using a detergent composition comprises the isolated xanthan lyase of SEQ ID NO: 126 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 10.

In an embodiment, the method for reducing or preventing soil redeposition using a detergent composition comprises the isolated xanthan lyase of SEQ ID NO: 126 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 12.

In an embodiment, the method for reducing or preventing soil redeposition using a detergent composition comprises the isolated xanthan lyase of SEQ ID NO: 126 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 14.

In an embodiment, the method for reducing or preventing soil redeposition using a detergent composition comprises the isolated xanthan lyase of SEQ ID NO: 126 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 48.

In an embodiment, the method for reducing or preventing soil redeposition using a detergent composition comprises the isolated xanthan lyase of SEQ ID NO: 126 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 52.

In an embodiment, the method for reducing or preventing soil redeposition using a detergent composition comprises the isolated xanthan lyase of SEQ ID NO: 126 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 56.

In an embodiment, the method for reducing or preventing soil redeposition using a detergent composition comprises the isolated xanthan lyase of SEQ ID NO: 126 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 82.

In an embodiment, the method for reducing or preventing soil redeposition using a detergent composition comprises the isolated xanthan lyase of SEQ ID NO: 126 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 86.

In an embodiment, the method for reducing or preventing soil redeposition using a detergent composition comprises the isolated xanthan lyase of SEQ ID NO: 126 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 90.

In an embodiment, the method for reducing or preventing soil redeposition using a detergent composition comprises the isolated xanthan lyase of SEQ ID NO: 126 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 94.

In an embodiment, the method for reducing or preventing soil redeposition using a detergent composition comprises the isolated xanthan lyase of SEQ ID NO: 126 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 98.

In an embodiment, the method for reducing or preventing soil redeposition using a detergent composition comprises the isolated xanthan lyase of SEQ ID NO: 126 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 102.

In an embodiment, the method for reducing or preventing soil redeposition using a detergent composition comprises the isolated xanthan lyase of SEQ ID NO: 126 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 130.

In an embodiment, the method for reducing or preventing soil redeposition using a detergent composition comprises the isolated xanthan lyase of SEQ ID NO: 126 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 134.

In an embodiment, the method for reducing or preventing soil redeposition using a detergent composition comprises the isolated xanthan lyase of SEQ ID NO: 126 and an isolated GH9 endoglucanase having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 138.

### Sources of Xanthan Lyases Having Anti-Redeposition Properties

A polypeptide having xanthan lyase activity or GH9 endoglucanase activity may be obtained from microorganisms of any genus. For purposes of the present invention, the term “obtained from” as used herein in connection with a given source shall mean that the polypeptide encoded by a polynucleotide is produced by the source or by a strain in which the polynucleotide from the source has been inserted. In one aspect, the polypeptide obtained from a given source is secreted extracellularly.

In one aspect, the polypeptide is from a bacterium of the class Bacilli, such as from the order Bacillales, or from the family Paenibacillaceae, or from the genus Paeniobacillus or from the species Paeniobacillus such as Paeniobacillus sp NN062047, Paeniobacillus sp NN062250, Paeniobacillus sp NN062253, Paeniobacillus sp NN018054, Paeniobacillus sp NN062046, Paeniobacillus sp NN062408, Paeniobacillus sp NN062332, Paeniobacillus sp NN062147 or Paeniobacillus sp NN062193.

In another aspect, the polypeptide from a bacterium of the class Actinobacteria, such as from the order Actinomycetales, or from the family Microbacteriaceae, or from the genus Microbacterium or from the species Microbacterium such as Microbacterium testaceum, Microbacterium sp NN062045, Microbacterium sp NN062148, Microbacterium sp NN062175 or Microbacterium sp NN062149.

It will be understood that for the aforementioned species, the invention encompasses both the perfect and imperfect states, and other taxonomic equivalents, e.g., anamorphs, regardless of the species name by which they are known. Those skilled in the art will readily recognize the identity of appropriate equivalents.

Strains of these species are readily accessible to the public in a number of culture collections, such as the American Type Culture Collection (ATCC), Deutsche Sammlung von Mikroorganismen and Zellkulturen GmbH (DSMZ), Centraalbureau Voor Schimmelcultures (CBS), and Agricultural Research Service Patent Culture Collection, Northern Regional Research Center (NRRL).

The polypeptide may be identified and obtained from other sources including microorganisms isolated from nature (e.g., soil, composts, water, etc.) or DNA samples obtained directly from natural materials (e.g., soil, composts, water, etc.) using the above-mentioned probes. Techniques for isolating microorganisms and DNA directly from natural habitats are well known in the art. A polynucleotide encoding the polypeptide may then be obtained by similarly screening a genomic DNA or cDNA library of another microorganism or mixed DNA sample. Once a polynucleotide encoding a polypeptide has been detected with the probe(s), the polynucleotide can be isolated or cloned by utilizing techniques that are known to those of ordinary skill in the art (see, e.g., Sambrook et al., 1989, supra).

### Polynucleotides

The present invention also relates to isolated polynucleotides encoding a polypeptide of the present invention, as described herein.

The techniques used to isolate or clone a polynucleotide are known in the art and include isolation from genomic DNA or cDNA, or a combination thereof. The cloning of the polynucleotides from genomic DNA can be effected, e.g., by using the well known polymerase chain reaction (PCR) or antibody screening of expression libraries to detect cloned DNA fragments with shared structural features. See, e.g., Innis et al., 1990, PCR: A Guide to Methods and Application, Academic Press, New York. Other nucleic acid amplification procedures such as ligase chain reaction (LCR), ligation activated transcription (LAT) and polynucleotide-based amplification (NASBA) may be used. The polynucleotides may be cloned in a strain of Bacillus subtilis or E. Co/i, or a related organism and thus, for example, may be an allelic or species variant of the polypeptide encoding region of the polynucleotide.

Modification of a polynucleotide encoding a polypeptide of the present invention may be necessary for synthesizing polypeptides substantially similar to the polypeptide. The term “substantially similar” to the polypeptide refers to non-naturally occurring forms of the polypeptide. These polypeptides may differ in some engineered way from the polypeptide isolated from its native source, e.g., variants that differ in specific activity, thermostability, pH optimum, or the like. The variants may be constructed on the basis of the polynucleotide presented as the mature polypeptide coding sequence of SEQ ID NO: 1, SEQ ID NO: 3, SEQ ID NO: 9, SEQ ID NO: 11, SEQ ID: NO:13, SEQ ID NO: 15, SEQ ID NO: 45, SEQ ID NO: 47, SEQ ID NO: 51, SEQ ID NO: 55, SEQ ID NO: 59, SEQ ID NO: 63, SEQ ID NO: 81, SEQ ID NO: 85, SEQ ID NO: 89, SEQ ID NO: 93, SEQ ID NO: 97, SEQ ID NO: 105, SEQ ID NO: 109, SEQ ID NO: 113, SEQ ID NO: 117, SEQ ID NO: 121, SEQ ID NO: 125, SEQ ID NO: 129, SEQ ID NO: 133 or SEQ ID NO: 137, a subsequence thereof, and/or by introduction of nucleotide substitutions that do not result in a change in the amino acid sequence of the polypeptide, but which correspond to the codon usage of the host organism intended for production of the enzyme, or by introduction of nucleotide substitutions that may give rise to a different amino acid sequence. For a general description of nucleotide substitution, see Ford et al., (1991), “Protein Expression and Purification”, 2: 95-107.

### Nucleic Acid Constructs

The present invention also relates to nucleic acid constructs comprising a polynucleotide of the present invention operably linked to one or more control sequences that direct the expression of the coding sequence in a suitable host cell under conditions compatible with the control sequences.

A polynucleotide may be manipulated in a variety of ways to provide for expression of the polypeptide. Manipulation of the polynucleotide prior to its insertion into a vector may be desirable or necessary depending on the expression vector. The techniques for modifying polynucleotides utilizing recombinant DNA methods are well known in the art.

The control sequence may be a promoter, a polynucleotide that is recognized by a host cell for expression of a polynucleotide encoding a polypeptide of the present invention. The promoter contains transcriptional control sequences that mediate the expression of the polypeptide. The promoter may be any polynucleotide that shows transcriptional activity in the host cell including mutant, truncated, and hybrid promoters, and may be obtained from genes encoding extracellular or intracellular polypeptides either homologous or heterologous to the host cell.

Examples of suitable promoters for directing transcription of the nucleic acid constructs of the present invention in a bacterial host cell are the promoters obtained from the Bacillus amyloliquefaciens alpha-amylase gene (amyQ), Bacillus licheniformis alpha-amylase gene (amyL), Bacillus licheniformis penicillinase gene (penP), Bacillus stearothermophilus maltogenic amylase gene (amyM), Bacillus subtilis levansucrase gene (sacB), Bacillus subtilis xylA and xylB genes, Bacillus thuringiensis cryIIIA gene (Agaisse and Lereclus, 1994, Molecular Microbiology 13: 97-107), E. coli lac operon, E. coli trc promoter (Egon et al., 1988, Gene 69: 301-315), Streptomyces coelicolor agarase gene (dagA), and prokaryotic beta-lactamase gene (Villa-Kamaroff et al., 1978, Proc. Natl. Acad. Sci. USA 75: 3727-3731), as well as the tac promoter (DeBoer et al., 1983, Proc. Natl. Acad. Sci. USA 80: 21-25). Further promoters are described in “Useful proteins from recombinant bacteria” in Gilbert et al., 1980, Scientific American 242: 74-94; and in Sambrook et al., 1989, supra. Examples of tandem promoters are disclosed in WO 99/43835.

Examples of suitable promoters for directing transcription of the nucleic acid constructs of the present invention in a filamentous fungal host cell are promoters obtained from the genes for Aspergillus nidulans acetamidase, Aspergillus niger neutral alpha-amylase, Aspergillus niger acid stable alpha-amylase, Aspergillus niger or Aspergillus awamori glucoamylase (glaA), Aspergillus oryzae TAKA amylase, Aspergillus oryzae alkaline protease, Aspergillus oryzae triose phosphate isomerase, Fusarium oxysporum trypsin-like protease (WO 96/00787), Fusarium venenatum amyloglucosidase (WO 00/56900), Fusarium venenatum Daria (WO 00/56900), Fusarium venenatum Quinn (WO 00/56900), Rhizomucor miehei lipase, Rhizomucor miehei aspartic proteinase, Trichoderma reesei beta-glucosidase, Trichoderma reesei cellobiohydrolase I, Trichoderma reesei cellobiohydrolase II, Trichoderma reesei endoglucanase I, Trichoderma reesei endoglucanase II, Trichoderma reesei endoglucanase III, Trichoderma reesei endoglucanase IV, Trichoderma reesei endoglucanase V, Trichoderma reesei xylanase I, Trichoderma reesei xylanase II, Trichoderma reesei beta-xylosidase, as well as the NA2-tpi promoter (a modified promoter from an Aspergillus neutral alpha-amylase gene in which the untranslated leader has been replaced by an untranslated leader from an Aspergillus triose phosphate isomerase gene; non-limiting examples include modified promoters from an Aspergillus niger neutral alpha-amylase gene in which the untranslated leader has been replaced by an untranslated leader from an Aspergillus nidulans or Aspergillus oryzae triose phosphate isomerase gene); and mutant, truncated, and hybrid promoters thereof.

In a yeast host, useful promoters are obtained from the genes for Saccharomyces cerevisiae enolase (ENO-1), Saccharomyces cerevisiae galactokinase (GAL1), Saccharomyces cerevisiae alcohol dehydrogenase/glyceraldehyde-3-phosphate dehydrogenase (ADH1, ADH2/GAP), Saccharomyces cerevisiae triose phosphate isomerase (TPI), Saccharomyces cerevisiae metallothionein (CUP1), and Saccharomyces cerevisiae 3-phosphoglycerate kinase. Other useful promoters for yeast host cells are described by Romanos et al., 1992, Yeast 8: 423-488.

The control sequence may also be a transcription terminator, which is recognized by a host cell to terminate transcription. The terminator is operably linked to the 3′-terminus of the polynucleotide encoding the polypeptide. Any terminator that is functional in the host cell may be used in the present invention.

Preferred terminators for bacterial host cells are obtained from the genes for Bacillus clausii alkaline protease (aprH), Bacillus licheniformis alpha-amylase (amyL), and Escherichia coli ribosomal RNA (rrnB).

Preferred terminators for filamentous fungal host cells are obtained from the genes for Aspergillus nidulans anthranilate synthase, Aspergillus niger glucoamylase, Aspergillus niger alpha-glucosidase, Aspergillus oryzae TAKA amylase, and Fusarium oxysporum trypsin-like protease.

Preferred terminators for yeast host cells are obtained from the genes for Saccharomyces cerevisiae enolase, Saccharomyces cerevisiae cytochrome C (CYC1), and Saccharomyces cerevisiae glyceraldehyde-3-phosphate dehydrogenase. Other useful terminators for yeast host cells are described by Romanos et al., 1992, supra.

The control sequence may also be an mRNA stabilizer region downstream of a promoter and upstream of the coding sequence of a gene which increases expression of the gene. Examples of suitable mRNA stabilizer regions are obtained from a Bacillus thuringiensis cryIIIA gene (WO 94/25612) and a Bacillus subtilis SP82 gene (Hue et al., 1995, Journal of Bacteriology 177: 3465-3471).

The control sequence may also be a leader, a nontranslated region of an mRNA that is important for translation by the host cell. The leader is operably linked to the 5′-terminus of the polynucleotide encoding the polypeptide. Any leader that is functional in the host cell may be used.

Preferred leaders for filamentous fungal host cells are obtained from the genes for Aspergillus oryzae TAKA amylase and Aspergillus nidulans triose phosphate isomerase.

Suitable leaders for yeast host cells are obtained from the genes for Saccharomyces cerevisiae enolase (ENO-1), Saccharomyces cerevisiae 3-phosphoglycerate kinase, Saccharomyces cerevisiae alpha-factor, and Saccharomyces cerevisiae alcohol dehydrogenase/glyceraldehyde-3-phosphate dehydrogenase (ADH2/GAP).

The control sequence may also be a polyadenylation sequence, a sequence operably linked to the 3′-terminus of the polynucleotide and, when transcribed, is recognized by the host cell as a signal to add polyadenosine residues to transcribed mRNA. Any polyadenylation sequence that is functional in the host cell may be used.

Preferred polyadenylation sequences for filamentous fungal host cells are obtained from the genes for Aspergillus nidulans anthranilate synthase, Aspergillus niger glucoamylase, Aspergillus niger alpha-glucosidase Aspergillus oryzae TAKA amylase, and Fusarium oxysporum trypsin-like protease.

Useful polyadenylation sequences for yeast host cells are described by Guo and Sherman, 1995, Mol. Cellular Biol. 15: 5983-5990.

The control sequence may also be a signal peptide coding region that encodes a signal peptide linked to the N-terminus of a polypeptide and directs the polypeptide into the cell's secretory pathway. The 5′-end of the coding sequence of the polynucleotide may inherently contain a signal peptide coding sequence naturally linked in translation reading frame with the segment of the coding sequence that encodes the polypeptide. Alternatively, the 5′-end of the coding sequence may contain a signal peptide coding sequence that is foreign to the coding sequence. A foreign signal peptide coding sequence may be required where the coding sequence does not naturally contain a signal peptide coding sequence. Alternatively, a foreign signal peptide coding sequence may simply replace the natural signal peptide coding sequence in order to enhance secretion of the polypeptide. However, any signal peptide coding sequence that directs the expressed polypeptide into the secretory pathway of a host cell may be used.

Effective signal peptide coding sequences for bacterial host cells are the signal peptide coding sequences obtained from the genes for Bacillus NCIB 11837 maltogenic amylase, Bacillus licheniformis subtilisin, Bacillus licheniformis beta-lactamase, Bacillus stearothermophilus alpha-amylase, Bacillus stearothermophilus neutral proteases (nprT, nprS, nprM), and Bacillus subtilis prsA. Further signal peptides are described by Simonen and Palva, (1993), Microbiological Reviews 57: 109-137.

Effective signal peptide coding sequences for filamentous fungal host cells are the signal peptide coding sequences obtained from the genes for Aspergillus niger neutral amylase, Aspergillus niger glucoamylase, Aspergillus oryzae TAKA amylase, Humicola insolens cellulase, Humicola insolens endoglucanase V, Humicola lanuginosa lipase, and Rhizomucor miehei aspartic proteinase.

Useful signal peptides for yeast host cells are obtained from the genes for Saccharomyces cerevisiae alpha-factor and Saccharomyces cerevisiae invertase. Other useful signal peptide coding sequences are described by Romanos et al., 1992, supra.

The control sequence may also be a propeptide coding sequence that encodes a propeptide positioned at the N-terminus of a polypeptide. The resultant polypeptide is known as a proenzyme or propolypeptide (or a zymogen in some cases). A propolypeptide is generally inactive and can be converted to an active polypeptide by catalytic or autocatalytic cleavage of the propeptide from the propolypeptide. The propeptide coding sequence may be obtained from the genes for Bacillus subtilis alkaline protease (aprE), Bacillus subtilis neutral protease (nprT), Myceliophthora thermophila laccase (WO 95/33836), Rhizomucor miehei aspartic proteinase, and Saccharomyces cerevisiae alpha-factor.

Where both signal peptide and propeptide sequences are present, the propeptide sequence is positioned next to the N-terminus of a polypeptide and the signal peptide sequence is positioned next to the N-terminus of the propeptide sequence.

It may also be desirable to add regulatory sequences that regulate expression of the polypeptide relative to the growth of the host cell. Examples of regulatory systems are those that cause expression of the gene to be turned on or off in response to a chemical or physical stimulus, including the presence of a regulatory compound. Regulatory systems in prokaryotic systems include the lac, tac, and trp operator systems. In yeast, the ADH2 system or GAL1 system may be used. In filamentous fungi, the Aspergillus niger glucoamylase promoter, Aspergillus oryzae TAKA alpha-amylase promoter, and Aspergillus oryzae glucoamylase promoter may be used. Other examples of regulatory sequences are those that allow for gene amplification. In eukaryotic systems, these regulatory sequences include the dihydrofolate reductase gene that is amplified in the presence of methotrexate, and the metallothionein genes that are amplified with heavy metals. In these cases, the polynucleotide encoding the polypeptide would be operably linked with the regulatory sequence.

### Expression Vectors

The present invention also relates to recombinant expression vectors comprising a polynucleotide of the present invention, a promoter, and transcriptional and translational stop signals. The various nucleotide and control sequences may be joined together to produce a recombinant expression vector that may include one or more convenient restriction sites to allow for insertion or substitution of the polynucleotide encoding the polypeptide at such sites. Alternatively, the polynucleotide may be expressed by inserting the polynucleotide or a nucleic acid construct comprising the polynucleotide into an appropriate vector for expression. In creating the expression vector, the coding sequence is located in the vector so that the coding sequence is operably linked with the appropriate control sequences for expression.

The recombinant expression vector may be any vector (e.g., a plasmid or virus) that can be conveniently subjected to recombinant DNA procedures and can bring about expression of the polynucleotide. The choice of the vector will typically depend on the compatibility of the vector with the host cell into which the vector is to be introduced. The vector may be a linear or closed circular plasmid.

The vector may be an autonomously replicating vector, i.e., a vector that exists as an extrachromosomal entity, the replication of which is independent of chromosomal replication, e.g., a plasmid, an extrachromosomal element, a minichromosome, or an artificial chromosome. The vector may contain any means for assuring self-replication. Alternatively, the vector may be one that, when introduced into the host cell, is integrated into the genome and replicated together with the chromosome(s) into which it has been integrated. Furthermore, a single vector or plasmid or two or more vectors or plasmids that together contain the total DNA to be introduced into the genome of the host cell, or a transposon, may be used.

The vector preferably contains one or more selectable markers that permit easy selection of transformed, transfected, transduced, or the like cells. A selectable marker is a gene the product of which provides for biocide or viral resistance, resistance to heavy metals, prototrophy to auxotrophs, and the like.

Examples of bacterial selectable markers are Bacillus licheniformis or Bacillus subtilis dal genes, or markers that confer antibiotic resistance such as ampicillin, chloramphenicol, kanamycin, neomycin, spectinomycin, or tetracycline resistance. Suitable markers for yeast host cells include, but are not limited to, ADE2, HIS3, LEU2, LYS2, MET3, TRP1, and URA3. Selectable markers for use in a filamentous fungal host cell include, but are not limited to, amdS (acetamidase), argB (ornithine carbamoyltransferase), bar (phosphinothricin acetyltransferase), hph (hygromycin phosphotransferase), niaD (nitrate reductase), pyrG (orotidine-5′-phosphate decarboxylase), sC (sulfate adenyltransferase), and trpC (anthranilate synthase), as well as equivalents thereof. Preferred for use in an Aspergillus cell are Aspergillus nidulans or Aspergillus oryzae amdS and pyrG genes and a Streptomyces hygroscopicus bar gene.

The vector preferably contains an element(s) that permits integration of the vector into the host cell's genome or autonomous replication of the vector in the cell independent of the genome.

For integration into the host cell genome, the vector may rely on the polynucleotide's sequence encoding the polypeptide or any other element of the vector for integration into the genome by homologous or non-homologous recombination. Alternatively, the vector may contain additional polynucleotides for directing integration by homologous recombination into the genome of the host cell at a precise location(s) in the chromosome(s). To increase the likelihood of integration at a precise location, the integrational elements should contain a sufficient number of nucleic acids, such as 100 to 10,000 base pairs, 400 to 10,000 base pairs, and 800 to 10,000 base pairs, which have a high degree of sequence identity to the corresponding target sequence to enhance the probability of homologous recombination. The integrational elements may be any sequence that is homologous with the target sequence in the genome of the host cell. Furthermore, the integrational elements may be non-encoding or encoding polynucleotides. On the other hand, the vector may be integrated into the genome of the host cell by non-homologous recombination.

For autonomous replication, the vector may further comprise an origin of replication enabling the vector to replicate autonomously in the host cell in question. The origin of replication may be any plasmid replicator mediating autonomous replication that functions in a cell. The term “origin of replication” or “plasmid replicator” means a polynucleotide that enables a plasmid or vector to replicate in vivo.

Examples of bacterial origins of replication are the origins of replication of plasmids pBR322, pUC19, pACYC177, and pACYC184 permitting replication in E. coli, and pUB110, pE194, pTA1060, and pAMR1 permitting replication in Bacillus.

Examples of origins of replication for use in a yeast host cell are the 2 micron origin of replication, ARS1, ARS4, the combination of ARS1 and CEN3, and the combination of ARS4 and CEN6.

Examples of origins of replication useful in a filamentous fungal cell are AMA1 and ANSI (Gems et al., 1991, Gene 98: 61-67; Cullen et al., 1987, Nucleic Acids Res. 15: 9163-9175; WO 00/24883). Isolation of the AMA1 gene and construction of plasmids or vectors comprising the gene can be accomplished according to the methods disclosed in WO 00/24883.

More than one copy of a polynucleotide of the present invention may be inserted into a host cell to increase production of a polypeptide. An increase in the copy number of the polynucleotide can be obtained by integrating at least one additional copy of the sequence into the host cell genome or by including an amplifiable selectable marker gene with the polynucleotide where cells containing amplified copies of the selectable marker gene, and thereby additional copies of the polynucleotide, can be selected for by cultivating the cells in the presence of the appropriate selectable agent.

The procedures used to ligate the elements described above to construct the recombinant expression vectors of the present invention are well known to one skilled in the art (see, e.g., Sambrook et al., 1989, supra).

### Host Cells

The present invention also relates to recombinant host cells, comprising a polynucleotide of the present invention operably linked to one or more control sequences that direct the production of a polypeptide of the present invention. A construct or vector comprising a polynucleotide is introduced into a host cell so that the construct or vector is maintained as a chromosomal integrant or as a self-replicating extra-chromosomal vector as described earlier. The term “host cell” encompasses any progeny of a parent cell that is not identical to the parent cell due to mutations that occur during replication. The choice of a host cell will to a large extent depend upon the gene encoding the polypeptide and its source.

The host cell may be any cell useful in the recombinant production of a polypeptide of the present invention, e.g., a prokaryote or a eukaryote.

The prokaryotic host cell may be any Gram-positive or Gram-negative bacterium. Gram-positive bacteria include, but are not limited to, Bacillus, Clostridium, Enterococcus, Geobacillus, Lactobacillus, Lactococcus, Oceanobacillus, Staphylococcus, Streptococcus, and Streptomyces. Gram-negative bacteria include, but are not limited to, Campylobacter, E. coli, Flavobacterium, Fusobacterium, Helicobacter, Ilyobacter, Neisseria, Pseudomonas, Salmonella, and Ureaplasma.

The bacterial host cell may be any Bacillus cell including, but not limited to, Bacillus alkalophilus, Bacillus amyloliquefaciens, Bacillus brevis, Bacillus circulans, Bacillus clausii, Bacillus coagulans, Bacillus firmus, Bacillus lautus, Bacillus lentus, Bacillus licheniformis, Bacillus megaterium, Bacillus pumilus, Bacillus stearothermophilus, Bacillus subtilis, and Bacillus thuringiensis cells.

The bacterial host cell may also be any Streptococcus cell including, but not limited to, Streptococcus equisimilis, Streptococcus pyogenes, Streptococcus uberis, and Streptococcus equi subsp. Zooepidemicus cells.

The bacterial host cell may also be any Streptomyces cell including, but not limited to, Streptomyces achromogenes, Streptomyces avermitilis, Streptomyces coelicolor, Streptomyces griseus, and Streptomyces lividans cells.

The introduction of DNA into a Bacillus cell may be effected by protoplast transformation (see, e.g., Chang and Cohen, 1979, Mol. Gen. Genet. 168: 111-115), competent cell transformation (see, e.g., Young and Spizizen, 1961, J. Bacteriol. 81: 823-829, or Dubnau and Davidoff-Abelson, 1971, J. Mol. Biol. 56: 209-221), electroporation (see, e.g., Shigekawa and Dower, 1988, Biotechniques 6: 742-751), or conjugation (see, e.g., Koehler and Thorne, 1987, J. Bacteriol. 169: 5271-5278). The introduction of DNA into an E. coli cell may be effected by protoplast transformation (see, e.g., Hanahan, 1983, J. Mol. Biol. 166: 557-580) or electroporation (see, e.g., Dower et al., 1988, Nucleic Acids Res. 16: 6127-6145). The introduction of DNA into a Streptomyces cell may be effected by protoplast transformation, electroporation (see, e.g., Gong et al., 2004, Folia Microbiol. (Praha) 49: 399-405), conjugation (see, e.g., Mazodier et al., 1989, J. Bacteriol. 171: 3583-3585), or transduction (see, e.g., Burke et al., 2001, Proc. Natl. Acad. Sci. USA 98: 6289-6294). The introduction of DNA into a Pseudomonas cell may be effected by electroporation (see, e.g., Choi et al., 2006, J. Microbiol. Methods 64: 391-397) or conjugation (see, e.g., Pinedo and Smets, 2005, Appl. Environ. Microbiol. 71: 51-57). The introduction of DNA into a Streptococcus cell may be effected by natural competence (see, e.g., Perry and Kuramitsu, 1981, Infect. Immun. 32: 1295-1297), protoplast transformation (see, e.g., Catt and Jollick, 1991, Microbios 68: 189-207), electroporation (see, e.g., Buckley et al., 1999, Appl. Environ. Microbiol. 65: 3800-3804), or conjugation (see, e.g., Clewell, 1981, Microbiol. Rev. 45: 409-436). However, any method known in the art for introducing DNA into a host cell can be used.

The host cell may also be a eukaryote, such as a mammalian, insect, plant, or fungal cell.

The host cell may be a fungal cell. “Fungi” as used herein includes the phyla Ascomycota, Basidiomycota, Chytridiomycota, and Zygomycota as well as the Oomycota and all mitosporic fungi (as defined by Hawksworth et al., In, Ainsworth and Bisby's Dictionary of The Fungi, 8th edition, 1995, CAB International, University Press, Cambridge, UK).

The fungal host cell may be a yeast cell. “Yeast” as used herein includes ascosporogenous yeast (Endomycetales), basidiosporogenous yeast, and yeast belonging to the Fungi Imperfecti (Blastomycetes). Since the classification of yeast may change in the future, for the purposes of this invention, yeast shall be defined as described in Biology and Activities of Yeast (Skinner, Passmore, and Davenport, editors, Soc. App. Bacteriol. Symposium Series No. 9, 1980).

The yeast host cell may be a Candida, Hansenula, Kluyveromyces, Pichia, Saccharomyces, Schizosaccharomyces, or Yarrowia cell, such as a Kluyveromyces lactis, Saccharomyces carlsbergensis, Saccharomyces cerevisiae, Saccharomyces diastaticus, Saccharomyces douglasii, Saccharomyces kluyveri, Saccharomyces norbensis, Saccharomyces oviformis, or Yarrowia lipolytica cell.

The fungal host cell may be a filamentous fungal cell. “Filamentous fungi” include all filamentous forms of the subdivision Eumycota and Oomycota (as defined by Hawksworth et al., 1995, supra). The filamentous fungi are generally characterized by a mycelial wall composed of chitin, cellulose, glucan, chitosan, mannan, and other complex polysaccharides. Vegetative growth is by hyphal elongation and carbon catabolism is obligately aerobic. In contrast, vegetative growth by yeasts such as Saccharomyces cerevisiae is by budding of a unicellular thallus and carbon catabolism may be fermentative.

The filamentous fungal host cell may be an Acremonium, Aspergillus, Aureobasidium, Bjerkandera, Ceriporiopsis, Chrysosporium, Coprinus, Coriolus, Cryptococcus, Filibasidium, Fusarium, Humicola, Magnaporthe, Mucor, Myceliophthora, Neocallimastix, Neurospora, Paecilomyces, Penicillium, Phanerochaete, Phlebia, Piromyces, Pleurotus, Schizophyllum, Talaromyces, Thermoascus, Thielavia, Tolypocladium, Trametes, or Trichoderma cell.

For example, the filamentous fungal host cell may be an Aspergillus awamori, Aspergillus foetidus, Aspergillus fumigatus, Aspergillus japonicus, Aspergillus nidulans, Aspergillus niger, Aspergillus oryzae, Bjerkandera adusta, Ceriporiopsis aneirina, Ceriporiopsis caregiea, Ceriporiopsis gilvescens, Ceriporiopsis pannocinta, Ceriporiopsis rivulosa, Ceriporiopsis subrufa, Ceriporiopsis subvermispora, Chrysosporium inops, Chrysosporium keratinophilum, Chrysosporium lucknowense, Chrysosporium merdarium, Chrysosporium pannicola, Chrysosporium queenslandicum, Chrysosporium tropicum, Chrysosporium zonatum, Coprinus cinereus, Coriolus hirsutus, Fusarium bactridioides, Fusarium cerealis, Fusarium crookwellense, Fusarium culmorum, Fusarium graminearum, Fusarium graminum, Fusarium heterosporum, Fusarium negundi, Fusarium oxysporum, Fusarium reticulatum, Fusarium roseum, Fusarium sambucinum, Fusarium sarcochroum, Fusarium sporotrichioides, Fusarium sulphureum, Fusarium torulosum, Fusarium trichothecioides, Fusarium venenatum, Humicola insolens, Humicola lanuginosa, Mucor miehei, Myceliophthora thermophila, Neurospora crassa, Penicillium purpurogenum, Phanerochaete chrysosporium, Phlebia radiata, Pleurotus eryngii, Thielavia terrestris, Trametes villosa, Trametes versicolor, Trichoderma harzianum, Trichoderma koningii, Trichoderma longibrachiatum, Trichoderma reesei, or Trichoderma viride cell.

Fungal cells may be transformed by a process involving protoplast formation, transformation of the protoplasts, and regeneration of the cell wall in a manner known per se. Suitable procedures for transformation of Aspergillus and Trichoderma host cells are described in EP 238023, Yelton et al., 1984, Proc. Natl. Acad. Sci. USA 81: 1470-1474, and Christensen et al., 1988, Bio/Technology 6: 1419-1422. Suitable methods for transforming Fusarium species are described by Malardier et al., 1989, Gene 78: 147-156, and WO 96/00787. Yeast may be transformed using the procedures described by Becker and Guarente, In Abelson, J. N. and Simon, M. I., editors, Guide to Yeast Genetics and Molecular Biology, Methods in Enzymology, Volume 194, pp 182-187, Academic Press, Inc., New York; Ito et al., 1983, J. Bacteriol. 153: 163; and Hinnen et al., 1978, Proc. Natl. Acad. Sci. USA 75: 1920.

### Methods of Production

The present invention also relates to methods of producing a polypeptide of the present invention, comprising (a) cultivating a cell, which in its wild-type form produces the polypeptide, under conditions conducive for production of the polypeptide; and (b) recovering the polypeptide. In a preferred aspect, the cell is a Paenibacillus cell, or a Microbacterium cell.

The present invention also relates to methods of producing a polypeptide of the present invention, comprising (a) cultivating a recombinant host cell of the present invention under conditions conducive for production of the polypeptide; and (b) recovering the polypeptide.

The host cells are cultivated in a nutrient medium suitable for production of the polypeptide using methods known in the art. For example, the cell may be cultivated by shake flask cultivation, or small-scale or large-scale fermentation (including continuous, batch, fed-batch, or solid state fermentations) in laboratory or industrial fermentors performed in a suitable medium and under conditions allowing the polypeptide to be expressed and/or isolated. The cultivation takes place in a suitable nutrient medium comprising carbon and nitrogen sources and inorganic salts, using procedures known in the art. Suitable media are available from commercial suppliers or may be prepared according to published compositions (e.g., in catalogues of the American Type Culture Collection). If the polypeptide is secreted into the nutrient medium, the polypeptide can be recovered directly from the medium. If the polypeptide is not secreted, it can be recovered from cell lysates.

The polypeptide may be detected using methods known in the art that are specific for the polypeptides such as methods for determining cellulose activity. These detection methods include, but are not limited to, use of specific antibodies, formation of an enzyme product, or disappearance of an enzyme substrate. For example, an enzyme assay may be used to determine the activity of the polypeptide.

The polypeptide may be recovered using methods known in the art. For example, the polypeptide may be recovered from the nutrient medium by conventional procedures including, but not limited to, collection, centrifugation, filtration, extraction, spray-drying, evaporation, or precipitation.

The polypeptide may be purified by a variety of procedures known in the art including, but not limited to, chromatography (e.g., ion exchange, affinity, hydrophobic, chromatofocusing, and size exclusion), electrophoretic procedures (e.g., preparative isoelectric focusing), differential solubility (e.g., ammonium sulfate precipitation), SDS-PAGE, or extraction (see, e.g., Protein Purification, Janson and Ryden, editors, VCH Publishers, New York, 1989) to obtain substantially pure polypeptides.

In an alternative aspect, the polypeptide is not recovered, but rather a host cell of the present invention expressing the polypeptide is used as a source of the polypeptide.

### Detergent Compositions

In one embodiment, the invention is directed to detergent compositions comprising a xanthan lyase of the present invention in combination with one or more additional detergent components. The choice of detergent components is within the skill of the artisan and includes conventional ingredients, including the exemplary non-limiting components set forth below. In an embodiment, the detergent composition comprises a xanthan lyase of the present invention, a GH9 endoglucanase of the present invention in combination with one or more detergent components.

The choice of components may include, for textile care, the consideration of the type of textile to be cleaned, the type and/or degree of soiling, the temperature at which cleaning is to take place, and the formulation of the detergent product. Although the components mentioned below are categorized according to a particular function, this should not be construed as a limitation since the component may have one or more additional functionalities which the skilled artisan will appreciate.

The detergent composition may be suitable for the laundring of textiles such as e.g. fabrics, cloths or linen, or for cleaning hard surfaces such as e.g. floors, tables, or dish wash.

The present invention also relates to the use of polypeptides having an enzyme detergency benefit in cleaning or detergent applications and their use of thereof in processes such as cleaning hard surfaces and laundry.

### Detergent Compositions of the Present Invention

In one embodiment of the present invention, the a polypeptide of the present invention may be added to a detergent composition in an amount corresponding to 0.0001-200 mg of enzyme protein, such as 0.0005-100 mg of enzyme protein, preferably 0.001-30 mg of enzyme protein, more preferably 0.005-8 mg of enzyme protein, even more preferably 0.01-2 mg of enzyme protein per litre of wash liquor.

A composition for use in automatic dishwash (ADW), for example, may include 0.0001%-50%, such as 0.001%-20%, such as 0.01%-10%, such as 0.05-5% of enzyme protein by weight of the composition.

A composition for use in laundry granulation, for example, may include 0.0001%-50%, such as 0.001%-20%, such as 0.01%-10%, such as 0.05%-5% of enzyme protein by weight of the composition.

A composition for use in laundry liquid, for example, may include 0.0001%-10%, such as 0.001-7%, such as 0.1%-5% of enzyme protein by weight of the composition.

The enzyme(s) of the detergent composition of the invention may be stabilized using conventional stabilizing agents, e.g., a polyol such as propylene glycol or glycerol, a sugar or sugar alcohol, lactic acid, boric acid, or a boric acid derivative, e.g., an aromatic borate ester, or a phenyl boronic acid derivative such as 4-formylphenyl boronic acid, and the composition may be formulated as described in, for example, WO92/19709 and WO92/19708.

In certain markets different wash conditions and, as such, different types of detergents are used. This is disclosed in e.g. EP 1 025 240. For example, In Asia (Japan) a low detergent concentration system is used, while the United States uses a medium detergent concentration system, and Europe uses a high detergent concentration system.

A low detergent concentration system includes detergents where less than about 800 ppm of detergent components are present in the wash water. Japanese detergents are typically considered low detergent concentration system as they have approximately 667 ppm of detergent components present in the wash water.

A medium detergent concentration includes detergents where between about 800 ppm and about 2000 ppm of detergent components are present in the wash water. North American detergents are generally considered to be medium detergent concentration systems as they have approximately 975 ppm of detergent components present in the wash water.

A high detergent concentration system includes detergents where greater than about 2000 ppm of detergent components are present in the wash water. European detergents are generally considered to be high detergent concentration systems as they have approximately 4500-5000 ppm of detergent components in the wash water.

Latin American detergents are generally high suds phosphate builder detergents and the range of detergents used in Latin America can fall in both the medium and high detergent concentrations as they range from 1500 ppm to 6000 ppm of detergent components in the wash water. Such detergent compositions are all embodiments of the invention.

A polypeptide of the present invention may also be incorporated in the detergent formulations disclosed in WO97/07202, which is hereby incorporated by reference.

### Surfactants

The detergent composition may comprise one or more surfactants, which may be anionic and/or cationic and/or non-ionic and/or semi-polar and/or zwitterionic, or a mixture thereof. In a particular embodiment, the detergent composition includes a mixture of one or more nonionic surfactants and one or more anionic surfactants. The surfactant(s) is typically present at a level of from about 0.1% to 60% by weight, such as about 1% to about 40%, or about 3% to about 20%, or about 3% to about 10%. The surfactant(s) is chosen based on the desired cleaning application, and includes any conventional surfactant(s) known in the art. Any surfactant known in the art for use in detergents may be utilized.

When included therein the detergent will usually contain from about 1% to about 40% by weight, such as from about 5% to about 30%, including from about 5% to about 15%, or from about 20% to about 25% of an anionic surfactant. Non-limiting examples of anionic surfactants include sulfates and sulfonates, in particular, linear alkylbenzenesulfonates (LAS), isomers of LAS, branched alkylbenzenesulfonates (BABS), phenylalkanesulfonates, alpha-olefinsulfonates (AOS), olefin sulfonates, alkene sulfonates, alkane-2,3-diylbis(sulfates), hydroxyl-alkanesulfonates and disulfonates, alkyl sulfates (AS) such as sodium dodecyl sulfate (SDS), fatty alcohol sulfates (FAS), primary alcohol sulfates (PAS), alcohol ethersulfates (AES or AEOS or FES, also known as alcohol ethoxysulfates or fatty alcohol ether sulfates), secondary alkanesulfonates (SAS), paraffin sulfonates (PS), ester sulfonates, sulfonated fatty acid glycerol esters, alpha-sulfo fatty acid methyl esters (alpha-SFMe or SES) including methyl ester sulfonate (MES), alkyl- or alkenylsuccinic acid, dodecenyl/tetradecenyl succinic acid (DTSA), fatty acid derivatives of amino acids, diesters and monoesters of sulfo-succinic acid or soap, and combinations thereof.

When included therein the detergent will usually contain from about 0% to about 10% by weight of a cationic surfactant. Non-limiting examples of cationic surfactants include alkly-dimethylethanolamine quat (ADMEAQ), cetyltrimethylammonium bromide (CTAB), dimethyldistearylammonium chloride (DSDMAC), and alkylbenzyldimethylammonium, alkyl quaternary ammonium compounds, alkoxylated quaternary ammonium (AQA) compounds, and combinations thereof.

When included therein the detergent will usually contain from about 0.2% to about 40% by weight of a non-ionic surfactant, for example from about 0.5% to about 30%, in particular from about 1% to about 20%, from about 3% to about 10%, such as from about 3% to about 5%, or from about 8% to about 12%. Non-limiting examples of non-ionic surfactants include alcohol ethoxylates (AE or AEO), alcohol propoxylates, propoxylated fatty alcohols (PFA), alkoxylated fatty acid alkyl esters, such as ethoxylated and/or propoxylated fatty acid alkyl esters, alkylphenol ethoxylates (APE), nonylphenol ethoxylates (NPE), alkylpolyglycosides (APG), alkoxylated amines, fatty acid monoethanolamides (FAM), fatty acid diethanolamides (FADA), ethoxylated fatty acid monoethanolamides (EFAM), propoxylated fatty acid monoethanolamides (PFAM), polyhydroxy alkyl fatty acid amides, or N-acyl N-alkyl derivatives of glucosamine (glucamides, GA, or fatty acid glucamide, FAGA), as well as products available under the trade names SPAN and TWEEN, and combinations thereof.

When included therein the detergent will usually contain from about 0% to about 10% by weight of a semipolar surfactant. Non-limiting examples of semipolar surfactants include amine oxides (AO) such as alkyldimethylamineoxide, N-(coco alkyl)-N,N-dimethylamine oxide and N-(tallow-alkyl)-N,N-bis(2-hydroxyethyl)amine oxide, fatty acid alkanolamides and ethoxylated fatty acid alkanolamides, and combinations thereof.

When included therein the detergent will usually contain from about 0% to about 10% by weight of a zwitterionic surfactant. Non-limiting examples of zwitterionic surfactants include betaine, alkyldimethylbetaine, sulfobetaine, and combinations thereof.

### Hydrotropes

A hydrotrope is a compound that solubilises hydrophobic compounds in aqueous solutions (or oppositely, polar substances in a non-polar environment). Typically, hydrotropes have both hydrophilic and a hydrophobic character (so-called amphiphilic properties as known from surfactants); however the molecular structure of hydrotropes generally do not favor spontaneous self-aggregation, see e.g. review by Hodgdon and Kaler (2007), Current Opinion in Colloid & Interface Science 12: 121-128. Hydrotropes do not display a critical concentration above which self-aggregation occurs as found for surfactants and lipids forming miceller, lamellar or other well defined meso-phases. Instead, many hydrotropes show a continuous-type aggregation process where the sizes of aggregates grow as concentration increases. However, many hydrotropes alter the phase behavior, stability, and colloidal properties of systems containing substances of polar and non-polar character, including mixtures of water, oil, surfactants, and polymers. Hydrotropes are classically used across industries from pharma, personal care, food, to technical applications. Use of hydrotropes in detergent compositions allow for example more concentrated formulations of surfactants (as in the process of compacting liquid detergents by removing water) without inducing undesired phenomena such as phase separation or high viscosity.

The detergent may contain 0-5% by weight, such as about 0.5 to about 5%, or about 3% to about 5%, of a hydrotrope. Any hydrotrope known in the art for use in detergents may be utilized. Non-limiting examples of hydrotropes include sodium benzene sulfonate, sodium p-toluene sulfonate (STS), sodium xylene sulfonate (SXS), sodium cumene sulfonate (SCS), sodium cymene sulfonate, amine oxides, alcohols and polyglycolethers, sodium hydroxynaphthoate, sodium hydroxynaphthalene sulfonate, sodium ethylhexyl sulfate, and combinations thereof.

### Builders and Co-Builders

The detergent composition may contain about 0-65% by weight, such as about 5% to about 45% of a detergent builder or co-builder, or a mixture thereof. In a dish wash detergent, the level of builder is typically 40-65%, particularly 50-65%. The builder and/or co-builder may particularly be a chelating agent that forms water-soluble complexes with Ca and Mg. Any builder and/or co-builder known in the art for use in laundry detergents may be utilized. Non-limiting examples of builders include zeolites, diphosphates (pyrophosphates), triphosphates such as sodium triphosphate (STP or STPP), carbonates such as sodium carbonate, soluble silicates such as sodium metasilicate, layered silicates (e.g., SKS-6 from Hoechst), ethanolamines such as 2-aminoethan-1-ol (MEA), diethanolamine (DEA, also known as iminodiethanol), triethanolamine (TEA, also known as 2,2′,2″-nitrilotriethanol), and carboxymethyl inulin (CMI), and combinations thereof.

The detergent composition may also contain 0-20% by weight, such as about 5% to about 10%, of a detergent co-builder, or a mixture thereof. The detergent composition may include include a co-builder alone, or in combination with a builder, for example a zeolite builder. Non-limiting examples of co-builders include homopolymers of polyacrylates or copolymers thereof, such as poly(acrylic acid) (PAA) or copoly(acrylic acid/maleic acid) (PAA/PMA). Further non-limiting examples include citrate, chelators such as aminocarboxylates, aminopolycarboxylates and phosphonates, and alkyl- or alkenylsuccinic acid. Additional specific examples include 2,2′,2″-nitrilotriacetic acid (NTA), ethylenediaminetetraacetic acid (EDTA), diethylenetriaminepentaacetic acid (DTPA), iminodisuccinic acid (IDS), ethylenediamine-N,N′-disuccinic acid (EDDS), methylglycinediacetic acid (MGDA), glutamic acid-N,N-diacetic acid (GLDA), 1-hydroxyethane-1,1-diphosphonic acid (HEDP), ethylenediaminetetra-(methylenephosphonic acid) (EDTMPA), diethylenetriaminepentakis(methylenephosphonic acid) (DTPMPA or DTMPA), N-(2-hydroxyethyl)iminodiacetic acid (EDG), aspartic acid-N-monoacetic acid (ASMA), aspartic acid-N,N-diacetic acid (ASDA), aspartic acid-N-monopropionic acid (ASMP), iminodisuccinic acid (IDA), N-(2-sulfomethyl)-aspartic acid (SMAS), N-(2-sulfoethyl)-aspartic acid (SEAS), N-(2-sulfomethyl)-glutamic acid (SMGL), N-(2-sulfoethyl)-glutamic acid (SEGL), N-methyliminodiacetic acid (MIDA), α-alanine-N,N-diacetic acid (α-ALDA), serine-N,N-diacetic acid (SEDA), isoserine-N,N-diacetic acid (ISDA), phenylalanine-N,N-diacetic acid (PHDA), anthranilic acid-N,N-diacetic acid (ANDA), sulfanilic acid-N,N-diacetic acid (SLDA), taurine-N,N-diacetic acid (TUDA) and sulfomethyl-N,N-diacetic acid (SMDA), N-(2-hydroxyethyl)-ethylidenediamine-N,N,N′-triacetate (HEDTA), diethanolglycine (DEG), diethylenetriamine penta(methylenephosphonic acid) (DTPMP), aminotris(methylenephosphonic acid) (ATMP), and combinations and salts thereof. Further exemplary builders and/or co-builders are described in, e.g., WO 09/102854, U.S. Pat. No. 5,977,053

### Bleaching Systems

The detergent may contain 0-50% by weight, such as about 0.1% to about 25%, of a bleaching system. Any bleaching system known in the art for use in laundry detergents may be utilized. Suitable bleaching system components include bleaching catalysts, photobleaches, bleach activators, sources of hydrogen peroxide such as sodium percarbonate and sodium perborates, preformed peracids and mixtures thereof. Suitable preformed peracids include, but are not limited to, peroxycarboxylic acids and salts, percarbonic acids and salts, perimidic acids and salts, peroxymonosulfuric acids and salts, for example, Oxone (R), and mixtures thereof. Non-limiting examples of bleaching systems include peroxide-based bleaching systems, which may comprise, for example, an inorganic salt, including alkali metal salts such as sodium salts of perborate (usually mono- or tetra-hydrate), percarbonate, persulfate, perphosphate, persilicate salts, in combination with a peracid-forming bleach activator. The term bleach activator is meant herein as a compound which reacts with peroxygen bleach like hydrogen peroxide to form a peracid. The peracid thus formed constitutes the activated bleach. Suitable bleach activators to be used herein include those belonging to the class of esters amides, imides or anhydrides. Suitable examples are tetracetylethylene diamine (TAED), sodium 4-[(3,5,5-trimethylhexanoyl)oxy]benzene sulfonate (ISONOBS), diperoxy dodecanoic acid, 4-(dodecanoyloxy)benzenesulfonate (LOBS), 4-(decanoyloxy)benzenesulfonate, 4-(decanoyloxy)benzoate (DOBS), 4-(nonanoyloxy)-benzenesulfonate (NOBS), and/or those disclosed in WO98/17767. A particular family of bleach activators of interest was disclosed in EP624154 and particulary preferred in that family is acetyl triethyl citrate (ATC). ATC or a short chain triglyceride like triacetin has the advantage that it is environmental friendly as it eventually degrades into citric acid and alcohol. Furthermore acetyl triethyl citrate and triacetin has a good hydrolytical stability in the product upon storage and it is an efficient bleach activator. Finally ATC provides a good building capacity to the laundry additive. Alternatively, the bleaching system may comprise peroxyacids of, for example, the amide, imide, or sulfone type. The bleaching system may also comprise peracids such as 6-(phthalimido)peroxyhexanoic acid (PAP). The bleaching system may also include a bleach catalyst. In some embodiments the bleach component may be an organic catalyst selected from the group consisting of organic catalysts having the following formulae:

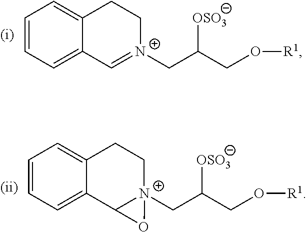

(iii) and mixtures thereof; wherein each R¹ is independently a branched alkyl group containing from 9 to 24 carbons or linear alkyl group containing from 11 to 24 carbons, preferably each R¹ is independently a branched alkyl group containing from 9 to 18 carbons or linear alkyl group containing from 11 to 18 carbons, more preferably each R¹ is independently selected from the group consisting of 2-propylheptyl, 2-butyloctyl, 2-pentylnonyl, 2-hexyldecyl, n-dodecyl, n-tetradecyl, n-hexadecyl, n-octadecyl, iso-nonyl, iso-decyl, iso-tridecyl and iso-pentadecyl. Other exemplary bleaching systems are described, e.g. in WO2007/087258, WO2007/087244, WO2007/087259 and WO2007/087242. Suitable photobleaches may for example be sulfonated zinc phthalocyanine

### Polymers

The detergent may contain 0-10% by weight, such as 0.5-5%, 2-5%, 0.5-2% or 0.2-1% of a polymer. Any polymer known in the art for use in detergents may be utilized. The polymer may function as a co-builder as mentioned above, or may provide antiredeposition, fiber protection, soil release, dye transfer inhibition, grease cleaning and/or anti-foaming properties. Some polymers may have more than one of the above-mentioned properties and/or more than one of the below-mentioned motifs. Exemplary polymers include (carboxymethyl)cellulose (CMC), poly(vinyl alcohol) (PVA), poly(vinylpyrrolidone) (PVP), poly(ethyleneglycol) or poly(ethylene oxide) (PEG), ethoxylated poly(ethyleneimine), carboxymethyl inulin (CMI), and polycarboxylates such as PAA, PAA/PMA, poly-aspartic acid, and lauryl methacrylate/acrylic acid copolymers, hydrophobically modified CMC (HM-CMC) and silicones, copolymers of terephthalic acid and oligomeric glycols, copolymers of poly(ethylene terephthalate) and poly(oxyethene terephthalate) (PET-POET), PVP, poly(vinylimidazole) (PVI), poly(vinylpyridine-N-oxide) (PVPO or PVPNO) and polyvinylpyrrolidone-vinylimidazole (PVPVI). Further exemplary polymers include sulfonated polycarboxylates, polyethylene oxide and polypropylene oxide (PEO-PPO) and diquaternium ethoxy sulfate. Other exemplary polymers are disclosed in, e.g., WO 2006/130575. Salts of the above-mentioned polymers are also contemplated.

### Fabric Hueing Agents

The detergent compositions of the present invention may also include fabric hueing agents such as dyes or pigments, which when formulated in detergent compositions can deposit onto a fabric when said fabric is contacted with a wash liquor comprising said detergent compositions and thus altering the tint of said fabric through absorption/reflection of visible light. Fluorescent whitening agents emit at least some visible light. In contrast, fabric hueing agents alter the tint of a surface as they absorb at least a portion of the visible light spectrum. Suitable fabric hueing agents include dyes and dye-clay conjugates, and may also include pigments. Suitable dyes include small molecule dyes and polymeric dyes. Suitable small molecule dyes include small molecule dyes selected from the group consisting of dyes falling into the Colour Index (C.I.) classifications of Direct Blue, Direct Red, Direct Violet, Acid Blue, Acid Red, Acid Violet, Basic Blue, Basic Violet and Basic Red, or mixtures thereof, for example as described in WO2005/03274, WO2005/03275, WO2005/03276 and EP1876226 (hereby incorporated by reference). The detergent composition preferably comprises from about 0.00003 wt % to about 0.2 wt %, from about 0.00008 wt % to about 0.05 wt %, or even from about 0.0001 wt % to about 0.04 wt % fabric hueing agent. The composition may comprise from 0.0001 wt % to 0.2 wt % fabric hueing agent, this may be especially preferred when the composition is in the form of a unit dose pouch. Suitable hueing agents are also disclosed in, e.g. WO 2007/087257 and WO2007/087243.

### Additional Enzymes

The detergent additive as well as the detergent composition may comprise one or more (additional) enzymes such as a protease, lipase, cutinase, an amylase, carbohydrase, cellulase, pectinase, mannanase, arabinase, galactanase, xylanase, oxidase, e.g., a laccase, and/or peroxidase.

In general, the properties of the selected enzyme(s) should be compatible with the selected detergent, (i.e., pH-optimum, compatibility with other enzymatic and non-enzymatic ingredients, etc.), and the enzyme(s) should be present in effective amounts.

### Cellulases

Suitable cellulases include those of bacterial or fungal origin. Chemically modified or protein engineered mutants are included. Suitable cellulases include cellulases from the genera Bacillus, Pseudomonas, Humicola, Fusarium, Thielavia, Acremonium, e.g., the fungal cellulases produced from Humicola insolens, Myceliophthora thermophila and Fusarium oxysporum disclosed in U.S. Pat. No. 4,435,307, U.S. Pat. No. 5,648,263, U.S. Pat. No. 5,691,178, U.S. Pat. No. 5,776,757 and WO 89/09259.

Especially suitable cellulases are the alkaline or neutral cellulases having color care benefits. Examples of such cellulases are cellulases described in EP 0 495 257, EP 0 531 372, WO 96/11262, WO 96/29397, WO 98/08940. Other examples are cellulase variants such as those described in WO 94/07998, EP 0 531 315, U.S. Pat. No. 5,457,046, U.S. Pat. No. 5,686,593, U.S. Pat. No. 5,763,254, WO 95/24471, WO 98/12307 and PCT/DK98/00299.

Example of cellulases exhibiting endo-beta-1,4-glucanase activity (EC 3.2.1.4) are those having described in WO02/099091.

Other examples of cellulases include the family 45 cellulases described in WO96/29397, and especially variants thereof having substitution, insertion and/or deletion at one or more of the positions corresponding to the following positions in SEQ ID NO: 8 of WO 02/099091: 2, 4, 7, 8, 10, 13, 15, 19, 20, 21, 25, 26, 29, 32, 33, 34, 35, 37, 40, 42, 42a, 43, 44, 48, 53, 54, 55, 58, 59, 63, 64, 65, 66, 67, 70, 72, 76, 79, 80, 82, 84, 86, 88, 90, 91, 93, 95, 95d, 95h, 95j, 97, 100, 101, 102, 103, 113, 114, 117, 119, 121, 133, 136, 137, 138, 139, 140a, 141, 143a, 145, 146, 147, 150e, 150j, 151, 152, 153, 154, 155, 156, 157, 158, 159, 160c, 160e, 160k, 161, 162, 164, 165, 168, 170, 171, 172, 173, 175, 176, 178, 181, 183, 184, 185, 186, 188, 191, 192, 195, 196, 200, and/or 20, preferably selected among P19A, G20K, Q44K, N48E, Q119H or Q146R. Commercially available cellulases include Celluzyme™, and Carezyme™ (Novozymes NS), Clazinase™, and Puradax HA™ (Genencor International Inc.), and KAC-500(B)™ (Kao Corporation).

### Proteases

Suitable proteases include those of bacterial, fungal, plant, viral or animal origin e.g. vegetable or microbial origin. Microbial origin is preferred. Chemically modified or protein engineered mutants are included. It may be an alkaline protease, such as a serine protease or a metalloprotease. A serine protease may for example be of the 51 family, such as trypsin, or the S8 family such as subtilisin. A metalloproteases protease may for example be a thermolysin from e.g. family M4 or other metalloprotease such as those from M5, M7 or M8 families.

The term “subtilases” refers to a sub-group of serine protease according to Siezen et al., Protein Engng. 4 (1991) 719-737 and Siezen et al. Protein Science 6 (1997) 501-523. Serine proteases are a subgroup of proteases characterized by having a serine in the active site, which forms a covalent adduct with the substrate. The subtilases may be divided into 6 sub-divisions, i.e. the Subtilisin family, the Thermitase family, the Proteinase K family, the Lantibiotic peptidase family, the Kexin family and the Pyrolysin family.

Examples of subtilases are those derived from Bacillus such as Bacillus lentus, B. alkalophilus, B. subtilis, B. amyloliquefaciens, Bacillus pumilus and Bacillus gibsonii described in; U.S. Pat. No. 7,262,042 and WO09/021867, and subtilisin lentus, subtilisin Novo, subtilisin Carlsberg, Bacillus licheniformis, subtilisin BPN′, subtilisin 309, subtilisin 147 and subtilisin 168 described in WO89/06279 and protease PD138 described in (WO93/18140). Other useful proteases may be those described in WO92/175177, WO01/016285, WO02/026024 and WO02/016547. Examples of trypsin-like proteases are trypsin (e.g. of porcine or bovine origin) and the Fusarium protease described in WO89/06270, WO94/25583 and WO05/040372, and the chymotrypsin proteases derived from Cellumonas described in WO05/052161 and WO05/052146.

A further preferred protease is the alkaline protease from Bacillus lentus DSM 5483, as described for example in WO95/23221, and variants thereof which are described in WO92/21760, WO95/23221, EP1921147 and EP1921148.

Examples of metalloproteases are the neutral metalloprotease as described in WO07/044993 (Genencor Int.) such as those derived from Bacillus amyloliquefaciens. Examples of useful proteases are the variants described in: WO92/19729, WO96/034946, WO98/20115, WO98/20116, WO99/011768, WO01/44452, WO03/006602, WO04/03186, WO04/041979, WO07/006305, WO11/036263, WO11/036264, especially the variants with substitutions in one or more of the following positions: 3, 4, 9, 15, 27, 36, 57, 68, 76, 87, 95, 96, 97, 98, 99, 100, 101, 102, 103, 104, 106, 118, 120, 123, 128, 129, 130, 160, 167, 170, 194, 195, 199, 205, 206, 217, 218, 222, 224, 232, 235, 236, 245, 248, 252 and 274 using the BPN′ numbering. More preferred the subtilase variants may comprise the mutations: S3T, V41, S9R, A15T, K27R, *36D, V68A, N76D, N87S,R, *97E, A98S, S99G,D,A, S99AD, S101G,M,R S103A, V1041,Y,N, S106A, G118V,R, H120D,N, N123S, S128L, P129Q, S130A, G160D, Y167A, R170S, A194P, G195E, V199M, V2051, L217D, N218D, M222S, A232V, K235L, Q236H, Q245R, N252K, T274A (using BPN′ numbering).

Suitable commercially available protease enzymes include those sold under the trade names Alcalase®, Duralase™, Durazym™, Relase®, Relase® Ultra, Savinase®, Savinase® Ultra, Primase®, Polarzyme®, Kannase®, Liquanase®, Liquanase® Ultra, Ovozyme®, Coronase®, Coronase® Ultra, Neutrase®, Everlase® and Esperase® (Novozymes NS), those sold under the tradename Maxatase®, Maxacal®, Maxapem®, Purafect®, Purafect Prime®, Preferenz™, Purafect MA®, Purafect Ox®, Purafect OxP™, Puramax®, Properase®, Effectenz™, FN2®, FN3®, FN4®, Excellase®, Opticlean® and Optimase® (Danisco/DuPont), Axapem™ (Gist-Brocases N.V.), BLAP (sequence shown in FIG. 29 of U.S. Pat. No. 5,352,604) and variants hereof (Henkel AG) and KAP (Bacillus alkalophilus subtilisin) from Kao.

### Lipases and Cutinases

Suitable lipases and cutinases include those of bacterial or fungal origin. Chemically modified or protein engineered mutant enzymes are included. Examples include lipase from Thermomyces, e.g. from T. lanuginosus (previously named Humicola lanuginosa) as described in EP258068 and EP305216, cutinase from Humicola, e.g. H. insolens (WO96/13580), lipase from strains of Pseudomonas (some of these now renamed to Burkholderia), e.g. P. alcaligenes or P. pseudoalcaligenes (EP218272), P. cepacia (EP331376), P. sp. strain SD705 (WO95/06720 & WO96/27002), P. wisconsinensis (WO96/12012), GDSL-type Streptomyces lipases (WO10/065455), cutinase from Magnaporthe grisea (WO10/107560), cutinase from Pseudomonas mendocina (U.S. Pat. No. 5,389,536), lipase from Thermobifida fusca (WO11/084412), Geobacillus stearothermophilus lipase (WO11/084417), lipase from Bacillus subtilis (WO11/084599), and lipase from Streptomyces griseus (WO11/150157) and S. pristinaespiralis (WO12/137147).

Other examples are lipase variants such as those described in EP407225, WO92/05249, WO94/01541, WO94/25578, WO95/14783, WO95/30744, WO95/35381, WO95/22615, WO96/00292, WO97/04079, WO97/07202, WO00/34450, WO00/60063, WO01/92502, WO07/87508 and WO09/109500.

Preferred commercial lipase products include include Lipolase™, Lipex™; Lipolex™ and Lipoclean™ (Novozymes NS), Lumafast (originally from Genencor) and Lipomax (originally from Gist-Brocades).

Still other examples are lipases sometimes referred to as acyltransferases or perhydrolases, e.g. acyltransferases with homology to Candida antarctica lipase A (WO10/111143), acyltransferase from Mycobacterium smegmatis (WO05/56782), perhydrolases from the CE 7 family (WO09/67279), and variants of the M. smegmatis perhydrolase in particular the S54V variant used in the commercial product Gentle Power Bleach from Huntsman Textile Effects Pte Ltd (WO10/100028).

### Amylases

Suitable amylases which can be used together with XX of the invention may be an alpha-amylase or a glucoamylase and may be of bacterial or fungal origin. Chemically modified or protein engineered mutants are included. Amylases include, for example, alpha-amylases obtained from Bacillus, e.g., a special strain of Bacillus licheniformis, described in more detail in GB 1,296,839.

Suitable amylases include amylases having SEQ ID NO: 3 in WO 95/10603 or variants having 90% sequence identity to SEQ ID NO: 3 thereof. Preferred variants are described in WO 94/02597, WO 94/18314, WO 97/43424 and SEQ ID NO: 4 of WO 99/019467, such as variants with substitutions in one or more of the following positions: 15, 23, 105, 106, 124, 128, 133, 154, 156, 178, 179, 181, 188, 190, 197, 201, 202, 207, 208, 209, 211, 243, 264, 304, 305, 391, 408, and 444.

Different suitable amylases include amylases having SEQ ID NO: 6 in WO 02/010355 or variants thereof having 90% sequence identity to SEQ ID NO: 6. Preferred variants of SEQ ID NO: 6 are those having a deletion in positions 181 and 182 and a substitution in position 193.

Other amylases which are suitable are hybrid alpha-amylase comprising residues 1-33 of the alpha-amylase derived from B. amyloliquefaciens shown in SEQ ID NO: 6 of WO 2006/066594 and residues 36-483 of the B. licheniformis alpha-amylase shown in SEQ ID NO: 4 of WO 2006/066594 or variants having 90% sequence identity thereof. Preferred variants of this hybrid alpha-amylase are those having a substitution, a deletion or an insertion in one of more of the following positions: G48, T49, G107, H156, A181, N190, M197, 1201, A209 and Q264. Most preferred variants of the hybrid alpha-amylase comprising residues 1-33 of the alpha-amylase derived from B. amyloliquefaciens shown in SEQ ID NO: 6 of WO 2006/066594 and residues 36-483 of SEQ ID NO: 4 are those having the substitutions:

M197T;

H156Y+A181T+N190F+A209V+Q264S; or

G48A+T49I+G107A+H156Y+A181T+N190F+1201F+A209V+Q264S.

Further amylases which are suitable are amylases having SEQ ID NO: 6 in WO 99/019467 or variants thereof having 90% sequence identity to SEQ ID NO: 6. Preferred variants of SEQ ID NO: 6 are those having a substitution, a deletion or an insertion in one or more of the following positions: R181, G182, H183, G184, N195, I206, E212, E216 and K269. Particularly preferred amylases are those having deletion in positions R181 and G182, or positions H183 and G184.

Additional amylases which can be used are those having SEQ ID NO: 1, SEQ ID NO: 3, SEQ ID NO: 2 or SEQ ID NO: 7 of WO 96/023873 or variants thereof having 90% sequence identity to SEQ ID NO: 1, SEQ ID NO: 2, SEQ ID NO: 3 or SEQ ID NO: 7. Preferred variants of SEQ ID NO: 1, SEQ ID NO: 2, SEQ ID NO: 3 or SEQ ID NO: 7 are those having a substitution, a deletion or an insertion in one or more of the following positions: 140, 181, 182, 183, 184, 195, 206, 212, 243, 260, 269, 304 and 476. More preferred variants are those having a deletion in positions 181 and 182 or positions 183 and 184. Most preferred amylase variants of SEQ ID NO: 1, SEQ ID NO: 2 or SEQ ID NO: 7 are those having a deletion in positions 183 and 184 and a substitution in one or more of positions 140, 195, 206, 243, 260, 304 and 476.

Other amylases which can be used are amylases having SEQ ID NO: 2 of WO 08/153815, SEQ ID NO: 10 in WO 01/66712 or variants thereof having 90% sequence identity to SEQ ID NO: 2 of WO 08/153815 or 90% sequence identity to SEQ ID NO: 10 in WO 01/66712. Preferred variants of SEQ ID NO: 10 in WO 01/66712 are those having a substitution, a deletion or an insertion in one of more of the following positions: 176, 177, 178, 179, 190, 201, 207, 211 and 264.

Further suitable amylases are amylases having SEQ ID NO: 2 of WO 09/061380 or variants having 90% sequence identity to SEQ ID NO: 2 thereof. Preferred variants of SEQ ID NO: 2 are those having a truncation of the C-terminus and/or a substitution, a deletion or an insertion in one of more of the following positions: Q87, Q98, S125, N128, T131, T165, K178, R180, S181, T182, G183, M201, F202, N225, S243, N272, N282, Y305, R309, D319, Q320, Q359, K444 and G475. More preferred variants of SEQ ID NO: 2 are those having the substitution in one of more of the following positions: Q87E,R, Q98R, S125A, N128C, T131I , T1651, K178L, T182G, M201L, F202Y, N225E,R, N272E,R, S243Q,A,E,D, Y305R, R309A, Q320R, Q359E, K444E and G475K and/or deletion in position R180 and/or S181 or of T182 and/or G183. Most preferred amylase variants of SEQ ID NO: 2 are those having the substitutions:

N128C+K178L+T182G+Y305R+G475K;

N128C+K178L+T182G+F202Y+Y305R+D319T+G475K;

S125A+N128C+K178L+T182G+Y305R+G475K; or

S125A+N128C+T131I+T1651+K178L+T182G+Y305R+G475K wherein the variants are C-terminally truncated and optionally further comprises a substitution at position 243 and/or a deletion at position 180 and/or position 181.

Other suitable amylases are the alpha-amylase having SEQ ID NO: 12 in WO01/66712 or a variant having at least 90% sequence identity to SEQ ID NO: 12. Preferred amylase variants are those having a substitution, a deletion or an insertion in one of more of the following positions of SEQ ID NO: 12 in WO01/66712: R28, R118, N174; R181, G182, D183, G184, G186, W189, N195, M202, Y298, N299, K302, S303, N306, R310, N314; R320, H324, E345, Y396, R400, W439, R444, N445, K446, Q449, R458, N471, N484. Particular preferred amylases include variants having a deletion of D183 and G184 and having the substitutions R118K, N195F, R320K and R458K, and a variant additionally having substitutions in one or more position selected from the group: M9, G149, G182, G186, M202, T257, Y295, N299, M323, E345 and A339, most preferred a variant that additionally has substitutions in all these positions.

Other examples are amylase variants such as those described in WO2011/098531, WO2013/001078 and WO2013/001087.

Commercially available amylases are Duramyl™, Termamyl™, Fungamyl™, Stainzyme™, Stainzyme Plus™, Natalase™, Liquozyme X and BAN™ (from Novozymes NS), and Rapidase™, Purastar™/Effectenz™, Powerase and Preferenz S100 (from Genencor International Inc./DuPont).

### Peroxidases/Oxidases

Suitable peroxidases/oxidases include those of plant, bacterial or fungal origin. Chemically modified or protein engineered mutants are included. Examples of useful peroxidases include peroxidases from Coprinus, e.g., from C. cinereus, and variants thereof as those described in WO 93/24618, WO 95/10602, and WO 98/15257.

Commercially available peroxidases include Guardzyme™ (Novozymes NS).

The detergent enzyme(s) may be included in a detergent composition by adding separate additives containing one or more enzymes, or by adding a combined additive comprising all of these enzymes. A detergent additive of the invention, i.e., a separate additive or a combined additive, can be formulated, for example, as a granulate, liquid, slurry, etc. Preferred detergent additive formulations are granulates, in particular non-dusting granulates, liquids, in particular stabilized liquids, or slurries.

Non-dusting granulates may be produced, e.g., as disclosed in U.S. Pat. Nos. 4,106,991 and 4,661,452 and may optionally be coated by methods known in the art. Examples of waxy coating materials are poly(ethylene oxide) products (polyethyleneglycol, PEG) with mean molar weights of 1000 to 20000; ethoxylated nonylphenols having from 16 to 50 ethylene oxide units; ethoxylated fatty alcohols in which the alcohol contains from 12 to 20 carbon atoms and in which there are 15 to 80 ethylene oxide units; fatty alcohols; fatty acids; and mono- and di- and triglycerides of fatty acids. Examples of film-forming coating materials suitable for application by fluid bed techniques are given in GB 1483591. Liquid enzyme preparations may, for instance, be stabilized by adding a polyol such as propylene glycol, a sugar or sugar alcohol, lactic acid or boric acid according to established methods. Protected enzymes may be prepared according to the method disclosed in EP 238,216.

### Adjunct Materials

Any detergent components known in the art for use in laundry detergents may also be utilized. Other optional detergent components include anti-corrosion agents, anti-shrink agents, anti-soil redeposition agents, anti-wrinkling agents, bactericides, binders, corrosion inhibitors, disintegrants/disintegration agents, dyes, enzyme stabilizers (including boric acid, borates, CMC, and/or polyols such as propylene glycol), fabric conditioners including clays, fillers/processing aids, fluorescent whitening agents/optical brighteners, foam boosters, foam (suds) regulators, perfumes, soil-suspending agents, softeners, suds suppressors, tarnish inhibitors, and wicking agents, either alone or in combination. Any ingredient known in the art for use in laundry detergents may be utilized. The choice of such ingredients is well within the skill of the artisan.

Dispersants: The detergent compositions of the present invention can also contain dispersants. In particular powdered detergents may comprise dispersants. Suitable water-soluble organic materials include the homo- or co-polymeric acids or their salts, in which the polycarboxylic acid comprises at least two carboxyl radicals separated from each other by not more than two carbon atoms. Suitable dispersants are for example described in Powdered Detergents, Surfactant science series volume 71, Marcel Dekker, Inc.

Dye Transfer Inhibiting Agents: The detergent compositions of the present invention may also include one or more dye transfer inhibiting agents. Suitable polymeric dye transfer inhibiting agents include, but are not limited to, polyvinylpyrrolidone polymers, polyamine N-oxide polymers, copolymers of N-vinylpyrrolidone and N-vinylimidazole, polyvinyloxazolidones and polyvinylimidazoles or mixtures thereof. When present in a subject composition, the dye transfer inhibiting agents may be present at levels from about 0.0001% to about 10%, from about 0.01% to about 5% or even from about 0.1% to about 3% by weight of the composition.

Fluorescent whitening agent: The detergent compositions of the present invention will preferably also contain additional components that may tint articles being cleaned, such as fluorescent whitening agent or optical brighteners. Where present the brightener is preferably at a level of about 0.01% to about 0.5%. Any fluorescent whitening agent suitable for use in a laundry detergent composition may be used in the composition of the present invention. The most commonly used fluorescent whitening agents are those belonging to the classes of diaminostilbene-sulphonic acid derivatives, diarylpyrazoline derivatives and bisphenyl-distyryl derivatives. Examples of the diaminostilbene-sulphonic acid derivative type of fluorescent whitening agents include the sodium salts of: 4,4′-bis-(2-diethanolamino-4-anilino-s-triazin-6-ylamino)stilbene-2,2′-disulphonate; 4,4′-bis-(2,4-dianilino-s-triazin-6-ylamino)stilbene-2.2′-disulphonate; 4,4′-bis-(2-anilino-4(N-methyl-N-2-hydroxy-ethylamino)-s-triazin-6-ylamino)stilbene-2,2′-disulphonate, 4,4′-bis-(4-phenyl-2,1,3-triazol-2-yl)stilbene-2,2′-disulphonate; 4,4′-bis-(2-anilino-4(1-methyl-2-hydroxy-ethylamino)-s-triazin-6-ylamino)stilbene-2,2′-disulphonate and 2-(stilbyl-4″-naptho-1,2′:4,5)-1,2,3-trizole-2″-sulphonate. Preferred fluorescent whitening agents are Tinopal DMS and Tinopal CBS available from Ciba-Geigy AG, Basel, Switzerland. Tinopal DMS is the disodium salt of 4,4′-bis-(2-morpholino-4 anilino-s-triazin-6-ylamino)stilbene disulphonate. Tinopal CBS is the disodium salt of 2,2′-bis-(phenyl-styryl) disulphonate. Also preferred are fluorescent whitening agents is the commercially available Parawhite KX, supplied by Paramount Minerals and Chemicals, Mumbai, India. Other fluorescers suitable for use in the invention include the 1-3-diaryl pyrazolines and the 7-alkylaminocoumarins. Suitable fluorescent brightener levels include lower levels of from about 0.01, from 0.05, from about 0.1 or even from about 0.2 wt % to upper levels of 0.5 or even 0.75 wt %.

Soil release polymers: The detergent compositions of the present invention may also include one or more soil release polymers which aid the removal of soils from fabrics such as cotton and polyester based fabrics, in particular the removal of hydrophobic soils from polyester based fabrics. The soil release polymers may for example be nonionic or anionic terephthalte based polymers, polyvinyl caprolactam and related copolymers, vinyl graft copolymers, polyester polyamides see for example Chapter 7 in Powdered Detergents, Surfactant science series volume 71, Marcel Dekker, Inc. Another type of soil release polymers are amphiphilic alkoxylated grease cleaning polymers comprising a core structure and a plurality of alkoxylate groups attached to that core structure. The core structure may comprise a polyalkylenimine structure or a polyalkanolamine structure as described in detail in WO 2009/087523 (hereby incorporated by reference). Furthermore random graft co-polymers are suitable soil release polymers Suitable graft co-polymers are described in more detail in WO 2007/138054, WO 2006/108856 and WO 2006/113314 (hereby incorporated by reference). Other soil release polymers are substituted polysaccharide structures especially substituted cellulosic structures such as modified cellulose deriviatives such as those described in EP 1867808 or WO 2003/040279 (both are hereby incorporated by reference). Suitable cellulosic polymers include cellulose, cellulose ethers, cellulose esters, cellulose amides and mixtures thereof. Suitable cellulosic polymers include anionically modified cellulose, nonionically modified cellulose, cationically modified cellulose, zwitterionically modified cellulose, and mixtures thereof. Suitable cellulosic polymers include methyl cellulose, carboxy methyl cellulose, ethyl cellulose, hydroxyl ethyl cellulose, hydroxyl propyl methyl cellulose, ester carboxy methyl cellulose, and mixtures thereof.

Anti-redeposition agents: The detergent compositions of the present invention may also include one or more anti-redeposition agents such as carboxymethylcellulose (CMC), polyvinyl alcohol (PVA), polyvinylpyrrolidone (PVP), polyoxyethylene and/or polyethyleneglycol (PEG), homopolymers of acrylic acid, copolymers of acrylic acid and maleic acid, and ethoxylated polyethyleneimines. The cellulose based polymers described under soil release polymers above may also function as anti-redeposition agents.

Other suitable adjunct materials include, but are not limited to, anti-shrink agents, anti-wrinkling agents, bactericides, binders, carriers, dyes, enzyme stabilizers, fabric softeners, fillers, foam regulators, hydrotropes, perfumes, pigments, sod suppressors, solvents, and structurants for liquid detergents and/or structure elasticizing agents.

### Formulation of Detergent Products

The detergent composition of the invention may be in any convenient form, e.g., a bar, a homogenous tablet, a tablet having two or more layers, a pouch having one or more compartments, a regular or compact powder, a granule, a paste, a gel, or a regular, compact or concentrated liquid. There are a number of detergent formulation forms such as layers (same or different phases), pouches, as well as forms for machine dosing unit.

Pouches can be configured as single or multicompartments. It can be of any form, shape and material which is suitable for hold the composition, e.g. without allowing the release of the composition from the pouch prior to water contact. The pouch is made from water soluble film which encloses an inner volume. Said inner volume can be divided into compartments of the pouch. Preferred films are polymeric materials preferably polymers which are formed into a film or sheet. Preferred polymers, copolymers or derivates thereof are selected polyacrylates, and water soluble acrylate copolymers, methyl cellulose, carboxy methyl cellulose, sodium dextrin, ethyl cellulose, hydroxyethyl cellulose, hydroxypropyl methyl cellulose, malto dextrin, poly methacrylates, most preferably polyvinyl alcohol copolymers and, hydroxyprpyl methyl cellulose (HPMC). Preferably the level of polymer in the film for example PVA is at least about 60%. Preferred average molecular weight will typically be about 20,000 to about 150,000. Films can also be of blend compositions comprising hydrolytically degradable and water soluble polymer blends such as polyactide and polyvinyl alcohol (known under the Trade reference M8630 as sold by Chris Craft In. Prod. Of Gary, Ind., US) plus plasticisers like glycerol, ethylene glycerol, Propylene glycol, sorbitol and mixtures thereof. The pouches can comprise a solid laundry cleaning composition or part components and/or a liquid cleaning composition or part components separated by the water soluble film. The compartment for liquid components can be different in composition than compartments containing solids. Ref: (US2009/0011970 A1).

Detergent ingredients can be separated physically from each other by compartments in water dissolvable pouches or in different layers of tablets. Thereby negative storage interaction between components can be avoided. Different dissolution profiles of each of the compartments can also give rise to delayed dissolution of selected components in the wash solution.

A liquid or gel detergent, which is not unit dosed, may be aqueous, typically containing at least 20% by weight and up to 95% water, such as up to about 70% water, up to about 65% water, up to about 55% water, up to about 45% water, up to about 35% water. Other types of liquids, including without limitation, alkanols, amines, diols, ethers and polyols may be included in an aqueous liquid or gel. An aqueous liquid or gel detergent may contain from 0-30% organic solvent. A liquid or gel detergent may be non-aqueous.

### Laundry Soap Bars

The enzymes of the invention may be added to laundry soap bars and used for hand washing laundry, fabrics and/or textiles. The term laundry soap bar includes laundry bars, soap bars, combo bars, syndet bars and detergent bars. The types of bar usually differ in the type of surfactant they contain, and the term laundry soap bar includes those containing soaps from fatty acids and/or synthetic soaps. The laundry soap bar has a physical form which is solid and not a liquid, gel or a powder at room temperature. The term solid is defined as a physical form which does not significantly change over time, i.e. if a solid object (e.g. laundry soap bar) is placed inside a container, the solid object does not change to fill the container it is placed in. The bar is a solid typically in bar form but can be in other solid shapes such as round or oval.

The laundry soap bar may contain one or more additional enzymes, protease inhibitors such as peptide aldehydes (or hydrosulfite adduct or hemiacetal adduct), boric acid, borate, borax and/or phenylboronic acid derivatives such as 4-formylphenylboronic acid, one or more soaps or synthetic surfactants, polyols such as glycerine, pH controlling compounds such as fatty acids, citric acid, acetic acid and/or formic acid, and/or a salt of a monovalent cation and an organic anion wherein the monovalent cation may be for example Na⁺, K⁺ or NH₄⁺ and the organic anion may be for example formate, acetate, citrate or lactate such that the salt of a monovalent cation and an organic anion may be, for example, sodium formate.

The laundry soap bar may also contain complexing agents like EDTA and HEDP, perfumes and/or different type of fillers, surfactants e.g. anionic synthetic surfactants, builders, polymeric soil release agents, detergent chelators, stabilizing agents, fillers, dyes, colorants, dye transfer inhibitors, alkoxylated polycarbonates, suds suppressers, structurants, binders, leaching agents, bleaching activators, clay soil removal agents, anti-redeposition agents, polymeric dispersing agents, brighteners, fabric softeners, perfumes and/or other compounds known in the art.

The laundry soap bar may be processed in conventional laundry soap bar making equipment such as but not limited to: mixers, plodders, e.g a two stage vacuum plodder, extruders, cutters, logo-stampers, cooling tunnels and wrappers. The invention is not limited to preparing the laundry soap bars by any single method. The premix of the invention may be added to the soap at different stages of the process. For example, the premix containing a soap, an enzyme, optionally one or more additional enzymes, a protease inhibitor, and a salt of a monovalent cation and an organic anion may be prepared and and the mixture is then plodded. The enzyme and optional additional enzymes may be added at the same time as the protease inhibitor for example in liquid form. Besides the mixing step and the plodding step, the process may further comprise the steps of milling, extruding, cutting, stamping, cooling and/or wrapping.

### Granular Detergent Formulations

A granular detergent may be formulated as described in WO09/092699, EP1705241, EP1382668, WO07/001262, U.S. Pat. No. 6,472,364, WO04/074419 or WO09/102854. Other useful detergent formulations are described in WO09/124162, WO09/124163, WO09/117340, WO09/117341, WO09/117342, WO09/072069, WO09/063355, WO09/132870, WO09/121757, WO09/112296, WO09/112298, WO09/103822, WO09/087033, WO09/050026, WO09/047125, WO09/047126, WO09/047127, WO09/047128, WO09/021784, WO09/010375, WO09/000605, WO09/122125, WO09/095645, WO09/040544, WO09/040545, WO09/024780, WO09/004295, WO09/004294, WO09/121725, WO09/115391, WO09/115392, WO09/074398, WO09/074403, WO09/068501, WO09/065770, WO09/021813, WO09/030632, and WO09/015951.

WO2011025615, WO2011016958, WO2011005803, WO2011005623, WO2011005730, WO2011005844, WO2011005904, WO2011005630, WO2011005830, WO2011005912, WO2011005905, WO2011005910, WO2011005813, WO2010135238, WO2010120863, WO2010108002, WO2010111365, WO2010108000, WO2010107635, WO2010090915, WO2010033976, WO2010033746, WO2010033747, WO2010033897, WO2010033979, WO2010030540, WO2010030541, WO2010030539, WO2010024467, WO2010024469, WO2010024470, WO2010025161, WO2010014395, WO2010044905,

WO2010145887, WO2010142503, WO2010122051, WO2010102861, WO2010099997, WO2010084039, WO2010076292, WO2010069742, WO2010069718, WO2010069957, WO2010057784, WO2010054986, WO2010018043, WO2010003783, WO2010003792,

WO2011023716, WO2010142539, WO2010118959, WO2010115813, WO2010105942, WO2010105961, WO2010105962, WO2010094356, WO2010084203, WO2010078979, WO2010072456, WO2010069905, WO2010076165, WO2010072603, WO2010066486, WO2010066631, WO2010066632, WO2010063689, WO2010060821, WO2010049187, WO2010031607, WO2010000636.

### Method of Producing the Composition

The present invention also relates to methods of producing the composition. The method may be relevant for the (storage) stability of the detergent composition: e.g. soap bar premix method WO2009155557.

### Uses

The present invention is also directed to the use of a detergent composition for reducing or preventing soil redeposition comprising an isolated polypeptide having xanthan lyase activity selected from the group consisting of:
(a) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 4;
(b) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 46;
(c) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 60;
(d) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 64;
(e) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 106;
(f) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 110;
(g) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 114;
(h) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 118;
(i) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 122;
(j) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 126;
(k) a polypeptide encoded by a polynucleotide that hybridizes under medium stringency conditions, medium-high stringency conditions, high stringency conditions, or very high stringency conditions with:
   (i) the mature polypeptide coding sequence of SEQ ID NO: 3;
   (ii) the mature polypeptide coding sequence of SEQ ID NO: 45;
   (iii) the mature polypeptide coding sequence of SEQ ID NO: 59;
   (iv) the mature polypeptide coding sequence of SEQ ID NO: 63;
   (v) the mature polypeptide coding sequence of SEQ ID NO: 105;
   (vi) the mature polypeptide coding sequence of SEQ ID NO: 109;
   (vii) the mature polypeptide coding sequence of SEQ ID NO: 113;
   (viii) the mature polypeptide coding sequence of SEQ ID NO: 117;
   (ix) the mature polypeptide coding sequence of SEQ ID NO: 121;
   (x) the mature polypeptide coding sequence of SEQ ID NO: 125; or
   (xi) the full-length complement thereof of (i), (ii), (iii), (iv), (v), (vi), (vii), (viii), (ix), or (x);
(l) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 3;
(m) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 45;
(n) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 59;
(o) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 63;
(p) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 105;
(q) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 109;
(r) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 113;
(s) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 117;
(t) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 121;
(u) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 125;
(v) a variant of the mature polypeptide of SEQ ID NO: 4, SEQ ID NO: 46, SEQ ID NO: 60, SEQ ID NO: 64, SEQ ID NO: 106, SEQ ID NO: 110, SEQ ID NO: 114, SEQ ID NO: 118, SEQ ID NO: 122 or SEQ ID NO: 126 comprising a substitution, deletion, and/or insertion at one or more positions (e.g. several); and
(w) a fragment of the polypeptide of (a), (b), (c), (d), (e), (f), (g), (h), (i), (j), (k), (l), (m), (n), (o), (p), (q), (r), (s), (t), (u) or (v) that has xanthan lyase activity.

In one embodiment, the detergent composition further comprises one or more detergent components selected from the group comprising surfactants, builders, hydrotopes, bleaching systems, polymers, fabric hueing agents, adjunct materials, dispersants, dye transfer inhibiting agents, fluorescent whitening agents and soil release polymers, or any mixture thereof. The detergent composition may be in the form of a bar, a homogenous tablet, a tablet having two or more layers, a pouch having one or more compartments, a regular or compact powder, a granulate, a paste, a gel, or a regular, compact or concentrated liquid and may be used for dish wash or laundering.

In another embodiment, the detergent composition comprises one or more additional enzymes selected from the group comprising proteases, amylases, lipases, cutinases, cellulases, endoglucanases, xyloglucanases, pectinases, pectin lyases, xanthanases, peroxidaes, haloperoxygenases, catalases and mannanases, or any mixture thereof.

In a further embodiment, the detergent composition comprises one or more detergent components selected from the group comprising surfactants, builders, hydrotopes, bleaching systems, polymers, fabric hueing agents, adjunct materials, dispersants, dye transfer inhibiting agents, fluorescent whitening agents and soil release polymers, or any mixture thereof and one or more additional enzymes selected from the group comprising proteases, amylases, lipases, cutinases, cellulases, endoglucanases, xyloglucanases, pectinases, pectin lyases, xanthanases, peroxidaes, haloperoxygenases, catalases and mannanases, or any mixture thereof.

In an embodiment, the use of a detergent composition for reducing or preventing soil redeposition comprises an isolated polypeptide having xanthan lyase activity and an isolated GH9 endoglucanase. In a preferred embodiment, the isolated GH9 endoglucanase is selected from the group consisting of:
(a) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 2;
(b) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 10;
(c) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 12;
(d) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 14;
(e) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 48;
(f) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 52;
(g) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 56;
(h) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 82;
(i) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 86;
(j) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 90;
(k) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 94;
(l) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 98;
(m) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 102;
(n) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 130;
(o) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 134;
(p) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 138;
(q) a polypeptide encoded by a polynucleotide that hybridizes under medium stringency conditions, medium-high stringency conditions, high stringency conditions, or very high stringency conditions with:
   (i) the mature polypeptide coding sequence of SEQ ID NO: 1;
   (ii) the mature polypeptide coding sequence of SEQ ID NO: 9;
   (iii) the mature polypeptide coding sequence of SEQ ID NO: 11;
   (iv) the mature polypeptide coding sequence of SEQ ID NO: 13;
   (v) the mature polypeptide coding sequence of SEQ ID NO: 47;
   (vi) the mature polypeptide coding sequence of SEQ ID NO: 51;
   (vii) the mature polypeptide coding sequence of SEQ ID NO: 55;
   (viii) the mature polypeptide coding sequence of SEQ ID NO: 81;
   (ix) the mature polypeptide coding sequence of SEQ ID NO: 85;
   (x) the mature polypeptide coding sequence of SEQ ID NO: 89;
   (xi) the mature polypeptide coding sequence of SEQ ID NO: 93;
   (xii) the mature polypeptide coding sequence of SEQ ID NO: 97;
   (xiii) the mature polypeptide coding sequence of SEQ ID NO: 101;
   (xiv) the mature polypeptide coding sequence of SEQ ID NO: 129;
   (xv) the mature polypeptide coding sequence of SEQ ID NO: 133;
   (xvi) the mature polypeptide coding sequence of SEQ ID NO: 137; or
   (xvii) the full-length complement thereof of (i), (ii), (iii), (iv), (v), (vi), (vii), (viii), (ix), (x), (xi), (xii), (xiii), (xiv), (xv), or (xvi);
(r) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 1;
   (s) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 9;
(t) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 11;
(u) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 13;
(v) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 47;
(w) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 51;
(x) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 55;
(y) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 81;
(z) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 85;
(aa) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 89;
(ab) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 93;
(ac) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 97;
(ad) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 101;
(ae) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 129;
(af) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 133;
(ag) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 137;
(ah) a variant of the mature polypeptide of SEQ ID NO: 2, SEQ ID NO: 10, SEQ ID NO: 12, SEQ ID NO: 14, SEQ ID NO: 48, SEQ ID NO: 52, SEQ ID NO: 56, SEQ ID NO: 82, SEQ ID NO: 86, SEQ ID NO: 90, SEQ ID NO: 94, SEQ ID NO: 98, SEQ ID NO: 102, SEQ ID NO: 130, SEQ ID NO: 134 or SEQ ID NO: 138 comprising a substitution, deletion, and/or insertion at one or more positions (e.g. several); and
(ai) a fragment of the polypeptide of (a), (b), (c), (d), (e), (f), (g), (h), (i), (j), (k), (l), (m), (n), (o), (p), (q), (r), (s), (t), (u), (v), (w), (x), (y), (z), (aa), (ab), (ac), (ad), (ae), (af), (ag) or (ah) that has xanthan degrading activity and/or endo-β-1,4-glucanase activity.

A further preferred embodiment is the use of a detergent composition for reducing or preventing soil redeposition comprising an isolated polypeptide having xanthan lyase activity selected from the group consisting of:
(a) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 4;
(b) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 46;
(c) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 60;
(d) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 64;
(e) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 106;
(f) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 110;
(g) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 114;
(h) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 118;
(i) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 122;
(j) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 126;
(k) a polypeptide encoded by a polynucleotide that hybridizes under medium stringency conditions, medium-high stringency conditions, high stringency conditions, or very high stringency conditions with:
   (i) the mature polypeptide coding sequence of SEQ ID NO: 3;
   (ii) the mature polypeptide coding sequence of SEQ ID NO: 45;
   (iii) the mature polypeptide coding sequence of SEQ ID NO: 59;
   (iv) the mature polypeptide coding sequence of SEQ ID NO: 63;
   (v) the mature polypeptide coding sequence of SEQ ID NO: 105;
   (vi) the mature polypeptide coding sequence of SEQ ID NO: 109;
   (vii) the mature polypeptide coding sequence of SEQ ID NO: 113;
   (viii) the mature polypeptide coding sequence of SEQ ID NO: 117;
   (ix) the mature polypeptide coding sequence of SEQ ID NO: 121;
   (x) the mature polypeptide coding sequence of SEQ ID NO: 125; or
   (xi) the full-length complement thereof of (i), (ii), (iii), (iv), (v), (vi), (vii), (viii), (ix), or (x);
(l) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 3;
(m) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 45;
(n) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 59;
(o) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 63;
(p) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 105;
(q) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 109;
(r) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 113;
(s) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 117;
(t) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 121;
(u) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 125;
(v) a variant of the mature polypeptide of SEQ ID NO: 4, SEQ ID NO: 46, SEQ ID NO: 60, SEQ ID NO: 64, SEQ ID NO: 106, SEQ ID NO: 110, SEQ ID NO: 114, SEQ ID NO: 118, SEQ ID NO: 122 or SEQ ID NO: 126 comprising a substitution, deletion, and/or insertion at one or more positions (e.g. several); and
(w) a fragment of the polypeptide of (a), (b), (c), (d), (e), (f), (g), (h), (i), (j), (k), (l), (m), (n), (o), (p), (q), (r), (s), (t), (u) or (v) that has xanthan lyase activity;
   and an isolated GH9 endoglucanase selected from the group consisting of:
(a) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 2;
(b) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 10;
(c) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 48;
(d) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 56;
(e) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 82;
(f) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 86;
(g) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 90;
(h) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 94;
(i) a polypeptide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide of SEQ ID NO: 98;
(j) a polypeptide encoded by a polynucleotide that hybridizes under medium stringency conditions, medium-high stringency conditions, high stringency conditions, or very high stringency conditions with:
   (i) the mature polypeptide coding sequence of SEQ ID NO: 1;
   (ii) the mature polypeptide coding sequence of SEQ ID NO: 9;
   (iii) the mature polypeptide coding sequence of SEQ ID NO: 47;
   (iv) the mature polypeptide coding sequence of SEQ ID NO: 55;
   (v) the mature polypeptide coding sequence of SEQ ID NO: 81;
   (vi) the mature polypeptide coding sequence of SEQ ID NO: 85;
   (vii) the mature polypeptide coding sequence of SEQ ID NO: 89;
   (viii) the mature polypeptide coding sequence of SEQ ID NO: 93;
   (ix) the mature polypeptide coding sequence of SEQ ID NO: 97;
   (x) the full-length complement thereof of (i), (ii), (iii), (iv), (v), (vi), (vii), (viii), (ix) or (x);
(k) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 1;
(l) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 9;
(m) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 47;
(n) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 55;
(o) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 81;
(p) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 85;
(q) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 89;
(r) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 93;
(s) a polypeptide encoded by a polynucleotide having at least 80%, e.g., at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% sequence identity to the mature polypeptide coding sequence of SEQ ID NO: 97;
(t) a variant of the mature polypeptide of SEQ ID NO: 2, SEQ ID NO: 10, SEQ ID NO: 48, SEQ ID NO: 56, SEQ ID NO: 82, SEQ ID NO: 86, SEQ ID NO: 90, SEQ ID NO: 94 or SEQ ID NO: 98 comprising a substitution, deletion, and/or insertion at one or more positions (e.g. several); and
(u) a fragment of the polypeptide of (a), (b), (c), (d), (e), (f), (g), (h), (i), (j), (k), (l), (m), (n), (o), (p), (q), (r), (s), (t) or (u) that has xanthan degrading activity and/or endo-β-1,4-glucanase activity.

### Redeposition Effects

Xanthan gum has been use as an ingredient in many consumer products including foods and cosmetics and has found use in the oil industry. Stains and soils which are washed off a textile, fabric or hard surface and into the wash liquor can be redeposited anywhere on the same textile, fabric or hard surface or onto another textile, fabric or hard surface in the same wash. Anti-redeposition agents are compounds, such as polymers or enzymes, which prevent soils which are in the wash liquor from depositing back onto the textile, fabric or hard surface. Whilst not wishing to be bound by theory, the washing process generally works by reducing the particle size and/or molecular weight of the soil fragment which then facilitates the soils to remain suspended in the wash liquor. Anti-redeposition agents can be added which keep detached soils as individual entities in solution and prevents re-combination that can give rise to grit formation. Anti-redeposition agents, especially enzymes which have anti-redeposition properties, can also help to detach soils from the soiled surfaces.

The xanthan lyases of the invention, optionally together with a GH9 endoglucanase, help prevent the soil from being deposited back onto the textile, fabric or hard surface and therefore the textile and/or fabric looks cleaner and/or whiter and/or the hard surface has better shine and reduced filming and spotting on the washed items.

The detergent composition may be formulated as already described herein as a hand or machine laundry detergent composition for both household and industrial laundry cleaning, or be formulated as a detergent composition for use in general household or industrial hard surface cleaning operations, or be formulated for hand or machine (both household and industrial) dishwashing operations.

The anti-redeposition effect may be measured using the MiniLOM assay or the Terg-O-tometer (TOM) wash assay. In an embodiment, the ΔRem enzyme value may be measured using the TOM wash assay as described herein on pre-washed knitted cotton swatches (wfk 10A or CN-42) at 40° C. using xanthan solution and WFK 09v pigment soil. The remission value is preferably measured at 460 nm. The preferred enzyme concentration used for the GH9 endoglucanase and xanthan lyase is 0.5 mg EP/L and 1.0 mg EP/L respectively.

The ΔRem enzyme value for xanthan solution and WFK 09v pigment soil is at least 2 units as determined by TOM. The ΔRem enzyme value for xanthan solution and WFK 09v pigment soil is at least 2.25 units as determined by TOM. The ΔRem enzyme value for xanthan solution and WFK 09v pigment soil is at least 2.5 units as determined by TOM. The ΔRem enzyme value for xanthan solution and WFK 09v pigment soil is at least 2.75 units as determined by TOM. The ΔRem enzyme value for xanthan solution and WFK 09v pigment soil is at least 3 units as determined by TOM. The ΔRem enzyme value for xanthan solution and WFK 09v pigment soil is at least 3.5 units as determined by TOM. The ΔRem enzyme value for xanthan solution and WFK 09v pigment soil is at least 4 units as determined by TOM. The ΔRem enzyme value for xanthan solution and WFK 09v pigment soil is at least 4.5 units as determined by TOM. The ΔRem enzyme value for xanthan solution and WFK 09v pigment soil is at least 5 units as determined by TOM.

In an embodiment, the ΔRem enzyme value may be measured using the MiniLOM wash assay as described herein on pre-washed knitted cotton swatches (wfk 10A or CN-42) at 40° C. using xanthan solution and WFK 09v pigment soil. The remission value is preferably measured at 460 nm. The preferred enzyme concentration used for the GH9 endoglucanase and xanthan lyase is 0.5 mg EP/L and 1.0 mg EP/L respectively.

The ΔRem enzyme value for xanthan solution and WFK 09v pigment soil is at least 2 units as determined by MiniLOM. The ΔRem enzyme value for xanthan solution and WFK 09v pigment soil is at least 2.25 units as determined by MiniLOM. The ΔRem enzyme value for xanthan solution and WFK 09v pigment soil is at least 2.5 units as determined by MiniLOM. The ΔRem enzyme value for xanthan solution and WFK 09v pigment soil is at least 2.75 units as determined by MiniLOM. The ΔRem enzyme value for xanthan solution and WFK 09v pigment soil is at least 3 units as determined by MiniLOM. The ΔRem enzyme value for xanthan solution and WFK 09v pigment soil is at least 3.5 units as determined by MiniLOM. The ΔRem enzyme value for xanthan solution and WFK 09v pigment soil is at least 4 units as determined by MiniLOM. The ΔRem enzyme value for xanthan solution and WFK 09v pigment soil is at least 4.5 units as determined by MiniLOM. The ΔRem enzyme value for xanthan solution and WFK 09v pigment soil is at least 5 units as determined by MiniLOM.

The present invention is further described by the following examples that should not be construed as limiting the scope of the invention.

### EXAMPLES

### Swatches

The pre-washed knitted cotton (wfk 10A) and pre-washed polyester (wfk 30A) were purchased from wfk Testgewebe GmbH, Christenfeld 10, D-41379 Bruggen, Germany. Pre-washed knitted cotton (CN-42) was purchased from Center For Testmaterials BV (CFT), Stoomloggerweg 11, 3133 KT Vlaardingen, The Netherlands.

### Stains

The pigment soil WFK 09v was purchased from wfk Testgewebe GmbH, Christenfeld 10, D-41379 Bruggen, Germany.

Xanthan gum (Xanthomonas campestris) was obtained from Sigma (CAS 11138-66-2).

TABLE 1
Composition of Model Detergent A

| Detergent ingredients | Wt % |
|---|---|
| Linear alkylbenzenesulfonic acid (LAS) (Marlon AS3) | 13 |
| Sodium alkyl(C12)ether sulfate (AEOS) (STEOL CS-370 E) | 10 |
| Coco soap (Radiacid 631) | 2.75 |
| Soy soap (Edenor SJ) | 2.75 |
| Alcohol ethoxylate (AEO) (Bio-Soft N25-7) | 11 |
| Sodium hydroxide | 2 |
| Ethanol | 3 |
| Propane-1,2-diol (MPG) | 6 |
| Glycerol | 2 |
| Triethanolamine (TEA) | 3 |
| Sodium formate | 1 |
| Sodium citrate | 2 |
| Diethylenetriaminepentakis(methylenephosphonic acid) | 0.2 |
| (DTMPA) | |
| Polycarboxylate polymer (PCA) (Sokalan CP-5) | 0.2 |
| Water | Up to 100 |

Final pH adjustment to pH 8 with NaOH or citric acid

### Wash Assays

### Mini Launder-O-Meter (MiniLOM)

The miniLOM assay is a small scale version of the Launder-O-Meter (LOM). It can be used to determine the “enzyme detergency benefit”. A miniLOM basically consists of closed test tubes being rotated in a heating cabinet at a given time and temperature. Each test tube constitutes one small washing machine and during an experiment, each will contain a solution of a specific detergent/enzyme system to be tested along with the soiled and unsoiled fabrics it is tested on. Mechanical stress is achieved by the tubes being rotated and by including metal balls in the tube. The small scale model wash system is mainly used in testing of detergents and enzymes at European wash conditions.

Prewashed test swatches were washed in a MiniLOM, comprising following steps: 36 mL detergent solution (15° dH with a Ca/Mg/HCO3 ratio of 5:3:1) containing pigment soil (1.73 g/L)+100 mL xanthan solution (1.35 g/L) was added to the beakers giving a final detergent concentration of 3.33 g/L, a final xanthan concentration of 0.03% (w/w) and a final pigment soil concentration of 1.6 g/L. Once the selected temperature for washing (e.g. 40° C.) was reached, the enzyme and swatches were added to the wash solution. After washing (e.g. after 30 minutes) the textiles were flushed in tap water for 5 minutes, the water was pressed out of the swatch by hand, and the swatch was covered with paper and allowed to air-dry overnight in the dark.

### Terg-O-Tometer (TOM) Wash Assay

The Terg-O-tometer (TOM) is a medium scale model wash system that can be applied to test 12 different wash conditions simultaneously. A TOM is basically a large temperature controlled water bath with up to 12 open metal beakers submerged into it. Each beaker constitutes one small top loader style washing machine and during an experiment, each of them will contain a solution of a specific detergent/enzyme system and the soiled and unsoiled fabrics its performance is tested on. Mechanical stress is achieved by a rotating stirring arm, which stirs the liquid within each beaker with a frequency of 120 per minute. Because the TOM beakers have no lid, it is possible to withdraw samples during a TOM experiment and assay for information on-line during wash.

Prewashed test swatches were washed in a Terg-O-tometer, comprising following steps: 350 mL detergent solution (15° dH with a Ca/Mg/HCO3 ratio of 5:3:1)+100 mL xanthan solution (1.35 g/L) was added to the beakers giving a final detergent concentration of 3.33 g/L and a final xanthan concentration of 0.03% (w/w). Subsequently 0.7 g pigment soil was gently added to each beaker and the mixture was mixed for 5 minutes. Once the selected temperature for washing (e.g. 40° C.) was reached, the enzyme and swatches were added to the wash solution. After washing (e.g. after 30 minutes) the textiles were flushed in tap water for 5 minutes, the water was pressed out of the swatch by hand, and the swatch was covered with paper and allowed to air-dry overnight in the dark.

### Evaluation of Stains

Anti-redeposition is expressed as a remission value or delta remission value (ΔRem). After washing and rinsing the swatches were spread out flat between adsorbent paper and allowed to air dry at room temperature in a dark cupboard overnight. All washes were evaluated on day 2 after the wash. Light reflectance evaluations of the swatches were done using a Macbeth Color Eye 7000 reflectance spectrophotometer with very small aperture for the Mini-LOM and Large aperture for the TOM. The measurements were made without UV in the incident light and remission at 460 nm was extracted. Measurements were made on washed swatches with and without enzymes. The test swatch to be measured was placed on top of another swatch of same type and colour (twin swatch). With only one swatch of each kind per beaker, a swatch from a replicate wash was used in this way. The anti-redeposition effect for each swatch was measured either as 1) remission values measured for the individual swatches or 2) delta remission values for individual swatches calculated by subtracting the remission value of the washed swatch with detergent only from the remission value of the washed swatch with enzymes and detergent.

### Activity Assays

### Reducing Ends

The BCA reducing ends assay is used to determine the concentration of reducing sugars in solution which are formed when the polysaccharide chain is broken down by one or more enzymes present in the assay.

The method used to determine the amount of reducing ends produced was the 2,2′ bicinchoninic acid assay (BCA) as described in Murphy, L., Cruys-Bagger, N., Damgaard, H. D., Baumann, M. J., Olsen, S. N., Borch, K., Lassen, S. F., Sweeney, M., Tatsumi, H., and Westh, P. (2012), “Origin of initial burst in activity for Trichoderma reesei endo-glucanases hydrolyzing insoluble cellulose”, J. Biol. Chem. 287, 1252-1260 and adapted from Zhang, Y. H. P., and Lynd, L. R. (2005), “Determination of the number-average degree of polymerization of cellodextrins and cellulose with application to enzymatic hydrolysis”, Biomacromolecules 6, 1510-15155 and Dubois, M., Gilles, K. A., Hamilton, J. K., Rebers, P. A., and Smith, F. (1956), “Colorimetric method for determination of sugars and related substances”, Anal. Chem. 28: 350-3566. Quantification of reducing ends was based on a glucose standard curve. Appropriate substrate and enzyme controls were included and corrected for in each analysis. Appropriate dilutions were used to ensure samples were within the glucose calibration curve range.

### Viscosity Reduction

The viscosity reduction assay is used to determine the change in viscosity of a solution over time. As the polysaccharide chain is cleaved internally by one or more enzymes present in the assay, the viscosity of the solution is reduced. The viscosity measurements were performed using the Novozymes-developed viscosity pressure assay described in WO2011/107472. 100 μL from each 1 mL hydrolysis or control reaction was removed and analysed.

### Xanthan Lyase Activity Assay

0.8 mL 100 mM HEPES buffer, pH 6.0 was mixed with 0.2 mL Xanthan gum (5 mg/mL) dissolved in water in a 1 mL 1 cm cuvette. The cuvette was inserted into a spectrophotometer (Agilent G1103A 8453A, CA, USA) with temperature control set at 40° C. The solution was pre-incubated for 10 min and 0.1 mL sample was added and the solution was mixed by aspiring and dispensing the solution for at least 5 times using a pipette. Total reaction volume was 1.1 mL. Absorbance at 235 nm was collected for 10 min using a 30 sec measuring interval. Initial activity was calculated by using the software (UV-Visible Chemstation Rev A.10.01 [81], Agilent).

### Colourmetric Assay

Xanthan lyase activity was determined by reducing ends on xanthan gum using the colorimetric assay developed by Lever (1972), Anal. Biochem. 47: 273-279, 1972. GH9 endoglucanase activity was determined using xanthan gum pre-treated with xanthan lyase. Any reducing ends that are produced will react with PAHBAH generating an increase of colour which is proportional to the enzyme activity under the conditions used in the assay.

The enzyme samples were diluted to 0.1 mg/ml in activity buffer in costarstrips using a BioMek liquid handler robot. 50 μl of substrate (0.1% xanthan gum or xanthan gum pre-treated with xanthan lyase in Milli-Q water) and 50 μl of each diluted sample was transferred to a 96-well PCR-MTP plate. 50 μl activity buffer (100 mM sodium acetate, 100 mM MES, 1 mM CaCl2, in 0.01% Triton X100, pH 7) was added to each sample and the solutions mixed. The sealed PCR-plate was incubated in a PCR machine at 37° C. for 15 min. then immediately cooled to 10° C. 75 μl of the stop solution (15 mg/ml PAHBAH (Sigma H-9882) in Ka-Na-tartrate (50 g/L)/NaOH (20 g/L) solution) was added to each sample, the mixture was shaken, and 75 μl of each sample was discarded. The samples were incubated for 10 min. at 95° C., then 1 min. 10° C. 150 μl of each sample was transferred to a new 96-well PCR-MTP and the absorbance at 405 nm was measured.

### Example 1

### Identification of the Xanthan Lyase and GH9 Xanthanase Genes

The bacterial strains were isolated from soil samples obtained from diverse places (see table 2 below) by using xanthan gum as sole carbon source. Isolation and identification of the gene and corresponding protein sequence is described in examples 1, 3, 16 and 20 of PCT/EP2013/059472.

TABLE 2
Origin of bacterial trains.

| Strain | Source | Country | Strain number |
|---|---|---|---|
| Paenibacillus sp | forest soil | China | NN062047 |
| Microbacterium sp | field soil | Spain | NN062149 |
| Microbacterium sp | sand beach | Denmark | NN062148 |
| Microbacterium sp | garden soil | Denmark | NN062045 |
| Paenibacillus sp | Soil | New Zealand | NN018054 |
| Paenibacillus sp | forest soil | United States | NN062253 |
| Paenibacillus sp | forest soil | United States | NN062250 |
| Paenibacillus sp | Forest soil | China | NN062046 |
| Paenibacillus sp | Soil | Denmark | NN062408 |
| Paenibacillus sp | Soil | United States | NN062332 |
| Paenibacillus sp | Sand beach | Denmark | NN062147 |
| Paenibacillus sp | Garden soil | Denmark | NN062193 |
| Microbacterium sp | Soil | Denmark | NN062175 |

### Example 2

### Cloning and Expression in Bacillus subtilis with N-Terminal his Tag

The cloning and expression of the xanthan lyase polypeptides and GH9 endoglucanase polypeptides are described in examples 2, 4, 11, 12, 17, 21 and 22 of PCT/EP2013/059472.

### Example 3

### Purification of the GH9 Endoglucanase and Xanthan Lyase Protein

The xanthan lyase polypeptides and GH9 endoglucanase polypeptides were purified as described in example 5 of PCT/EP2013/059472.

### Example 4

### Degradation of Xanthan Gum by Xanthan Lyases and/or GH9 Endoglucanases

Measurement of the degradation of xanthan gum by xanthan lyases and/or GH9 endoglucanases of the invention using the viscosity pressure assay (as described above, see also WO2011/107472) are described in examples 6, 10, 15, 24, 29 and 33 of PCT/EP2013/059472.

Measurement of the degradation of xanthan gum by xanthan lyases and/or GH9 endoglucanases of the invention using the reducing ends assay (as described above) are described in examples 6, 15 and 34 of PCT/EP2013/059472.

Measurement of the degradation of xanthan gum by xanthan lyases and/or GH9 endoglucanases of the invention using a colourmetric assay (as described above) are described in examples 25, 26, 27 and 30 of PCT/EP2013/059472.

### Example 5

### Anti-Redeposition Study of 4 Xanthan Lyases and 3 GH9 Endoglucanases Using TOM

The experiments were conducted as described in the Terg-O-tometer (TOM) wash assay as described above using the experimental conditions specified in table 3 below. The results are given in tables 4 as remissions at 460 nm using 4 different xanthan lyases and 3 different GH9 endoglucanases. Each experiment was performed in duplicate containers with 4 swatches per container.

TABLE 3
Experimental conditions for TOM

| | |
|---|---|
| Test solution | 3.33 g/L Model detergent A |
| Test solution volume | 350 mL detergent + 100 mL xanthan solution |
| pH | Unadjusted |
| Soil | 0.7 g/beaker pigment soil WFK 09v |
| Wash time | 30 minutes |
| Temperature | 40° C. |
| Enzyme dosage | Xanthan lyase: 1.0 mg enzyme protein/L |
| | GH9 endoglucanase: 0.5 mg enzyme protein/L |
| Water hardness | 16°dH |
| Ca²⁺:Mg²⁺:CO₃²⁻ ratio | 5:1:3 |
| Swatch | Pre-washed knitted cotton (wfk 10A) |

Water hardness was adjusted by addition of CaCl₂, MgCl₂, and NaHCO₃ to the test system.

TABLE 4
Remissions on pre-washed knitted cotton (wfk 10A)

| | Xanthan Lyase | | | | |
|---|---|---|---|---|---|
| Rem₄₆₀ | | | SEQ ID NO: | SEQ ID NO: | SEQ ID NO: |
| GH9 Endoglucanase | None | SEQ ID NO: 8 | 62 | 66 | 68 |
| None | 53.5 ± 1.0 | NT | NT | NT | NT |
| SEQ ID NO: 6 | NT | 58.2 ± 1.6 | 59.4 ± 1.1 | 59.7 ± 1.1 | 60.9 ± 0.8 |
| SEQ ID NO: 16 | NT | 59.6 ± 0.8 | 57.2 ± 0.8 | 58.2 ± 0.6 | 58.6 ± 1.4 |
| SEQ ID NO: 58 | NT | 58.1 ± 0.6 | 59.2 ± 0.9 | 61.4 ± 1.0 | — |

NT Not tested

These results show that the examined combination of xanthan lyase and GH9 has an anti-redeposition effect, i.e. it reduces soil redeposition, under the conditions tested.

### Example 6

### Anti-Redeposition Study of 2 Xanthan Lyases and 2 GH9 Endoglucanases Using MiniLOM

The experiments were conducted as described in the Mini Launder-O-tometer (MiniLOM) wash assay as described above using the experimental conditions specified in table 5 below. The results are given in tables 6 (wfk 10A) and 7 (CN-42) as remissions at 460 nm.

TABLE 5
Experimental conditions for MiniLOM

| | |
|---|---|
| Test solution | 3.33 g/L Model detergent A |
| Test solution volume | 36 mL detergent + 4 mL xanthan solution |
| | (2.7 g/L, 0.03% w/w in wash) |
| pH | Unadjusted |
| Soil | 0.06 g/tube pigment soil WFK 09v |
| Wash time | 30 minutes |
| Temperature | 40° C. |
| Enzyme dosage | Xanthan lyase: 1.0 mg enzyme protein/L |
| | GH9 endoglucanase: 0.5 mg enzyme protein/L |
| Water hardness | 16°dH |
| Ca²⁺:Mg²⁺:CO₃²⁻ ratio | 5:1:3 |
| Swatch | Pre-washed knitted cotton (wfk 10A) |
| | Pre-washed knitted cotton (CN-42) |

TABLE 6
Remissions on Pre-washed knitted cotton (wfk 10A)

| Rem₄₆₀ | Xanthan Lyase | | |
|---|---|---|---|
| GH9 Endoglucanase | None | SEQ ID NO: 8 | SEQ ID NO: 66 |
| None | 65.5 ± 0.9 | NT | NT |
| SEQ ID NO: 6 | 66.7 ± 0.3 | 69.7 ± 0.5 | 69.9 ± 0.8 |
| SEQ ID NO: 58 | 66.5 ± 0.8 | 69.5 ± 0.6 | 70.0 ± 0.6 |

NT: Not tested

TABLE 7
Remissions on Pre-washed knitted cotton (CN-42)

| Rem₄₆₀ | Xanthan Lyase | | |
|---|---|---|---|
| GH9 Endoglucanase | None | SEQ ID NO: 8 | SEQ ID NO: 66 |
| None | 63.3 ± 1.3 | NT | NT |
| SEQ ID NO: 6 | 63.9 ± 1.0 | 74.7 ± 1.3 | 75.4 ± 1.4 |
| SEQ ID NO: 58 | 62.9 ± 1.0 | 72.4 ± 1.8 | 76.0 ± 1.5 |

NT: Not tested

These results show that the examined combination of xanthan lyase and GH9 has an anti-redeposition effect, i.e. it reduces soil redeposition, under the conditions tested.

### Example 7

### Anti-Redeposition Study of 3 Xanthan Lyases and 1 GH9 Endoglucanases Using MiniLOM

The experiments were conducted as described in the Mini Launder-O-tometer (MiniLOM) wash assay as described above using the experimental conditions specified in table 5 above. The results are given in table 8 as remissions at 460 nm.

TABLE 8
Remissions on swatch CN-42

| | Xanthan Lyase | | | |
|---|---|---|---|---|
| Rem₄₆₀ | | SEQ ID | SEQ ID | SEQ |
| GH9 Endoglucanase | None | NO: 108 | NO: 112 | ID NO: 116 |
| None | 64.8 ± 1.1 | 66.1 ± 0.4 | 66.3 ± 1.1 | 65.2 ± 1.5 |
| SEQ ID NO: 6 | 60.5 ± 1.7 | 66.9 ± 1.6 | 68.9 ± 0.9 | 69.3 ± 0.9 |

These results show that the examined combination of xanthan lyase and GH9 has an anti-redeposition effect, i.e. it reduces soil redeposition, under the conditions tested.

### Example 8

### Anti-Redeposition Study of 3 Xanthan Lyases and 2 GH9 Endoglucanases Using MiniLOM

The experiments were conducted as described in the Mini Launder-O-tometer (MiniLOM) wash assay as described above using the experimental conditions specified in table 5 above. The results are given in table 9 as remissions at 460 nm.

TABLE 9
Remissions on swatch CN-42

| | Xanthan Lyase | | | |
|---|---|---|---|---|
| Rem₄₆₀ | | | SEQ ID | SEQ ID |
| GH9 Endoglucanase | None | SEQ ID NO: 8 | NO: 66 | NO: 68 |
| None | 68.0 ± 2.2 | 71.9 ± 1.9 | 71.5 ± 3.1 | 70.5 ± 1.1 |
| SEQ ID NO: 6 | 63.0 ± 3.1 | 73.6 ± 2.4 | 74.2 ± 1.4 | 74.9 ± 1.7 |
| SEQ ID NO: 58 | 63.2 ± 2.4 | 76.5 ± 1.7 | 75.0 ± 1.3 | 75.9 ± 2.0 |

These results show that the examined combination of xanthan lyase and GH9 has an anti-redeposition effect, i.e. it reduces soil redeposition, under the conditions tested.

### Example 9

### Anti-Redeposition Study of 10 Xanthan Lyases and 6 GH9 Endoglucanases Using MiniLOM

Swatches

The pre-washed knitted cotton (wfk 10A) was purchased from wfk Testgewebe GmbH. Christenfeld 10. D-41379 Brüggen. Germany. Pre-washed knitted cotton (CN-42) was purchased from Center For Testmaterials BV (CFT). Stoomloggerweg 11. 3133 KT Vlaardingen. The Netherlands.

Stains

The pigment soil WFK 09v was purchased from wfk Testgewebe GmbH. Christenfeld 10. D-41379 Brüggen. Germany.

Xanthan gum (Xanthomonas campestris) was obtained from Sigma (CAS 11138-66-2).

TABLE 10
Composition of Model Detergent A

| Detergent ingredients | Wt % |
|---|---|
| Linear alkylbenzenesulfonic acid (LAS) (Marlon AS3) | 13 |
| Sodium alkyl(C12)ether sulfate (AEOS) (STEOL CS-370 E) | 10 |
| Coco soap (Radiacid 631) | 2.75 |
| Soy soap (Edenor SJ) | 2.75 |
| Alcohol ethoxylate (AEO) (Bio-Soft N25-7) | 11 |
| Sodium hydroxide | 2 |
| Ethanol | 3 |
| Propane-1.2-diol (MPG) | 6 |
| Glycerol | 2 |
| Triethanolamine (TEA) | 3 |
| Sodium formate | 1 |
| Sodium citrate | 2 |
| Diethylenetriaminepentakis(methylenephosphonic acid) | 0.2 |
| (DTMPA) | |
| Polycarboxylate polymer (PCA) (Sokalan CP-5) | 0.2 |
| Water | Up to 100 |

Final pH adjustment to pH 8 with NaOH or citric acid

### Wash Assay

### Mini Launder-O-Meter (MiniLOM)

The miniLOM assay is a small scale version of the Launder-O-Meter (LOM). It can be used to determine the “enzyme detergency benefit”. A miniLOM basically consists of closed test tubes being rotated in a heating cabinet at a given time and temperature. Each test tube constitutes one small washing machine and during an experiment. each will contain a solution of a specific detergent/enzyme system to be tested along with the soiled and unsoiled fabrics it is tested on. Mechanical stress is achieved by the tubes being rotated and by including metal balls in the tube. The small scale model wash system is mainly used in testing of detergents and enzymes at European wash conditions.

Prewashed test swatches were washed in a MiniLOM. comprising following steps: 36 mL detergent solution (16° dH with a Ca/Mg/HCO3 ratio of 5:3:1) containing pigment soil (1.78 g/L) +4 mL xanthan solution (0.3 g/L) was added to the beakers giving a final detergent concentration of 3.33 g/L. a final xanthan concentration of 0.03% (w/w) and a final pigment soil concentration of 1.6 g/L. Once the selected temperature for washing (e.g. 40° C.) was reached. the enzyme and swatches were added to the wash solution. After washing (e.g. after 30 minutes) the textiles were flushed in tap water for 5 minutes. the water was pressed out of the swatch by hand. and the swatch was covered with paper and allowed to air-dry overnight in the dark.

The experiments were conducted as described in the Mini Launder-O-tometer (MiniLOM) wash assay as described above using the experimental conditions specified in table 10 above. The results are given in table 11 as remissions at 460 nm.

TABLE 11
Delta Remissions on swatch CN-42

| | XL-1 | XL-5 | XL-6 | XL-10 | XL-16 | XL-17 | XL-18 | XL-19 | XL-20 | XL-21 |
|---|---|---|---|---|---|---|---|---|---|---|
| GH9-1 | | | | | | | | 7.7 | 4.7 | 9.4 |
| GH9-8 | | | | | 4.2 | 10.5 | 7.0 | 8.1 | 6.4 | 10.6 |
| GH9-15 | 8.2 | 7.7 | 5.7 | 6.1 | 6.0 | 4.9 | 7.3 | 6.3 | 7.4 | 6.4 |
| GH9-16 | 10.0 | 6.7 | 8.5 | 8.1 | −0.6 | 5.9 | 7.2 | 4.9 | 2.5 | 10.8 |
| GH9-19 | 8.8 | 7.4 | 7.6 | 7.0 | 4.4 | 6.8 | 5.9 | 6.9 | 4.6 | 6.3 |
| GH9-21 | 6.4 | 5.9 | 6.3 | 7.2 | 6.8 | 5.5 | 4.7 | 4.4 | 3.6 | 6.1 |

TABLE 12
Remissions on swatch CN-42

| | XL-1 | XL-5 | XL-6 | XL-10 | XL-16 | XL-17 | XL-18 | XL-19 | XL-20 | XL-21 |
|---|---|---|---|---|---|---|---|---|---|---|
| GH9-1 | | | | | | | | 416.2 ± | 398.6 ± | 433.2 ± |
| | | | | | | | | 4.7 | 1.8 | 1.5 |
| GH9-8 | | | | | 395.1 ± | 433.3 ± | 418.6 ± | 418.8 ± | 408.6 ± | 440.1 ± |
| | | | | | 3.1 | 1.0 | 0.8 | 2.4 | 2.4 | 2.1 |
| GH9-15 | 449.2 ± | 445.8 ± | 433.8 ± | 436.6 ± | 435.8 ± | 429.3 ± | 443.4 ± | 407.8 ± | 414.7 ± | 415.2 ± |
| | 2.5 | 2.8 | 2.4 | 2.0 | 2.0 | 2.4 | 1.4 | 3.9 | 3.3 | 4.5 |
| GH9-16 | 441.0 ± | 421.0 ± | 431.9 ± | 429.2 ± | 377.3 ± | 416.4 ± | 424.1 ± | 399.2 ± | 385.4 ± | 441.4 ± |
| | 1.4 | 1.6 | 1.6 | 2.1 | 2.1 | 1.8 | 2.1 | 3.7 | 2.2 | 2.5 |
| GH9-19 | 434.5 ± | 425.9 ± | 427.4 ± | 423.5 ± | 408.1 ± | 422.2 ± | 417.1 ± | 411.3 ± | 398.0 ± | 414.7 ± |
| | 3.1 | 1.7 | 1.7 | 3.2 | 2.2 | 1.2 | 2.2 | 2.4 | 2.9 | 1.5 |
| GH9-21 | 416.7 ± | 413.8 ± | 416.2 ± | 421.9 ± | 419.4 ± | 411.4 ± | 406.9 ± | 396.2 ± | 392.0 ± | 413.2 ± |
| | 1.4 | 1.1 | 1.1 | 1.9 | 2.3 | 2.1 | 2.0 | 0.7 | 2.8 | 3.4 |

These results show that the examined combination of xanthan lyase and GH9 has an anti-redeposition effect. i.e. it reduces soil redeposition under the conditions tested.

1-17. (canceled)

18. A method for reducing or preventing soil redeposition using a detergent composition comprising a polypeptide having xanthan lyase activity selected from the group consisting of:
(a) a polypeptide having at least 80% sequence identity to the mature polypeptide of SEQ ID NO: 4;
(b) a polypeptide having at least 80% sequence identity to the mature polypeptide of SEQ ID NO: 46;
(c) a polypeptide having at least 80% sequence identity to the mature polypeptide of SEQ ID NO: 60;
(d) a polypeptide having at least 80% sequence identity to the mature polypeptide of SEQ ID NO: 64;
(e) a polypeptide having at least 80% sequence identity to the mature polypeptide of SEQ ID NO: 106;
(f) a polypeptide having at least 80% sequence identity to the mature polypeptide of SEQ ID NO: 110;
(g) a polypeptide having at least 80% sequence identity to the mature polypeptide of SEQ ID NO: 114;
(h) a polypeptide having at least 80% sequence identity to the mature polypeptide of SEQ ID NO: 118;
(i) a polypeptide having at least 80% sequence identity to the mature polypeptide of SEQ ID NO: 122;
(j) a polypeptide having at least 80% sequence identity to the mature polypeptide of SEQ ID NO: 126;
(k) a polypeptide encoded by a polynucleotide that hybridizes under medium stringency conditions with:
(i) the mature polypeptide coding sequence of SEQ ID NO: 3;
(ii) the mature polypeptide coding sequence of SEQ ID NO: 45;
(iii) the mature polypeptide coding sequence of SEQ ID NO: 59;
(iv) the mature polypeptide coding sequence of SEQ ID NO: 63;
(v) the mature polypeptide coding sequence of SEQ ID NO: 105;
(vi) the mature polypeptide coding sequence of SEQ ID NO: 109;
(vii) the mature polypeptide coding sequence of SEQ ID NO: 113;
(viii) the mature polypeptide coding sequence of SEQ ID NO: 117;
(ix) the mature polypeptide coding sequence of SEQ ID NO: 121;
(x) the mature polypeptide coding sequence of SEQ ID NO: 125; or
(xi) the full-length complement thereof of (i), (ii), (iii), (iv), (v), (vi), (vii), (viii), (ix), or (x);
(l) a polypeptide encoded by a polynucleotide having at least 80% sequence identity to the mature polypeptide coding sequence of SEQ ID NO: 3;
(m) a polypeptide encoded by a polynucleotide having at least 80% sequence identity to the mature polypeptide coding sequence of SEQ ID NO: 45;
(n) a polypeptide encoded by a polynucleotide having at least 80% sequence identity to the mature polypeptide coding sequence of SEQ ID NO: 59;
(o) a polypeptide encoded by a polynucleotide having at least 80% sequence identity to the mature polypeptide coding sequence of SEQ ID NO: 63;
(p) a polypeptide encoded by a polynucleotide having at least 80% sequence identity to the mature polypeptide coding sequence of SEQ ID NO: 105;
(q) a polypeptide encoded by a polynucleotide having at least 80% sequence identity to the mature polypeptide coding sequence of SEQ ID NO: 109;
(r) a polypeptide encoded by a polynucleotide having at least 80% sequence identity to the mature polypeptide coding sequence of SEQ ID NO: 113;
(s) a polypeptide encoded by a polynucleotide having at least 80% sequence identity to the mature polypeptide coding sequence of SEQ ID NO: 117;
(t) a polypeptide encoded by a polynucleotide having at least 80% sequence identity to the mature polypeptide coding sequence of SEQ ID NO: 121;
(u) a polypeptide encoded by a polynucleotide having at least 80% sequence identity to the mature polypeptide coding sequence of SEQ ID NO: 125;
(v) a variant of the mature polypeptide of SEQ ID NO: 4, SEQ ID NO: 46, SEQ ID NO: 60, SEQ ID NO: 64, SEQ ID NO: 106, SEQ ID NO: 110, SEQ ID NO: 114, SEQ ID NO: 118, SEQ ID NO: 122 or SEQ ID NO: 126 comprising a substitution, deletion, and/or insertion at one or more positions; and
(w) a fragment of the polypeptide of (a), (b), (c), (d), (e), (f), (g), (h), (i), (j), (k), (l), (m), (n), (o), (p), (q), (r), (s), (t), (u) or (v) that has xanthan lyase activity.

19. The method of claim 18, wherein the mature polypeptide corresponds to amino acids 1 to 760 of SEQ ID NO: 4, amino acids 1 to 1043 of SEQ ID NO: 46, amino acids 1 to 896 of SEQ ID NO: 60, amino acids 1 to 1038 of SEQ ID NO: 64, amino acids 1 to 901 of SEQ ID NO: 106, amino acids 1 to 899 of SEQ ID NO: 110, amino acids 1 to 897 of SEQ ID NO: 114, amino acids 1 to 933 of SEQ ID NO: 118, amino acids 1 to 1049 of SEQ ID NO: 122 or amino acids 1 to 900 of SEQ ID NO: 126.

20. The method of claim 18, comprising or consisting of SEQ ID NO: 4, SEQ ID NO: 46, SEQ ID NO: 60, SEQ ID NO: 64, SEQ ID NO: 106, SEQ ID NO: 110, SEQ ID NO: 114, SEQ ID NO: 118, SEQ ID NO: 122 or SEQ ID NO: 126 or the mature polypeptide of SEQ ID NO: 4, SEQ ID NO: 46, SEQ ID NO: 60, SEQ ID NO: 64, SEQ ID NO: 106, SEQ ID NO: 110, SEQ ID NO: 114, SEQ ID NO: 118, SEQ ID NO: 122 or SEQ ID NO: 126.

21. The method of claim 18, comprising a variant polypeptide, wherein the variant polypeptide is selected from the group consisting of:
(a) a variant of the polypeptide of SEQ ID NO: 4 comprising a substitution, deletion, and/or insertion of between one and 152 positions;
(b) a variant of the polypeptide of SEQ ID NO: 46 comprising a substitution, deletion, and/or insertion of between one and 208 positions;
(c) a variant of the polypeptide of SEQ ID NO: 60 comprising a substitution, deletion, and/or insertion of between one and 179 positions;
(d) a variant of the polypeptide of SEQ ID NO: 64 comprising a substitution, deletion, and/or insertion of between one and 207 positions;
(e) a variant of the polypeptide of SEQ ID NO: 106 comprising a substitution, deletion, and/or insertion of between one and 180 positions;
(f) a variant of the polypeptide of SEQ ID NO: 110 comprising a substitution, deletion, and/or insertion of between one and 179 positions;
(g) a variant of the polypeptide of SEQ ID NO: 114 comprising a substitution, deletion, and/or insertion of between one and 179 positions;
(h) a variant of the polypeptide of SEQ ID NO: 118 comprising a substitution, deletion, and/or insertion of between one and 186 positions;
(i) a variant of the polypeptide of SEQ ID NO: 122 comprising a substitution, deletion, and/or insertion of between one and 209 positions; and
(j) a variant of the polypeptide of SEQ ID NO: 126 comprising a substitution, deletion, and/or insertion of between one and 180 positions.

22. The method of claim 18, wherein the detergent composition also comprises a GH9 endoglucanase.

23. The method of claim 22, wherein the GH9 endoglucanase is selected from the group consisting of:
(a) a polypeptide having at least 80% sequence identity to the mature polypeptide of SEQ ID NO: 2;
(b) a polypeptide having at least 80% sequence identity to the mature polypeptide of SEQ ID NO: 10;
(c) a polypeptide having at least 80% sequence identity to the mature polypeptide of SEQ ID NO: 12;
(d) a polypeptide having at least 80% sequence identity to the mature polypeptide of SEQ ID NO: 14;
(e) a polypeptide having at least 80% sequence identity to the mature polypeptide of SEQ ID NO: 48;
(f) a polypeptide having at least 80% sequence identity to the mature polypeptide of SEQ ID NO: 52;
(g) a polypeptide having at least 80% sequence identity to the mature polypeptide of SEQ ID NO: 56;
(h) a polypeptide having at least 80% sequence identity to the mature polypeptide of SEQ ID NO: 82;
(i) a polypeptide having at least 80% sequence identity to the mature polypeptide of SEQ ID NO: 86;
(j) a polypeptide having at least 80% sequence identity to the mature polypeptide of SEQ ID NO: 90;
(k) a polypeptide having at least 80% sequence identity to the mature polypeptide of SEQ ID NO: 94;
(l) a polypeptide having at least 80% sequence identity to the mature polypeptide of SEQ ID NO: 98;
(m) a polypeptide having at least 80% sequence identity to the mature polypeptide of SEQ ID NO: 102;
(n) a polypeptide having at least 80% sequence identity to the mature polypeptide of SEQ ID NO: 130;
(o) a polypeptide having at least 80% sequence identity to the mature polypeptide of SEQ ID NO: 134;
(p) a polypeptide having at least 80% sequence identity to the mature polypeptide of SEQ ID NO: 138;
(q) a polypeptide encoded by a polynucleotide that hybridizes under medium stringency conditions with:
(i) the mature polypeptide coding sequence of SEQ ID NO: 1;
(ii) the mature polypeptide coding sequence of SEQ ID NO: 9;
(iii) the mature polypeptide coding sequence of SEQ ID NO: 11;
(iv) the mature polypeptide coding sequence of SEQ ID NO: 13;
(v) the mature polypeptide coding sequence of SEQ ID NO: 47;
(vi) the mature polypeptide coding sequence of SEQ ID NO: 51;
(vii) the mature polypeptide coding sequence of SEQ ID NO: 55;
(viii) the mature polypeptide coding sequence of SEQ ID NO: 81;
(ix) the mature polypeptide coding sequence of SEQ ID NO: 85;
(x) the mature polypeptide coding sequence of SEQ ID NO: 89;
(xi) the mature polypeptide coding sequence of SEQ ID NO: 93;
(xii) the mature polypeptide coding sequence of SEQ ID NO: 97;
(xiii) the mature polypeptide coding sequence of SEQ ID NO: 101;
(xiv) the mature polypeptide coding sequence of SEQ ID NO: 129;
(xv) the mature polypeptide coding sequence of SEQ ID NO: 133;
(xvi) the mature polypeptide coding sequence of SEQ ID NO: 137; or
(xvii) the full-length complement thereof of (i), (ii), (iii), (iv), (v), (vi), (vii), (viii), (ix), (x), (xi), (xii), (xiii), (xiv), (xv), or (xvi);
(r) a polypeptide encoded by a polynucleotide having at least 80% sequence identity to the mature polypeptide coding sequence of SEQ ID NO: 1;
(s) a polypeptide encoded by a polynucleotide having at least 80% sequence identity to the mature polypeptide coding sequence of SEQ ID NO: 9;
(t) a polypeptide encoded by a polynucleotide having at least 80% sequence identity to the mature polypeptide coding sequence of SEQ ID NO: 11;
(u) a polypeptide encoded by a polynucleotide having at least 80% sequence identity to the mature polypeptide coding sequence of SEQ ID NO: 13;
(v) a polypeptide encoded by a polynucleotide having at least 80% sequence identity to the mature polypeptide coding sequence of SEQ ID NO: 47;
(w) a polypeptide encoded by a polynucleotide having at least 80% sequence identity to the mature polypeptide coding sequence of SEQ ID NO: 51;
(x) a polypeptide encoded by a polynucleotide having at least 80% sequence identity to the mature polypeptide coding sequence of SEQ ID NO: 55;
(y) a polypeptide encoded by a polynucleotide having at least 80% sequence identity to the mature polypeptide coding sequence of SEQ ID NO: 81;
(z) a polypeptide encoded by a polynucleotide having at least 80% sequence identity to the mature polypeptide coding sequence of SEQ ID NO: 85;
(aa) a polypeptide encoded by a polynucleotide having at least 80% sequence identity to the mature polypeptide coding sequence of SEQ ID NO: 89;
(ab) a polypeptide encoded by a polynucleotide having at least 80% sequence identity to the mature polypeptide coding sequence of SEQ ID NO: 93;
(ac) a polypeptide encoded by a polynucleotide having at least 80% sequence identity to the mature polypeptide coding sequence of SEQ ID NO: 97;
(ad) a polypeptide encoded by a polynucleotide having at least 80% sequence identity to the mature polypeptide coding sequence of SEQ ID NO: 101;
(ae) a polypeptide encoded by a polynucleotide having at least 80% sequence identity to the mature polypeptide coding sequence of SEQ ID NO: 129;
(af) a polypeptide encoded by a polynucleotide having at least 80% sequence identity to the mature polypeptide coding sequence of SEQ ID NO: 133;
(ag) a polypeptide encoded by a polynucleotide having at least 80% sequence identity to the mature polypeptide coding sequence of SEQ ID NO: 137;
(ah) a variant of the mature polypeptide of SEQ ID NO: 2, SEQ ID NO: 10, SEQ ID NO: 12, SEQ ID NO: 14, SEQ ID NO: 48, SEQ ID NO: 52, SEQ ID NO: 56, SEQ ID NO: 82, SEQ ID NO: 86, SEQ ID NO: 90, SEQ ID NO: 94, SEQ ID NO: 98, SEQ ID NO: 102, SEQ ID NO: 130, SEQ ID NO: 134 or SEQ ID NO: 138 comprising a substitution, deletion, and/or insertion at one or more positions; and
(ai) a fragment of the polypeptide of (a), (b), (c), (d), (e), (f), (g), (h), (i), (j), (k), (l), (m), (n), (o), (p), (q), (r), (s), (t), (u), (v), (w), (x), (y), (z), (aa), (ab), (ac), (ad), (ae), (af), (ag) or (ah) that has xanthan degrading activity and/or endo-β-1,4-glucanase activity.

24. The method of claim 18, wherein the detergent composition also comprises a GH9 endoglucanase selected from the group consisting of:
(a) the polypeptide corresponding to amino acids 1 to 1055 of SEQ ID NO: 2;
(b) the polypeptide corresponding to amino acids 1 to 918 of SEQ ID NO: 10;
(c) the polypeptide corresponding to amino acids 1 to 916 of SEQ ID NO: 12;
(d) the polypeptide corresponding to amino acids 1 to 918 of SEQ ID NO: 14;
(e) the polypeptide corresponding to amino acids 1 to 1007 of SEQ ID NO: 48;
(f) the polypeptide corresponding to amino acids 1 to 915 of SEQ ID NO: 52;
(g) the polypeptide corresponding to amino acids 1 to 1056 of SEQ ID NO: 56;
(h) the polypeptide corresponding to amino acids 1 to 1371 of SEQ ID NO: 82;
(i) the polypeptide corresponding to amino acids 1 to 1203 of SEQ ID NO: 86;
(j) the polypeptide corresponding to amino acids 1 to 1379 of SEQ ID NO: 90;
(k) the polypeptide corresponding to amino acids 1 to 1371 of SEQ ID NO: 94;
(l) the polypeptide corresponding to amino acids 1 to 1372 of SEQ ID NO: 98;
(m) the polypeptide corresponding to amino acids 1 to 922 of SEQ ID NO: 102;
(n) the polypeptide corresponding to amino acids 1 to 916 of SEQ ID NO: 130;
(o) the polypeptide corresponding to amino acids 1 to 1373 of SEQ ID NO: 134; and
(p) the polypeptide corresponding to amino acids 1 to 1204 of SEQ ID NO: 138.

25. The method of claim 18, wherein the detergent composition also comprises a GH9 endoglucanase comprising or consisting of SEQ ID NO: 2, SEQ ID NO: 10, SEQ ID NO: 12, SEQ ID NO: 14, SEQ ID NO: 48, SEQ ID NO: 52, SEQ ID NO: 56, SEQ ID NO: 82, SEQ ID NO: 86, SEQ ID NO: 90, SEQ ID NO: 94, SEQ ID NO: 98, SEQ ID NO: 102, SEQ ID NO: 130, SEQ ID NO: 134 or SEQ ID NO: 138 or the mature polypeptide of SEQ ID NO: 2, SEQ ID NO: 10, SEQ ID NO: 12, SEQ ID NO: 14, SEQ ID NO: 48, SEQ ID NO: 52, SEQ ID NO: 56, SEQ ID NO: 82, SEQ ID NO: 86, SEQ ID NO: 90, SEQ ID NO: 94, SEQ ID NO: 98, SEQ ID NO: 102, SEQ ID NO: 130, SEQ ID NO: 134 or SEQ ID NO: 138.

26. The method of claim 18, wherein the detergent composition also comprises one or more further enzymes.

27. The method of claim 26, wherein the further enzymes are selected from the group comprising proteases, amylases, lipases, cutinases, cellulases, endoglucanases, xyloglucanases, pectinases, pectin lyases, xanthanases, peroxidaes, haloperoxygenases, catalases and mannanases, or any mixture thereof.

28. The method of claim 18, wherein the detergent composition also comprises one or more detergent components.

29. The method of claim 28, wherein the detergent components are selected from the group comprising surfactants, builders, hydrotopes, bleaching systems, polymers, fabric hueing agents, adjunct materials, dispersants, dye transfer inhibiting agents, fluorescent whitening agents and soil release polymers, or any mixture thereof.

30. The method of claim 18, wherein the detergent composition is in the form of a bar, a homogenous tablet, a tablet having two or more layers, a pouch having one or more compartments, a regular or compact powder, a granulate, a paste, a gel, or a regular, compact or concentrated liquid.

31. The method of claim 18 for dish wash or laundering.
